(19) United States
(12) Patent Application Publication
(10) Pub. No.: US 2006/0046216 A1
(43) Pub. Date: Mar. 2, 2006

(54) Photothermographic material and image forming method

(76) Inventor: Keiichi Suzuki, Kanagawa (JP)

Correspondence Address: TAIYO CORPORATION, 401 HOLLAND LANE, #407, ALEXANDRIA, VA, 22314, US

(21) Appl. No.: 11/210,780

(22) Filed: Aug. 25, 2005

(30) Foreign Application Priority Data
Aug. 30, 2004 (JP) 2004-250846

(51) Int. Cl. G03C 1/00

(52) U.S. Cl. 430/619

(57) ABSTRACT

A photothermographic material having, on at least one side of a support, an image forming layer containing at least a photosensitive silver halide, a non-photosensitive organic silver salt, a reducing agent, and a binder and at least two non-photosensitive layers, as well as an image forming method using the photothermographic material, wherein (1) 50% by weight or more of the binder is a hydrophilic binder and (2) one layer among the non-photosensitive layers that is nearer to the image forming layer is a non-photosensitive intermediate layer containing 50% by weight or more of a hydrophobic polymer latex as a binder. There are provided a photothermographic material excellent in coated surface state and also excellent in image storability, as well as a method of forming images by using the photothermographic material.

### CROSS-REFERENCE TO RELATED APPLICATION

This application claims priority under 35 USC 119 from Japanese Patent Application No. 2004-250846, the disclosure of which is incorporated by reference herein.

### BACKGROUND OF THE INVENTION

1. Field of the Invention

The present invention relates to a photothermographic material which has an excellent coated surface state and excellent image storability, and an image forming method using the same.

2. Description of the Related Art

In recent years, decreasing the amount of processing liquid waste in the field of films for medical imaging has been desired from the viewpoints of protecting the environment and economy of space. Technology is therefore required for light sensitive thermal developing photographic materials which can be exposed effectively by laser image setters or laser imagers and thermally developed to obtain clear black-toned images of high resolution and sharpness, for use in medical diagnostic applications and for use in photographic technical applications. The light sensitive thermal developing photographic materials do not require liquid processing chemicals and can therefore therefore be supplied to customers as a simpler and environmentally friendly thermal developing system.

While similar requirements also exist in the field of general image forming materials, images for medical imaging in particular require high image quality excellent in sharpness and granularity because fine depiction is required, and further require blue-black image tone from the viewpoint of easy diagnosis. Various kinds of hard copy systems utilizing dyes or pigments, such as ink jet printers and electrophotographic systems, have been marketed as general image forming systems, but they are not satisfactory as output systems for medical images.

Thermal image forming systems utilizing organic silver salts are described in many documents. In particular, photothermographic materials generally have an image forming layer including a catalytically active amount of a photocatalyst (for example, silver halide), a reducing agent, a reducible silver salt (for example, an organic silver salt), and if necessary, a toner for controlling the color tone of developed silver images, dispersed in a binder. Photothermographic materials form black silver images by being heated to a high temperature (for example, 80° C. or higher) after imagewise exposure to cause an oxidation-reduction reaction between a silver halide or a reducible silver salt (functioning as an oxidizing agent) and a reducing agent. The oxidation-reduction reaction is accelerated by the catalytic action of a latent image on the silver halide generated by exposure. As a result, a black silver image is formed on the exposed region. The Fuji Medical Dry Imager FM-DPL is an example of a medical image forming system that has been made commercially available.

Methods of manufacturing such a thermal image forming system using an organic silver salt include a method of manufacture by a solvent coating, and a method of coating an aqueous coating solution using an aqueous dispersion of fine polymer particles or an aqueous solution of a water-soluble polymer as a main binder followed by drying. Since the latter method does not require a process of solvent recovery or the like, a production facility therefor is simple, environmental burden is small, and the method is advantageous for mass production. However, since the coating solution has no setting ability in any of the methods, there are problems such as in that coated layers are disturbed by drying wind after coating the coating solution, whereby unevenness tends to be generated in the drying.

In U.S. Pat. Nos. 6,630,291 and 6,713,241, the disclosures of which are incorporated by reference herein, use of a hydrophilic binder such as gelatin as a binder is disclosed; however, there are problems in that thermal developing activity is low and increasing the activity to obtain sufficient images results in an increase in fogging, and such materials have not yet been put to practical use.

In the photothermographic material, it is necessary that chemical components necessary for forming an image are contained in the film in advance. For this reason, these chemical components exert influences on storage stability of the photothermographic material up until it is used. Further, even after an image has been formed by subjecting the photothermographic material to thermal development, these chemical components remain in the film as unreacted components or reaction products, and exert adverse influences on image storability and, moreover, exert significant influences such as change of color tone of the image or discoloration.

Thus there is a need in the art for a photothermographic material obtained from an aqueous coating solution with less environmental burden. Further there is generally a need for a photothermographic material having compatibility between a good coated surface state and a coating operability, and having favorable photographic properties, particularly image storage stability, and at the same time, development of means for improving such performances.

### SUMMARY OF THE INVENTION

A first aspect of the invention is to provide a photothermographic material comprising, on at least one side of a support, an image forming layer comprising at least a photosensitive silver halide, a non-photosensitive organic silver salt, a reducing agent, and a binder and at least two non-photosensitive layers which are disposed on the same side as the image forming layer and farther from the support than the image forming layer, wherein

(1) 50% by weight or more of the binder is a hydrophilic binder; and

(2) one layer among the non-photosensitive layers that is nearer to the image forming layer is a non-photosensitive intermediate layer containing 50% by weight or more of a hydrophobic polymer latex as a binder.

A second aspect of the invention is to provide an image forming method for forming images by imagewise exposure and thermal development of a photothermographic material comprising, on at least one side of a support, an image forming layer comprising at least a photosensitive silver halide, a non-photosensitive organic silver salt, a reducing agent, and a binder and at least two non-photosensitive layers which are disposed on the same side as the image forming layer and farther from the support than the image forming layer, wherein 50% by weight or more of the binder is a hydrophilic binder, and one layer among the non-photosensitive layers that is nearer to the image forming layer is a non-photosensitive intermediate layer containing 50% by weight or more of a hydrophobic polymer latex as a binder, and wherein the thermal development is conducted while transporting the photothermographic material at a line speed of from 23 mm/sec to 200 mm/sec.

### DETAILED DESCRIPTION OF THE INVENTION

An object of the present invention is to provide a photothermographic material which is excellent in coated surface state and also excellent in image storablity as well as an image forming method using the same.

The following description cites to several Japanese laid-open patent publications. The disclosures of each of these patent publications is hereby expressly incorporated by reference herein.

The present inventors have studied the use of a setting hydrophilic binder such as gelatin as a binder for an image forming layer for a novel photothermographic material capable of obtaining an excellent coated surface state. A hydrophilic binder has been used so far generally in silver halide photosensitive materials of a wet development system. However, when it is used as the binder for a photothermographic material, there has been revealed a new problem different from that in conventional wet development silver halide photosensitive materials. This is discoloration of silver images referred to as fingerprint discoloration. This is a phenomenon in which a portion of fingerprints deposited on the surface during handling after image formation undergoes discoloration during subsequent storage which eventually causes decoloration and loss of an image. As a result of earnest analysis made by the present inventors, it has been found that discoloration tends to occur more along with increase in the hydrophilicity of the image forming layer, which conflicts with the improvement of coating ability. Accordingly, a new method has been demanded for improving the coating ability and also maintaining good image storability. As a result of earnest effort made by the present inventors, it has been found that the problem can be solved by disposing a barrier layer comprising a hydrophobic latex between the image forming layer and the surface protective layer. It is particularly effective and preferred when the barrier layer is in direct contact with the image forming layer. Further, it has been found that the effect of the invention is remarkable in an image forming layer of a composition containing a compound having an imide group and capable of rapid development. Further, an image forming method capable of rapidly forming images by using the photothermographic material according to the invention has also been found, leading to the invention of an image forming method.

According to the present invention, a photothermographic material which is excellent in coated surface state and also excellent in image storablity and an image forming method using the same are provided.

The photothermographic material of the invention has, on at least one side of a support, an image forming layer containing at least a photosensitive silver halide, a non-photosensitive organic silver salt, a reducing agent, and a binder and at least two non-photosensitive layers which are disposed on the same side as the image forming layer and farther from the support than the image forming layer, wherein 50% by weight or more of the binder is a hydrophilic binder, and one layer among the non-photosensitive layers that is nearer to the image forming layer is a non-photosensitive intermediate layer containing 50% by weight or more of a hydrophobic polymer latex as a binder. The non-photosensitive intermediate layer is preferably adjacent to the image forming layer. Another one of the non-photosensitive layers is preferably an outermost layer, and more preferably 50% by weight or more of the binder thereof is a hydrophilic binder.

The photothermographic material of the invention has one or more image forming layers constructed on a support. The image forming layer may further comprise additional materials as desired and necessary, such as an antifoggant, a development accelerator, a film-forming promoting agent, and other auxiliary agents.

In the image forming layer of the photothermographic material of the invention, 50% by weight or more of the binder is a hydrophilic binder, and the hydrophilic binder of the imgae forming layer is preferably gelatin or a gelatin derivative. Further the photothermographic material of the invention preferably comprises at least one compound having an imide group represented by formula (I) or (II) described below.

The non-photosensitive organic silver salt is preferably prepared as particles in the presence of at least one compound selected from among polyacrylamide and derivatives thereof. In the present invention, the non-photosensitive organic silver salt is preferably nano-particles, and more preferably, a mean particle size of the nano-particles is from 50 nm to 1000 nm.

In the present invention, the hydrophobic polymer latex in the non-photosensitive intermediate layer is preferably a polymer latex containing a monomer component represented by formula (M) described below in a range of from 10% by weight to 70% by weight.

In the present invention, the hydrophilic binder of the outermost layer is preferably gelatin or a gelatin derivative.

Preferably, at least one layer among the image forming layer and the non-photosensitive layers contains a crosslinking agent.

The image forming method according to the invention is an image forming method for forming images by imagewise exposure and thermal development of a photothermographic material, wherein thermal development is conducted while transporting the material at a line speed of from 23 mm/sec to 200 mm/sec.

The present invention is explained below in detail.

1. Layer Constitution

The photothermographic material of the invention has at least one image forming layer and has further at least two non-photosensitive layers which are disposed on the same side as the image forming layer and farther from the support than the image forming layer, wherein one layer among the non-photosensitive layers that is nearer to the image forming layer is a non-photosensitive intermediate layer containing 50% by weight or more of a hydrophobic polymer latex as a binder. Constitutions of other layers are not particularly restricted.

Generally, the non-photosensitive layers can be classified depending on the layer arrangement into (a) a surface protective layer provided on the image forming layer (on the side farther from the support), (b) an intermediate layer provided among plural image forming layers or between the image forming layer and the protective layer, (c) an undercoat layer provided between the image forming layer and the support, and (d) a back layer which is provided on the side opposite to the image forming layer. These layers may each independently be one layer or plural layers.

Furthermore, a layer that functions as an optical filter can be provided as (a) or (b) above. An antihalation layer can be provided as (c) or (d) to the photothermographic material.

The photothermographic material of the present invention may be either “single-sided type” having an image forming layer on one side of the support, or “double-sided type” having image forming layers on both sides of the support.

(1) Single-Sided Type Photothermographic Material

In the case of single-sided type, the photothermographic material comprises a back layer on the opposite side of the support from the image forming layer (hereinafter, referred as backside).

The single-sided type photothermographic material of the present invention can be applied for an X-ray photosensitive material used for mammography. To use the single-sided type photothermographic material for that purpose, it is important to design the gradation of the obtained image in a suitable range.

(2) Double-Sided Type Photothermographic Material

The photothermographic material of the present invention can be preferably applied for an image forming method to record X-ray images using a fluorescent intensifying screen.

Concerning the preferable constitution for a photosensitive material used for mammography, reference can be made to Japanese Patent Application Laid-Open (JP-A) Nos. 5-45807, 10-62881, 10-54900, and 11-109564.

The image forming method using the photothermographic materials described above comprises:

(a) providing an assembly for forming an image by placing the photothermographic material between a pair of the X-ray intensifying screens,

(b) putting an analyte between the assembly and the X-ray source,

(c) applying X-rays having an energy level in a range of 25 kVp to 125 kVp to the analyte;

(d) taking the photothermographic material out of the assembly; and

(e) heating the removed photothermographic material in a temperature range of 90° C. to 180° C.

The photothermographic material used for the assembly in the present invention is subjected to X-ray exposure through a step wedge tablet and thermal development. On the photographic characteristic curve having an optical density (D) and an exposure value (log E) along the rectangular coordinates having the equal axis-of-coordinate unit, it is preferred to adjust so that the thermal developed image may have the photographic characteristic curve where the average gamma (γ) made at the points of a density of fog+0.1 and a density of fog+0.5 is from 0.5 to 0.9, and the average gamma (γ) made at the points of a density of fog+1.2 and a density of fog+1.6 is from 3.2 to 4.0. For the X-ray radiography employed in the practice of the present invention, the use of photothermographic material having the aforesaid photographic characteristic curve would give the radiation images with excellent photographic properties that exhibit an extended bottom portion and high gamma value at a middle density area. According to this photographic property, the photographic properties mentioned have the advantage of that the depiction in a low density portion on the mediastinal region and the heart shadow region having little X-ray transmittance becomes excellent, and that the density becomes easy to view, and that gradation in the images on the lung field region having much X-ray transmittance becomes excellent.

The photothermographic material having a preferred photographic characteristic curve mentioned above can be easily prepared, for example, by the method where each of the image forming layer of both sides may be constituted of two or more image forming layers containing silver halide and having a sensitivity different from each other. Especially, the aforesaid image forming layer preferably comprises an emulsion of high sensitivity for the upper layer and an emulsion with photographic properties of low sensitivity and high gradation for the lower layer. In the case of preparing the image forming layer comprising two layers, the sensitivity difference between the silver halide emulsion in each layer is preferably from 1.5 times to 20 times, and more preferably from 2 times to 15 times. The ratio of the amounts of emulsion used for forming each layer depends on the sensitivity difference between emulsions used and the covering power. Generally, as the sensitivity difference is large, the ratio of the using amount of high sensitivity emulsion is reduced. For example, if the sensitivity difference is two times, and the covering power is equal, the ratio of the amount of high sensitivity emulsion to low sensitivity emulsion would be preferably adjusted to be in a range of from 1:20 to 1:50 based on a silver amount.

As the techniques for crossover cutting (in the case of double-sided photosensitive material) and antihalation (in the case of single-sided photosensitive material), dyes or combined use of dye and mordant described in JP-A. No. 2-68539, (from page 13, left lower column, line 1 to page 14, left lower column, line 9) can be employed.

Next, the fluorescent intensifying screen of the present invention is explained below. The fluorescent intensifying screen essentially comprises a support and a fluorescent substance layer coated on one side of the support as the fundamental structure. The fluorescent substance layer is a layer where the fluorescent substance is dispersed in binders. On the surface of a fluorescent substance layer opposite to the support side (the surface of the side that does not face on the support), a transparent protective layer is generally disposed to protect the fluorescent substance layer from chemical degradation and physical shock.

Preferred fluorescent substances according to the present invention are described below. Tungstate fluorescent substances (CaWO₄, MgWO₄, CaWO₄:Pb, and the like), terbium activated rare earth sulfoxide fluorescent substances (Y₂O₂S:Tb, Gd₂O₂S:Tb, La₂O₂S:Tb, (Y,Gd)₂O₂S:Tb, (Y,Gd)O₂S:Tb, Tm, and the like), terbium activated rare earth phosphate fluorescent substances (YPO₄:Tb, GdPO₄:Tb, LaPO₄:Tb, and the like), terbium activated rare earth oxyhalogen fluorescent substances (LaOBr:Tb, LaOBr:Tb, Tm, LaOCl:Tb, LaOCl:Tb, Tm, LaOBr:Tb, GdOBr:Tb, GdOCl:Tb, and the like), thulium activated rare earth oxyhalogen fluorescent substances (LaOBr:Tm, LaOCl:Tm, and the like), barium sulfate fluorescent substances (BaSO₄:Pb, BaSO₄:Eu²⁺, (Ba,Sr)SO₄:Eu²⁺, and the like), divalent europium activated alkali earth metal phosphate fluorescent substances ((Ba₂PO₄)₂:Eu²⁺, (Ba₂PO₄)₂:Eu²⁺, and the like), divalent europium activated alkali earth metal fluorinated halogenide fluorescent substances (BaFCl:Eu²⁺, BaFBr:Eu²⁺, BaFCl:Eu²⁺, Tb, BaFBr:Eu²⁺, Tb, BaF₂.BaCl.KCl:Eu²⁺, (Ba,Mg)F₂.BaCl.KCl:Eu²⁺, and the like), iodide fluorescent substances (CsI:Na, CsI:Tl, NaI, KI:Tl, and the like), sulfide fluorescent substances (ZnS:Ag(Zn,Cd)S:Ag, (Zn,Cd)S:Cu, (Zn,Cd)S:Cu, Al, and the like), hafnium phosphate fluorescent substances (HfP₂O₇:Cu and the like), YTaO₄ and a substance in which various activator is added as an emission center to YTaO₄. However, the fluorescent substance used in the present invention is not particularly limited to these specific examples, as far as the fluorescent substance emits light in visible or near ultraviolet region by exposure to a radioactive ray.

In the fluorescent intensifying screen used in the present invention, the fluorescent substance is preferably packed in a particle diameter graded structure. Especially, the fluorescent substance particles having a large particle diameter are preferably coated at the side of the surface protective layer and fluorescent substance particles having a small particle diameter are preferably coated at the side of the support. The small particle diameter of fluorescent substance is preferably in a range of from 0.5 μm to 2.0 μm, and the large diameter is preferably in a range of from 10 μm to 30 μm.

Concerning the image forming method using photothermographic material according to the present invention, it is preferred that the image forming method is perfomed in combination with a fluorescent substance having a main emission peak at 400 nm or lower. And more preferably, the image forming method is performed in combination with a fluorescent substance having a main emission peak at 380 nm or lower. Either single-sided photosensitive material or double-sided photosensitive material can be applied for the assembly. As the screen having a main emission peak at 400 nm or lower, the screens described in JP-A No. 6-11804 and WO No. 93/01521 and the like are used, but the present invention is not limited to these. As the techniques of crossover cutting (for double-sided photosensitive material) and antihalation (for single-sided photosensitive material) of ultraviolet light, the technique described in JP-A No. 8-76307 can be applied. As ultraviolet absorbing dyes, the dye described in JP-A No. 2001-144030 is particularly preferred.

2. Constituting Components of Each Layer

(Non-photosensitive intermediate layer containing 50% by weight or more of hydrophobic polymer latex)

In the present invention, the binder of at least one layer of the non-photosensitive intermediate layers contains a hydrophobic polymer latex in an amount of 50% by weight or more, preferably 80% or more, and more preferably 90% by weight or more. When the amount is less than 50% by weight, the effect of improving image storability becomes reduced and it is not preferred.

In the present invention, the hydrophobic polymer latex may be a latex in which water-insoluble fine particles of hydrophobic polymer are dispersed or such in which polymer molecules are dispersed in molecular states or by forming micelles, but preferred are latex-dispersed particles.

An average particle size of the dispersed particles is in a range from 1 nm to 50000 nm, preferably from 5 nm to 1000 nm, more preferably from 10 nm to 500 nm, and even more preferably from 50 nm to 200 nm. There is no particular limitation concerning particle size distribution of the dispersed particles, and they may be widely distributed or may exhibit a monodisperse particle size distribution. From the viewpoint of controlling the physical properties of the coating solution, preferred mode of usage includes mixing two or more types of particles each having monodisperse particle distribution.

The glass transition temperature (Tg) of the hydrophobic polymer of the present invention is preferably in a range of from −30° C. to 70° C., more preferably from −10° C. to 35° C. and, most preferably from 0° C. to 35° C. In a case where Tg is lower than −30° C., film-forming property is excellent, but the formed film is poor in heat resistant strength. In a case where Tg is higher than 70° C., heat resistant strength is excellent, but film-forming property is not enough to perform film coating. However, it is possible to use two or more kinds of polymers to make Tg fall in the above range. Namely, even if a polymer has a Tg outside the above range, it is preferred that the weight-average Tg thereof is in the range mentioned above.

The I/O value of the hydrophobic polymer is preferably in a range of from 0.09 to 0.5, and more preferably from 0.1 to 0.3. The I/O value used herein means a value of an inorganic value divided by an organic value based on an organic conception diagram. In a case where the I/O value is smaller than 0.09, hydrophobicity is so high that an uniform film formation is very difficult in the film-forming process. In a case where the value is bigger than 0.5, the formed film is so hydrophilic that the film may give unfavorable effects on an osmotic property for moisture, dust, or the like. The I/O value can be calculated by a method described in “Yuuki Gainen Zu-Kiso To Oyo-(Organic Concept Diagram-Fundamentals and Applications-)”, written by Yoshio Kohda, published by Sankyo Shupan (1984).

Here, the organic concept diagram is to indicate the entire organic compounds at each position on the orthogonal coordinate whose axes indicate, respectively, the organic axis and the inorganic axis, where the characteristics of the compounds are categorized into an organic value representing a covalent bond tendency and an inorganic value representing an ionic bond tendency. The inorganic value based on this diagram is determined with respect to inorganic property or the magnitude of affecting force to the boiling point by various substituents on a basis of hydroxy group, and is a value in which an affecting force per hydroxy group is defined taken as 100 in numerical, since it is about 100° C. if a distance between the boiling point curve of a straight chain alcohol and the boiling point curve of a straight chain paraffin is taken around a carbon atom number of five. In a meantime, the organic value is determined based on that the number of carbon atoms representing the methylene group where each methylene group in the molecule is treated as a unit can measure the magnitude of the number of the organic value. The organic value is set with a standard in which a single piece number of the carbon atom number as the basis is determined as 20 from the average boiling point increase of 20° C. caused by one carbon atom addition to the straight chain compound having around 5 to 10 carbon atoms. The inorganic value and the organic value are set to correspond one to one on the graph. The I/O value is calculated from those values.

1) Hydrophobic Polymer Latex

The hydrophobic polymer latex usable in the present invention is preferably a polymer latex which is obtained bu copolymerizing the monomer component represented by formula (M). And more preferably, the hydrophobic polymer latex of the present invention is a polymer latex which contains the monomer component represented by formula (M) within a range of from 10% by weight to 70% by weight.
CH₂═CR⁰¹—CR⁰²═CH₂ Formula (M):

wherein R⁰¹ and R⁰² each independently represent one selected from a hydrogen atom, an alkyl groups having 1 to 6 carbon atoms, a halogen atom, or a cyano group.

As an alkyl group for R⁰¹ or R⁰², an alkyl group having 1 to 4 carbon atoms is preferred, and more preferably an alkyl group having 1 to 2 carbon atoms is used. As a halogen atom, a fluorine atom, a chlorine atom, or a bromine atom is preferred, and more preferred is a chlorine atom.

Particularly preferably, both of R⁰¹ and R⁰² represent a hydrogen atom, or one of R⁰¹ and R⁰² represents a hydrogen atom and the other represents a methyl group or a chlorine atom.

Specific examples of monomer represented by formula (M) according to the present invention include 1,3-butadiene, 2-ethyl-1,3-butadiene, 2-n-propyl-1,3-butadiene, 2,3-dimethyl-1,3-butadiene, 2-methyl-1,3-butadiene, 2-chloro-1,3-butadiene, 1-bromo-1,3-butadiene, 2-fluoro-1,3-butadiene, 2,3-dichloro-1,3-butadiene, and 2-cyano-1,3-butadiene.

In the invention, the other monomers, which are capable to copolymerize with the monomer represented by formula (M), are not particularly restricted, and any monomers may be preferably used provided that they are polymerizable by usual radical polymerization or ion polymerization.

Concerning the monomer which can be used preferably, it is capable to select the combination independently and freely from the monomer groups (a) to (j) described below.

—Monomer Groups (a) to (j)—

(a) conjugated dienes: 1,3-butadiene, 1,3-pentadiene, 1-phenyl-1,3-butadiene, 1-α-naphthyl-1,3-butadiene, 1-β-naphthyl-1,3-butadiene, 1-bromo-1,3-butadiene, 1-chloro-1,3-butadiene, 1,1,2-trichloro-1,3-butadiene, cyclopentadiene, and the like;

(b) olefins: ethylene, propylene, vinyl chloride, vinylidene chloride, 6-hydroxy-l-hexene, 4-pentenoic acid, methyl 8-nonenate, vinylsulfonic acid, trimethylvinylsilane, trimethoxyvinylsilane, 1,4-divinylcyclohexane, 1,2,5-trivinylcyclohexane, and the like;

(c) α,β-unsaturated carboxylic acid and salts thereof: acrylic acid, methacrylic acid, itaconic acid, maleic acid, sodium acrylate, ammonium methacrylate, potassium itaconate, and the like;

(d) α,β-unsaturated carboxylate esters: alkyl acrylate (for example, methyl acrylate, ethyl acrylate, butyl acrylate, cyclohexyl acrylate, 2-ethylhexyl acrylate, dodecyl acrylate, and the like), substituted alkyl acrylate (for example, 2-chloroethyl acrylate, benzyl acrylate, 2-cyanoethyl acrylate, and the like), alkyl methacrylate (for example, methyl methacrylate, butyl methacrylate, 2-ethylhexyl methacrylate, dodecyl methacrylate, and the like), substituted alkyl methacrylate (for example, 2-hydroxyethyl methacrylate, glycidyl methacrylate, glycerine monomethacrylate, 2-acetoxyethyl methacrylate, tetrahydrofurfulyl methacrylate, 2-methoxyethyl methacrylate, polypropyleneglycol monomethacrylate (addition mole number of polyoxypropylene=2 to 100), 3-N,N-dimethylaminopropyl methacrylate, chloro-3-N,N,N-trimethylammoniopropyl methacrylate, 2-carboxyethyl methacrylate, 3-sulfopropyl methacrylate, 4-oxysulfobutyl methacrylate, 3-trimethoxysilylpropyl methacrylate, allyl methacrylate, 2-isocyanatoethyl methacrylate, and the like), derivatives of unsaturated dicarboxylic acid (for example, monobutyl maleate, dimethyl maleate, monomethyl itaconate, dibutyl itaconate, and the like), and polyfunctional esters (for example, ethyleneglycol diacrylate, ethyleneglycol dimethacrylate, 1,4-cyclohexane diacrylate, pentaerythritol tetramethacrylate, pentaerythritol triacrylate, trimethylolpropane triacrylate, trimethylolethane triacrylate, dipentaerythritol pentamethacrylate, pentaerythritol hexaacrylate, 1,2,4-cyclohexane tetramethacrylate, and the like);

(e) amides of β-unsaturated carboxylic acid: for example, acrylamide, methacrylamide, N-methylacrylamide, N,N-dimethylacrylamide, N-methyl-N-hydroxyethyl methacrylamide, N-tert-butyl acrylamide, N-tert-octyl methacrylamide, N-cyclohexyl acrylamide, N-phenyl acrylamide, N-(2-acetoacetoxyethyl)acrylamide, N-acryloyl morpholine, diacetone acrylamide, diamide itaconate, N-methyl maleimide, 2-acrylamide-methylpropanesulfonic acid, methylenebis acrylamide, dimethacryloyl piperazine, and the like;

(f) unsaturated nitriles: acrylonitrile, methacrylonitrile, and the like;

(g) styrene and derivatives thereof: styrene, vinyltoluene, p-tert-butylstyrene, vinylbenzoic acid, methyl vinylbenzoate, α-methylstyrene, p-chloromethylstyrene, vinylnaphthalene, p-hydroxymethylstyrene, sodium p-styrenesulfonate, potassium p-styrenesulfinate, p-aminomethylstyrene, 1,4-divinylbenzene, and the like;

(h) vinylethers: methylvinyl ether, butylvinyl ether, methoxyethylvinyl ether, and the like;

(i) vinyl esters: vinyl acetate, vinyl propionate, vinyl benzoate, vinyl salicylate, vinyl chloroacetate, and the like; and

(j) other polymerizable monomers: N-vinylimidazole, 4-vinylpyridine, N-vinylpyrrolidone, 2-vinyloxazoline, 2-isopropenylozazoline, divinylsulfone, and the like.

Preferred examples of a polymer copolymerized with the monomer represented by formula (M) of the present invention include copolymers with styrene (for example, random copolymer, block polymer, or the like), copolymers with styrene and butadiene (for example, random copolymer, butadiene-isoprene-styrene block copolymer, styrene-butadiene-isoprene-styrene block copolymer, or the like), copolymers with ethylene and propylene, copolymers with acrylonitrile, copolymers with isobutyrene, copolymers with acrylic esters (for example, as acrylic ester, ethyl acrylate, butyl acrylate, or the like can be used), and copolymers with acrylic ester and acrylonitrile (the same acrylic esters as mentioned above can be used). Among these, most preferred is a copolymer with styrene.

In addition to the above components, the polymer of the present invention is preferably copolymerized with a monomer having an acid group. As the acid group, preferred are a carboxylic acid, a sulfonic acid, and a phosphoric acid. The copolymerization ratio of a monomer having the acid group is preferably from 1% by weight to 20% by weight, and more preferably from 1% by weight to 10% by weight.

Examples of a monomer having the acid group include acrylic acid, methacrylic acid, itaconic acid, p-styrene sulfonic acid sodium salt, isopyrene sulfonic acid, phoshoryl ethyl methacrylate, and the like.

There is no particular restriction concerning the copolymerization ratio of the monomer represented by formula (M) and other monomer, but preferred is the case where the monomer represented by formula (M) is copolymerized within a range of from 10% by weight to 70% by weight, more preferably from 15% by weight to 65% by weight, and even more preferably from 20% by weight to 60% by weight.

The glass transition temperature (Tg) of the polymer obtained by copolymerizing the monomer represented by formula (M) is preferably in a range of from −30° C. to 70° C., more preferably from −10° C. to 35° C. and, most preferably from 0° C. to 35° C. In a case where Tg is lower than −30° C., film-forming property is excellent, but the formed film is poor in heat resistant strength. In a case where Tg is higher than 70° C., heat resistant strength is excellent, but film-forming property is not enough to perform film coating. However, it is possible to use two or more kinds of polymers to make Tg fall in the above range. Namely, even if a polymer has a Tg outside the above range, it is preferred that the weight-average Tg thereof is in the range mentioned above.

The I/O value of the polymer obtained by copolymerizing the monomer represented by formula (M) is preferably from 0.025 to 0.3, and more preferably from 0.05 to 0.15. The I/O value used herein means a value of an inorganic value divided by an organic value based on an organic conception diagram. In a case where the I/O value is smaller than 0.025, hydrophilicity is so poor that an uniform film formation becomes difficult in the film-forming process. In a case where the value is bigger than 0.3, the formed film becomes so hydrophilic that it has adverse influences on photographic property against humidity, and photographic performances are extremely deteriorated, and it is not preferable. The I/O value can be calculated by the method described above.

In the present invention, the polymer obtained by copolymerizing the monomer represented by formula (M) is preferably contained in the coating solution in the form of an aqueous dispersion. The aqueous dispersion may be a latex, in which water-insoluble fine particles of hydrophobic polymer are dispersed, or such in which polymer molecules are dispersed in molecular states or by forming micelles, but preferred are latex-dispersed particles.

An average particle size of the dispersed particles is in a range from 1 nm to 50000 nm, preferably from 5 nm to 1000 nm, more preferably from 10 nm to 500 nm, and even more preferably from 50 nm to 200 nm. There is no particular limitation concerning particle size distribution of the dispersed particles, and they may be widely distributed or may exhibit a monodisperse particle size distribution. From the viewpoint of controlling the physical properties of the coating solution, preferred mode of usage includes mixing two or more types of particles each having monodisperse particle distribution.

<1> Preferable Latex

Particularly preferable as the polymer latex for use in the present invention is that of styrene-butadiene copolymer or that of styrene-isoprene copolymer. The weight ratio of monomer unit for styrene to that of butadiene, or isoprene, constituting the styrene-butadiene copolymer, or the styrene-isoprene copolymer, is preferably in a range of from 40:60 to 95:5.

Further, the polymer latex of the present invention preferably contains acrylic acid or methacrylic acid in a range from 1% by weight to 6% by weight with respect to the sum of styrene and butadiene, and more preferably from 2% by weight to 5% by weight. The polymer latex of the invention preferably contains acrylic acid.

<2> Specific Examples of Latex

Specific examples of preferred polymer latexes are given below, which are expressed by the starting monomers. Concerning the compounds P-1 to P-29 and P-31 to P-46, x, y, z, and z′ in chemical formula show the mass ratio in the polymer composition, and the sum of x, y, z, and z′ is equal to 100%. Tg represents the glass transition temperature of a dry film obtained from the polymer.

| | |
|---|---|
| P-1 | |
| 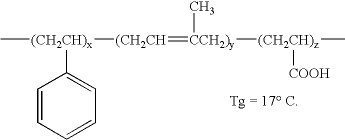 | x = 61.5 y = 35.5 z = 3 |
| P-2 | |
| 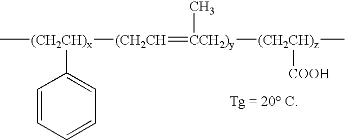 | x = 63 y = 34 z = 3 |
| P-3 | |
| 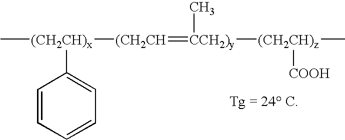 | x = 65 y = 32 z = 3 |
| P-4 | |
| 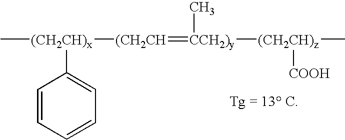 | x = 59.5 y = 37.5 z = 3 |
| P-5 | |
| 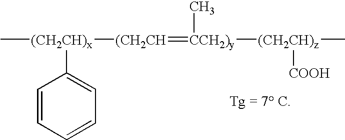 | x = 45 y = 50 z = 5 |
| P-6 | |
| 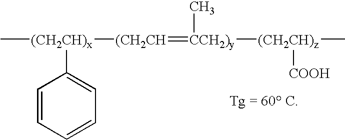 | x = 79 y = 15 z = 6 |
| P-7 | |
| 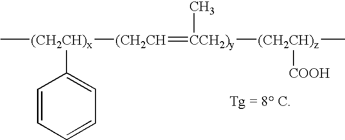 | x = 55 y = 41 z = 4 |
| P-8 | |
| 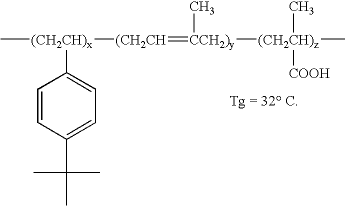 | x = 60 y = 35 z = 5 |
| P-9 | |
| 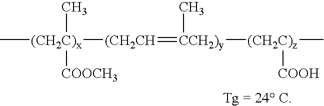 | x = 62 y = 33 z = 5 |
| P-10 | |
| 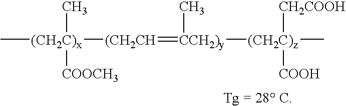 | x = 63 y = 33 z = 4 |
| P-11 | |
| 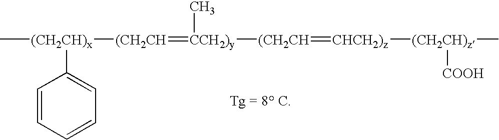 | x = 57 y = 35 z = 5 z′ = 15 |
| P-12 | |
| 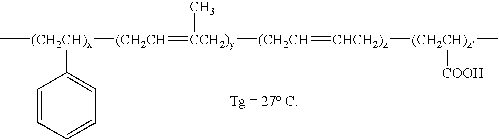 | x = 67 y = 28 z = 2 z′ = 3 |
| P-13 | |
| 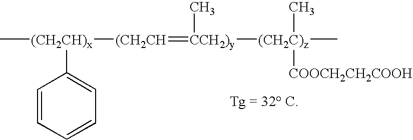 | x = 70 y = 20 z = 15 |
| P-14 | |
| 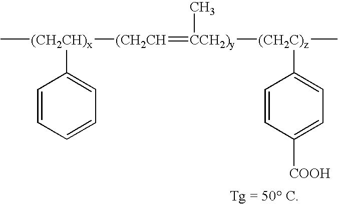 | x = 65 y = 20 z = 15 |
| P-15 | |
| 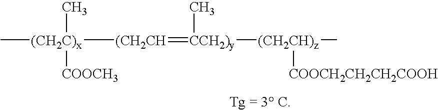 | x = 50 y = 38 z = 12 |
| P-16 | |
| 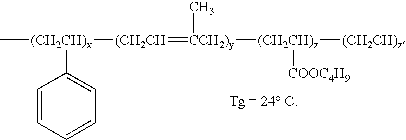 | x = 60 y = 10 z = 25 z′ = 5 |
| P-17 | |
| 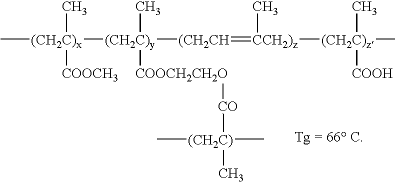 | x = 79 y = 2 z = 15 z′ = 4 |
| P-18 | |
| 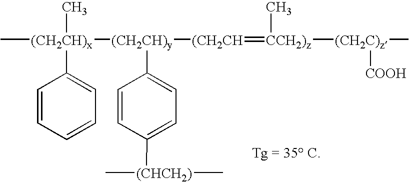 | x = 66 y = 2 z = 29 z′ = 3 |
| P-19 | |
| 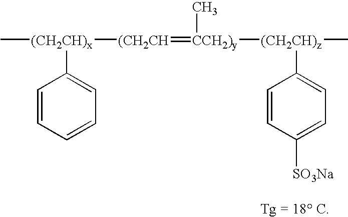 | x = 63 y = 35 z = 2 |
| P-20 | |
| 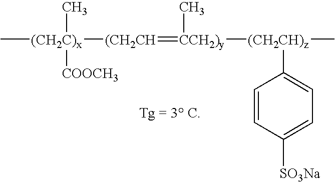 | x = 51 y = 45 z = 4 |
| P-21 | |
| 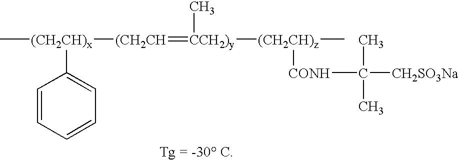 | x = 29 y = 70 z = 1 |
| P-22 | |
| 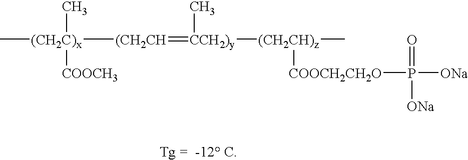 | x = 43 y = 54 z = 3 |
| P-23 | |
| 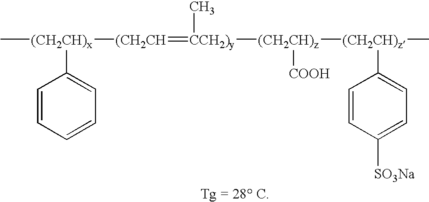 | x = 67 y = 30 z = 1 z′ = 2 |
| P-24 | |
| 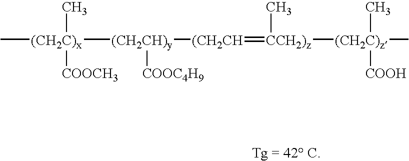 | x = 70 y = 22 z = 5 z′ = 3 |
| P-25 | |
| 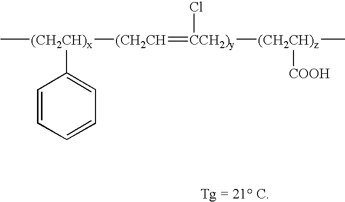 | x = 55 y = 42 z = 3 |
| P-26 | |
| 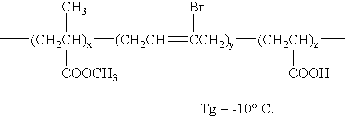 | x = 49 y = 58 z = 3 |
| P-27 | |
| 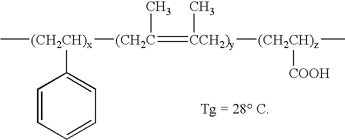 | x = 40 y = 57 z = 3 |
| P-28 | |
| 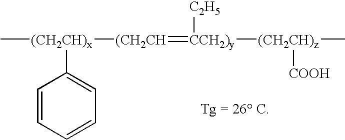 | x = 68 y = 28 z = 4 |
| P-29 | |
| 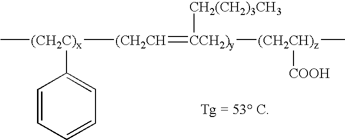 | x = 80 y = 15 z = 5 |
| P-31 | |
| 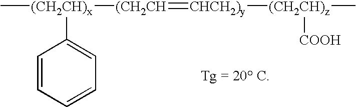 | x = 69 y = 28 z = 3 |
| P-32 | |
| 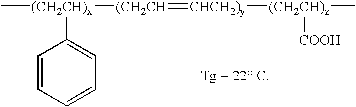 | x = 70 y = 27 z = 3 |
| P-33 | |
| 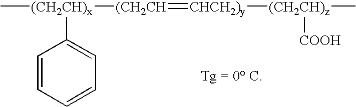 | x = 60 y = 37 z = 3 |
| P-34 | |
| 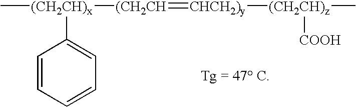 | x = 80 y = 17 z = 3 |
| P-35 | |
| 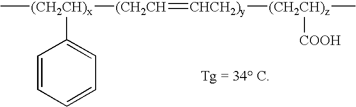 | x = 75 y = 22 z = 3 |
| P-36 | |
| 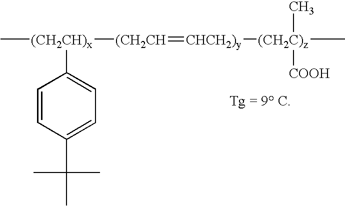 | x = 60 y = 37 z = 3 |
| P-37 | |
| 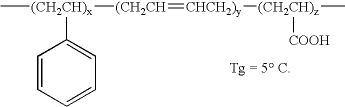 | x = 62 y = 35 z = 3 |
| P-38 | |
| 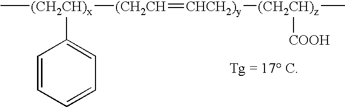 | x = 68 y = 29 z = 3 |
| P-39 | |
| 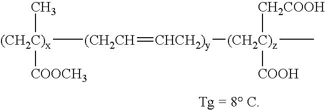 | x = 62 y = 34 z = 4 |
| P-40 | |
| 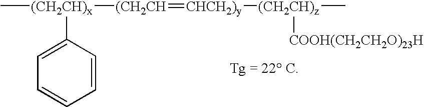 | x = 70 y = 15 z = 15 |
| P-41 | |
| 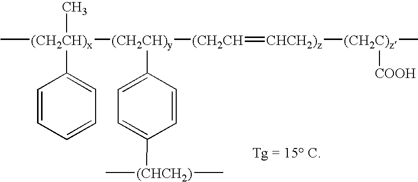 | x = 65 y = 2 z = 30 z′ = 3 |
| P-42 | |
| 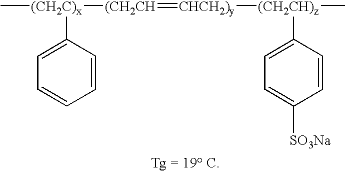 | x = 70 y = 27 z = 3 |
| P-43 | |
| 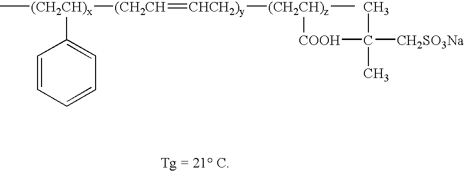 | x = 68 y = 29 z = 3 |
| P-44 | |
| 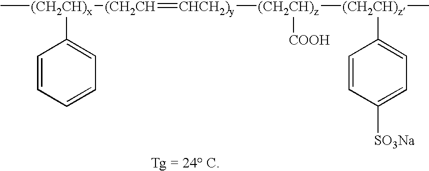 | x = 70 y = 27 z = 1 z′ = 2 |
| P-45 | |
| 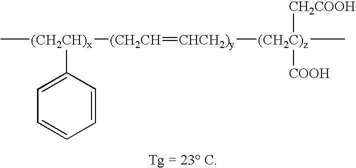 | x = 70 y = 27 z = 3 |
| P-46 | |
| 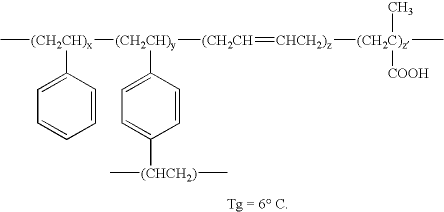 | x = 60 y = 3 z = 35 z′ = 2 |

As examples of commercially available latex of styrene-butadiene copolymer preferably used in the present invention, there can be mentioned LACSTAR 3307B and 7132C (all manufactured by Dainippon Ink and Chemicals, Inc.), Nipol Lx 416 (manufactured by Nippon Zeon Co., Ltd.), and the like.

The polymer latex above may be used alone, or may be used by blending two or more kinds depending on needs. Further, polymers other than these can be used in combination.

The polymer which can be used in combination may be either a hydrophobic polymer or a hydrophilic polymer.

Examples of the hydrophilic polymer which can be used in combination include gelatin, poly(vinyl alcohol), methyl cellulose, hydroxypropyl cellulose, carboxylmethyl cellulose, sodium polyacrylate, and the like. Such hydrophilic polymer is preferably added in an amount of 30% by weight or less, and more preferably 10% by weight or less, with respect to the total amount of the binder in the non-photosensitive intermediate layer.

Examples of hydrophobic polymer which can be used in combination include polymers which can be included in the following hydrophobic polymer layer, such as polyacrylate, polyurethane, polymethacrylate, copolymers thereof, latexes thereof, and the like. The hydrophobic polymer is preferably added in an amount of 30% by weight or less, and more preferably 10% by weight or less, with respect to the total amount of the binder in the non-photosensitive intermediate layer.

The polymer used in the binder of the present invention can be readily obtained by a solution polymerizing method, a suspension polymerizing method, an emulsion polymerizing method, a dispersion polymerizing method, an anionic polymerizing method, a cationic polymerizing method, or the like, however most preferable is an emulsion polymerizing method by which polymer can be obtained as a latex. For example, the polymer latex is obtained by emulsion polymerization at the temperature of from about 30° C. to 100° C., preferably from 60° C. to 90° C., for 3 hours to 24 hours with stirring using water or a mixed solvent of water and a water-miscible organic solvent (for example, methanol, ethanol, acetone, or the like) as a dispersion medium, and using a monomer mixture in an amount of from 5% by weight to 150% by weight with respect to the dispersion medium, an emulsifying agent in an amount of from 0.1% by weight to 20% by weight with respect to the total amount of monomers, and a polymerization initiator. Conditions such as the kind of the dispersion medium, monomer concentration, the amount of the initiator, the amount of the emulsifying agent, the amount of the dispersing agent, the reaction temperature, and the adding method of the monomer may be appropriately determined considering the kind of the monomer used. A dispersing agent is preferably used at need.

Emulsion polymerization is usually carried out according to the following documents: “Gosei Jushi Emulsion (Synthetic Resin Emulsion)” ed. by Taira Okuda and Hiroshi Inagaki, Polymer Publishing Association (1978); “Gosei Latex no Oyo (Application of Synthetic Latex)” ed. by Taka-aki Sugimura, Yasuo Kataoka, Soichi Suzuki and Keiji Kasahara, Polymer Publishing Association (1993); and “Gosei Latex no Kagaku (Chemistry of Synthetic Latex)” by Soichi Muroi, Polymer Publishing Association (1970).

Emulsion polymerizing method for synthesizing the polymer latex of the invention may be selected from an overall polymerizing method, a monomer addition (continuous or divided) method, an emulsion adding method and a seed polymerizing method. The overall polymerizing method, monomer addition (continuous or divided) method, and emulsion adding method are preferable in view of productivity of the latex.

The polymerization initiator described above may have a radical generation ability, and examples of them available include inorganic peroxides such as persulfate salts and hydrogen peroxide, peroxides described in the catalogue of organic peroxides by Nippon Oil and Fat Co., and azo compounds described in azo polymerization initiator catalogue by Wako Pure Chemical Industries, Ltd. Among them, a water-soluble peroxides such as persulfate, and water-soluble azo compounds described in azo polymerization initiator catalogue by Wako Pure Chemical Industries, Ltd., are preferable. Ammonium persulfate, sodium persulfate, potassium persulfate, azobis(2-methylpropionamidine)hydrochloride, azobis(2-methyl-N-(2-hydroxyethyl)propionamide, and azobiscyanovaleric acid are more preferable, and particularly, peroxides such as ammonium persulfate, sodium persulfate and potassium persulfate are preferable from the viewpoint of image storability, solubility, and cost.

The addition amount of the polymerization initiator described above is preferably in a range of from 0.3% by weight to 2.0% by weight, more preferably 0.4% by weight to 1.75% by weight, and particularly preferably 0.5% by weight to 1.5% by weight, with respect to the total amount of monomers. Image storability decreases when the amount of the polymerization initiator is less than 0.3% by weight, while the latex tends to be aggregated to deteriorate coating ability when the amount of the polymerization initiator exceeds 2.0% by weight.

Concerning the polymerization emulsifying agent mentioned above, any surfactants such as an anionic surfactant, a nonionic surfactant, a cationic surfactant, or an amphoteric surfactant can be employed. An anionic surfactant is preferably employed from the viewpoint of dispersibility and image storability, and more preferred is a sulfonic acid-type anionic surfactant which maintains the polymerization stability even in a small amount and has a hydrolysis resistance. Preferred is a long chain alkyl diphenylether disulfonate such as “PELEX SS-H” (trade name, available from Kao Co., Ltd.), and particularly preferred is a low electrolyte-type surfactant such as “PIONIN A-43-S” (trade name, available from Takemoto Oil & Fat Co., Ltd.).

As the polymerization emulsifying agent mentioned above, a sulfonic acid-type surfactant is preferably used in a range of from 0.1% by weight to 10.0% by weight, more preferably from 0.2% by weight to 7.5% by weight, and particularly preferably from 0.3% by weight to 5.0% by weight, with respect to the total amount of monomers in each case. Stability in the emulsion polymerization process can not secure when the addition amount of the polymerization emulsifying agent is less than 0.1% by weight, while image storability decreases when the addition amount exceeds 10.0% by weight.

It is prefered to use a chelating agent for the synthesis of the polymer latex used in the invention. The chelating agent is a compound capable of coordinating multi-valent metal ions such as iron ion, and alkali earth metal ions such as calcium ion, and examples thereof include the compounds described in Japanese Patent Application Publication (JP-B) No. 6-8956; U.S. Pat. No. 5053322; and JP-A Nos. 4-73645, 4-127145, 4-247073, 4-305572, 6-11805, 5-173312, 5-66527, 5-158195, 6-118580, 6-110168, 6-161054, 6-175299, 6-214352, 7-114161, 7-114154, 7-120894, 7-199433, 7-306504, 9-43792, 8-314090, 10-182571, 10-182570, and 11-190892.

The chelating agent used in the invention is preferably an inorganic chelating compound (sodium tripolyphosphate, sodium hexametaphosphate, sodium tetrapolyphosphate, or the like), an aminopolycarboxylic acid chelating compound (nitrilotriacetic acid, ethylenediamine tetraacetic acid, or the like), an organic phosphonic acid chelating agent (compounds described in Research Disclosure No. 18170, JP-A Nos. 52-102726; 53-42730, 56-97347, 54-121127, 55-4024, 55-4025, 55-29883, 55-126241, 55-65955, 55-65956, 57-179843, and 54-61125; and West Germany Patent (WGP) No. 1045373), a polyphenol chelating agent, or a polyamine chelating agent. An aminopolycarboxylic acid derivative is particularly preferable.

Preferable examples of the aminopolycarboxylic acid derivative are described in the supplement table of “EDTA (-Chemistry of Complexane-)”, Nankodo 1977. A part of the carboxy group of these compounds may be substituted by a salt of alkali metal such as sodium or potassium, or an ammonium salt. Particularly preferable aminocarboxylic acid derivatives include iminodiacetic acid, N-methyliminodiacetic acid, N-(2-aminoethyl)iminodiacetic acid, N-(carbamoylethyl)iminodiacetic acid, nitrilotriacetic acid, ehylenediamine-N,N′-diacetic acid, ehylenediamine-N,N′-di-α-propionic acid, ethylenediamine-N,N′-di-β-propionic acid, N,N′-ethylene-bis(α-o-hydroxyphenyl)glycine, N,N′-di(2-bydroxybenzyl)ethylenediamine-N,N′-diacetic acid, ethylenediamine-N,N′-diacetic acid-N,N′-diacetohydroxamic acid, N-hydroxyethylethylenediamine-N,N′,N′-triacetic acid, ethylenediamine-N,N,N′,N′-tetraacetic acid, 1,2-propylenediamine-N,N,N′,N′-tetraacetic acid, d,1-2,3-diaminobutane-N,N,N′,N′-tetraacetic acid, meso-2,3-diaminobutane-N,N,N′,N′-tetraacetic acid, 1-phenylethylenediamine-N,N,N′,N′-tetraacetic acid, d,1-1,2-diphenylethylenediamine-N,N,N′,N′-tetraacetic acid, 1,4-diaminobutane-N,N,N′,N′-tetraacetic acid, trans-cyclobutane-1,2-diamine-N,N,N′,N′-tetraacetic acid, trans-cyclopentane-1,2-diamine-N,N,N′,N′-tetraacetic acid, trans-cyclohexane-1,2-diamine-N,N,N′,N′-tetraacetic acid, cic-cyclohexane-1,2-diamine-N,N,N′,N′-tetraacetic acid, cyclohexane-1,3-diamine-N,N,N′,N′-tetraacetic acid, cyclohexane-1,4-diamine-N,N,N′,N′-tetraacetic acid, o-phenylenediamine-N,N,N′,N′-tetraacetic acid, cis-1,4-diaminobutene-N,N,N′,N′-tetraacetic acid, trans-1,4-diaminobutene-N,N,N′,N′-tetraacetic acid, α,α′-diamino-o-xylene-N,N,N′,N′-tetraacetic acid, 2-hydroxy-1,3-propanediamine-N,N,N′,N′-tetraacetic acid, 2,2-oxy-bis(ethyliminodiacetic acid), 2,2′-ethylenedioxy-bis(ethylimonodiacetic acid), ethylenediamine-N,N′-diacetic acid-N,N′-di-o-propionic acid, ethylenediamine-N,N′-diacetic acid-N,N′-di-p-propionic acid, ethylenediamine-N,N,N′,N′-tetrapropionic acid, diethylenetriamine-N,N,N′,N″,N″-pentaacetic acid, triethylenetetramine-N,N,N′,N″,N′″,N′″-hexaacetic acid, and 1,2,3-triaminopropane-N,N,N′,N″,N′″,N′″-hexaacetic acid. A part of the carboxylic group of these compounds may be substituted by a salt of alkali metal such as sodium or potassium, or an ammonium salt.

The addition amount of the chelating agent described above is preferably from 0.01% by weight to 0.4% by weight, more preferably from 0.02% by weight to 0.3% by weight, and particularly preferably from 0.03% by weight to 0.15% by weight, with respect to the total amount of monomers. Metal ions mingling in the production process of the polymer latex are insufficiently trapped when the amount of the chelating agent is less than 0.01% by weight to decrease stability of the latex against aggregation to deteriorate coating ability. When the content exceeds 0.4%, on the other hand, viscosity of the latex increases to deteriorate coating ability.

A chain transfer agent is preferably used in the synthesis of the polymer latex used in the present invention. The compounds described in Polymer Handbook Third Edition (Wiley-Interscience, 1989) are preferable as the chain transfer agents. Sulfur compounds are preferable since they have high chain transfer ability to make the amount of use of the reagent small. Particularly preferable chain transfer agents are hydrophobic mercaptan chain transfer agents such as tert-dodecylmercaptan, n-dodecylmercaptan, or the like.

The amount of the chain transfer agent described above is preferable from 0.2% by weight to 2.0% by weight, more preferably from 0.3% by weight to 1.8% by weight, and particularly preferably from 0.4% by weight to 1.6% by weight, with respect to the total amount of monomers. Manufacturing-related brittleness is decreased when the amount of the chain transfer agent is less than 0.2% by weight, while image storability is deteriorated when the amount exceeds 2.0% by weight.

In the emulsion polymerization, additives such as an electrolyte, a stabilizer, a thickener, a defoaming agent, an antioxidant, a vulcanizing agent, an antifreeze agent, a gelling agent, a vulcanization accelerator, or the like described in Synthetic Rubber Handbook and the like may be used in addition to the compounds above.

While examples of synthesis of the polymers used in the invention are shown below, the invention is not restricted to the synthetic methods shown below. Similar synthetic method may be used for synthetizing other compounds in the examples.

### SYNTHETIC EXAMPLE 1

### Synthesis of Compound P-1

Into the polymerization vessel of gas monomer reaction apparatus (type TAS-2J, manufactured by Taiatsu Techno Corp.), 1500 g of distilled water were poured and heated for 3 hours at 90° C. to make passive film over the stainless-steel vessel surface and stainless-steel stirring device. Into the polymerization vessel after this treatment were added 584.86 g of distilled water which was bubbled with nitrogen gas for 1 hour, 9.45 g of a surfactant (PIONIN A-43-S produced by Takemoto Oil and Fats Cp.), 20.25 g of 1 mol/L sodium hydroxide, 0.216 g of ethylenediamine tetraacetic acid tetrasodium salt, 332.1 g of styrene, 191.7 g of isoprene, 16.2 g of acrylic acid, and 4.32 g of tert-dodecyl mercaptan. And then the reaction vessel was sealed the mixture was stirred at 225 rpm, followed by elevating the inner temperature to 60° C. To the aforementioned mixture was added a solution prepared through dissolving 2.7 g of ammonium persulfate in 50 mL of water, and kept for 7 hours with stirring. Furthermore, the mixture was heated to 90° C. with stirring for 3 hours. After the reaction was completed, the inner temperature of the reaction vessel was cooled to room temperature. The polymer obtained was filtered through a filter cloth (mesh: 225), then 1145 g of the example compound P-1 (solid content of 45% by weight, mean particle diameter of 112 nm) was obtained.

### SYNTHETIC EXAMPLE 2

### Synthesis of Compound P-2

Into the reaction vessel of gas monomer reaction apparatus (type TAS-2J manufactured by Tiatsu Garasu Kogyo Ltd.) pretreated to make passive film similar to the above-described Synthetic Example 1, 350.92 g of distilled water which was bubbled with nitrogen gas for 1 hour, 3.78 g of the surfactant (PIONIN A-43-S produced by Takemoto Oil and Fats Cp.), 20.25 g of 1 mol/L sodium hydroxide, 0.216 g of ethylenediamine tetraacetic acid tetrasodium salt, 34.02 g of styrene, 18.36 g of isoprene, 1.62 g of acrylic acid, and 2.16 g of tert-dodecyl mercaptan were added. Thereafter, the reaction vessel was sealed and the mixture was stirred at 225 rpm, followed by elevating the inner temperature to 65° C. To this mixture was added a solution prepared through dissolving 1.35 g of ammonium persulfate in 50 mL of water and kept for 2 hours with stirring. An emulsion was separately prepared by adding, with stirring, 233.94 g of distilled water, 5.67 g of the surfactant (PIONIN A-43-S produced by Takemoto Oil and Fats Cp.), 306.18 g of styrene, 165.24 g of isoprene, 14.58 g of acrylic acid, 2.16 g of tert-dodecyl mercaptan, and 1.35 g of ammonium persulfate. The emulsion was poured dropwise over 8 hours into the reaction vessel described above. The reaction solution was further stirred for 2 hours after completing the addition. Thereafter the resulting mixture was further stirred for 3 hours by elevating the temperature at 90° C. After the reaction was completed, the inner temperature of the reaction vessel was cooled to room temperature. The polymers obtained was filtered through a filter cloth (mesh: 225), then 1147 g of the example compound P-2 (solid content of 45% by weight, mean particle diameter of 121 nm) was obtained.

### SYNTHETIC EXAMPLE 3

### Synthesis of Compound P-4

Into the reaction vessel of gas monomer reaction apparatus (type TAS-2J manufactured by Tiatsu Garasu Kogyo Ltd.) pretreated to make passive film similar to the above-described Synthetic Example 1, 578.11 g of distilled water which was bubbled with nitrogen gas for one hour, 16.2 g of the surfactant (PELEX SS-H produced by Kao Co., Ltd.), 20.25 g of 1 mol/L sodium hydroxide, 0.216 g of ethylenediamine tetraacetic acid tetrasodium salt, 321.3 g of styrene, 202.5 g of isoprene, 16.2 g of acrylic acid, and 4.32 g of tert-dodecyl mercaptan were added. Thereafter the reaction vessel was sealed and the mixture was stirred at the stirring rate of 225 rpm, followed by elevating the inner temperature to 60° C. To the aforesaid mixture was added a solution prepared through dissolving 2.7 g of ammonium persulfate in 25 mL of water, and kept for 5 hours with stirring. Furthermore a solution obtained dissolving 1.35 g of ammonium persulfate dissolved in 25 mL of water was added to the mixture. Then the mixture was heated to 90° C. and stirred for 3 hours. After the reaction was completed, the inner temperature of the vessel was cooled to room temperature. The polymers obtained was filtered through filter cloth (mesh: 225), then 1139 g of the example compound P-4 (solid content of 45% by weight, mean particle diameter of 105 nm) was obtained.

### SYNTHETIC EXAMPLE 4

### Synthesis of Compound P-31

Into the polymerization vessel of gas monomer reaction apparatus (type TAS-2J, manufactured by Taiatsu Techno Corp.), 1500 g of distilled water were poured and heated for 3 hours at 90° C. to make passive film over the stainless-steel vessel surface and stainless-steel stirring device. Into the polymerization vessel after this treatment were added 584.86 g of distilled water, 9.70 g of a surfactant (PIONIN A-43-S produced by Takemoto Oil and Fats Cp.), 20.25 g of 1 mol/L sodium hydroxide, 0.216 g of ethylenediamine tetraacetic acid tetrasodium salt, 372.6 g of styrene, 16.2 g of acrylic acid, and 4.32 g of tert-dodecyl mercaptan. And then the reaction vessel was sealed the mixture was stirred at 225 rpm. Degassing was conducted with a vacuum pump, followed by repeating nitrogen gas replacement several times. Thereto was injected 151.2 g of 1,3-butadiene, and the inner temperature is elevated to 60° C.

Thereto was added a solution of 2.7 g of ammonium persulfate dissolved in 50 mL of water, and the mixture was stirred for 5 hours as it stands. The temperature was further elevated to 90° C., followed by stirring for 3 hours. After completing the reaction, the inner temperature was lowered to reach to the room temperature, and thereafter the mixture was treated by adding 1 mol/L sodium hydroxide and ammonium hydroxide to give the molar ratio of Na⁺ ion:NH₄⁺ ion=1:5.3, and thus, the pH of the mixture was adjusted to 8.4. Thereafter, filtration with a polypropylene filter having the pore size of 1.0 μm was conducted to remove foreign substances such as dust followed by storage. Accordingly, 1150 g of the example compound P-31 (solid content of 44% by weight, mean particle diameter of 91 nm, Tg=20° C.) was obtained. Upon the measurement of halogen ion by ion chromatography, concentration of chloride ion was revealed to be 3 ppm.

In the invention, for the solvent of a coating solution for the polymer latex, aqueous solvent can be used and any of water-miscible organic solvents may be used in combination.

As water-miscible organic solvents, there can be used, for example, alcohols such as methyl alcohol, ethyl alcohol, propyl alcohol, or the like; cellosolves such as methyl cellosolve, ethyl cellosolve, butyl cellosolve, and the like; ethyl acetate, dimethylformamide, or the like. The addition amount of the organic solvent is preferably 50% by weight or less, and more preferably 30% by weight or less, with respect to the solvent.

Concerning the polymer latex of the invention, the concentration of the polymer is preferably from 10% by weight to 70% by weight, more preferably from 20% by weight to 60% by weight, and particularly preferably from 30% by weight to 55% by weight, with respect to the latex liquid in each case.

Concerning the polymer latex of the invention, the equilibrium water content under 25° C. and 60%RH is preferably 2% by weight or lower, more preferably, in a range of from 0.01% by weight to 1.5% by weight, and even more preferably, from 0.02% by weight to 1.0% by weight.

The term “equilibrium water content under 25° C. and 60% RH” as referred herein can be expressed as follows:
Equilibrium water content under 25° C. and 60% RH=[(W1−W0)/W0]×100 (% by weight)

wherein W1 is the weight of the polymer in moisture-controlled equilibrium under the atmosphere of 25° C. and 60% RH, and W0 is the absolutely dried weight at 25° C. of the polymer.

For the definition and the method of measurement for water content, reference can be made to Polymer Engineering Series 14, “Testing methods for polymeric materials” (The Society of Polymer Science, Japan, published by Chijin Shokan).

The total amount of binder in the non-photosensitive intermediate layer of the invention is preferably in a range from 0.2 g/m² to 30 g/m², more preferably from 1 g/m² to 15 g/m², and even more preferably 2 g/m² to 10 g/m².

2) Crosslinking Agent

According to the present invention, a crosslinking agent is preferably added in any layer on the side having thereon an image forming layer, and more preferably a crosslinking agent is added in the non-photosensitive intermediate layer. The addition of a crosslinking agent can produce an excellent photothermographic material having a non-photosensitive intermediate layer exhibiting a good degree of hydrophobic property and water resistance.

As the crosslinking agent, it is enough that the crosslinking agent has plural groups, which react with a carboxy group, in a molecule, and the species of crosslinking agent are not particularly limited. Examples of the crosslinking agent are described in T. H. James, “THE THEORY OF THE PHOTOGRAPHIC PROCESS, FOURTH EDITION” (Macmillan Publishing Co., Inc., pages 77 to 87, 1977). Both of a crosslinking agent of inorganic compound (for example, chrome alum) and a crosslinking agent of organic compound are preferred, but more preferred is a crosslinking agent of organic compound.

As preferable organic compounds of the crosslinking agent, carboxylic acid derivatives, carbamic acid derivatives, sulfonate ester compounds, sulfonyl compounds, epoxy compounds, aziridine compounds, isocyanate compounds, carbodiimide compounds, and oxazoline compounds can be described. Epoxy compounds, isocyanate compounds, carbodiimide compounds, and oxazoline compounds are more preferred. The crosslinking agent may be used alone or two or more kinds of them may be used in combination.

Specifically, following compounds can be described, however, the present invention is not limited in following examples.

<Carbodiimide>

Water-soluble or water-dispersible carbodiimide compounds are preferred, and as examples, polycarbodiimide derived from isophorone diisocyanate described in JP-A No. 59-187029 and JP-B No. 5-27450, carbodiimide compounds derived from tetramethylxylylene diisocyanate described in JP-A No. 7-330849, multi-branched type carbodiimide compounds described in JP-A No. 10-30024, and carbodiimide compounds derived from dicyclohexyl methanediisocyanate described in JP-A No. 2000-7642 can be described.

<Oxazoline Compound>

Water-soluble or water-dispersible oxazoline compounds are preferred, and as example, oxazoline compounds described in JP-A No. 2001-215653 can be described.

<Isocyanate Compound>

Since it is reactable compound with water, water-dispersible isocyanate is preferred from the viewpoint of stability of its solution, and especially that having self-emulsification property is preferred. As examples, water-dispersible isocyanates described in JP-A Nos. 7-304841, 8-277315, 10-45866, 9-71720, 9-328654, 9-104814, 2000-194045, 2000-194237 and 2003-64149 can be described.

<Epoxy Compound>

Water-soluble or water-dispersible epoxy compounds are preferred, and as examples, water-dispersible epoxy compounds described in JP-A Nos. 6-329877 and 7-309954 can be described.

More specific examples of crosslinking agent for use in the present invention are shown below, however the present invention is not limited in the following examples.

<Epoxy Compound>

Trade name: Dickfine EM-60 (Dai Nippon Ink & Chemicals, Inc.)

<Isocyanate Compound) Trade name: Duranate WB40-100 (Asahi Chemical Industries Co., Ltd.)
Duranate WB40-80D (Asahi Chemical Industries Co., Ltd.)
Duranate WT20-100 (Asahi Chemical Industries Co., Ltd.))
Duranate WT30-100 (Asahi Chemical Industries Co., Ltd.) CR-60N (Dainippon Ink & Chemicals, Inc.)

<Carbodiimide Compound>Trade name: Carbodilite V-02 (Nisshinbo Industries, Inc.)
Carbodilite V-02-L2 (Nisshinbo Industries, Inc.)
Carbodilite V-04 (Nisshinbo Industries, Inc.)
Carbodilite V-06 (Nisshinbo Industries, Inc.)
Carbodilite V-02 (Nisshinbo Industries, Inc.)
Carbodilite E-01 (Nisshinbo Industries, Inc.)
Carbodilite E-02 (Nisshinbo Industries, Inc.)

<Oxazoline Compound>Trade name: Epocros K-1010E (Nippon Shokubai Co., Ltd.)
Epocros K-1020E (Nippon Shokubai Co., Ltd.)
Epocros K-1030E (Nippon Shokubai Co., Ltd.)
Epocros K-2010E (Nippon Shokubai Co., Ltd.)
Epocros K-2020E (Nippon Shokubai Co., Ltd.)
Epocros K-2030E (Nippon Shokubai Co., Ltd.)
Epocros WS-500 (Nippon Shokubai Co., Ltd.)
Epocros WS-700 (Nippon Shokubai Co., Ltd.)

The cosslinking agent for use in the present invention may be added by mixing it in a solution for binder beforehand, or may be added at the end of the preparing process of the coating solution. Or, the crosslinking agent can be added just prior to coating.

The addition amount of the crosslinking agent for use in the present invention is preferably from 0.5 part by weight to 200 part by weight with respect to 100 part by weight of a binder in a component layer including the crosslinking agent, more preferably from 2 part by weight to 100 part by weight, and even more preferably from 3 part by weight to 50 part by weight.

3) Viscosity Increasing Agent

A viscosity increasing agent is preferably added to a coating solution for the non-photosensitive intermediate layer. By the addition of the viscosity increasing agent, intermix with the adjacent layer is hardly occurred in the coating step and drying step so that preferable intermediate layer having the intended composition can be formed. Examples of the preferable viscosity increasing agent include the polymer described in the following (i) and (ii). Specifically, an aqueous dispersion of the polymer described in (ii) is particularly preferred because the aqueous dispersion thereof does not cause deterioration in hydrophobicity and water resistance of the intermediate layer.

(i) Non-Ionic or Ionic Water-Soluble Polymer

Specifically, poly(vinyl alcohol), hydroxyethyl cellulose, hydroxymethyl cellulose, an alkaline metal salt of poly(acrylic acid), an alkali metal salt of carboxymethyl cellulose, carboxymethyl-hydroxyethyl cellulose, or the like can be used.

(ii) Aqueous Dispersion of Polymer

Specifically, an aqueous dispersion of acrylic polymer, an aqueous dispersion of synthetic rubber polymer (for example, styrene-butadiene copolymer), an aqueous dispersion of polyether polymer, an aqueous dispersion of polyurethane polymer, or the like can be used. Especially, in regard to the handling property, preferred examples of polymer having thixotropic property include hydroxyethyl cellulose, sodium hydroxymethylcarbonate, and carboxymethyl-hydroxyethyl cellulose.

The viscosity of the coating solution for non-photosensitive intermediate layer containing the viscosity increasing agent, measured at 40° C., is preferably from 1 mPa.s to 1000 mPa.s, more preferably from 1 mPa.s to 200 mPa.s, and even more preferably from 10 mPa.s to 100 mPa.s.

Various additives other than the binder can be incorporated in the non-photosensitive intermediate layer. In addition to the crosslinking agent and viscosity increasing agent set forth above, examples of the additives include a surfactant, a pH controlling agent, a film-forming promoting agent aid, inorganic fine particles, and the like.

(Layer Containing a Binder Which can Gelate upon Decrease in Temperature)

In the present invention, a binder which can gelate upon decrease in temperature is used in at least one layer of the non-photosensitive layers, which is disposed on the same side of the support as the image forming layer and is besides the non-photosensitive intermediate layer described above. The binder which can gelate means a water-soluble polymer derived from animal proteins described below or water-soluble polymers and hydrophobic polymers which are not derived from animal protein to which a gelling agent is added.

By gelation, the layer formed by coating loses fluidity, so the surface of the image forming layer is hard to be effected by air for drying, at the drying step after coating step, and therefore, a photothermographic material with uniformly coated surface can be obtained. Herein, it is important that a coating solution does not been gelled at the coating step. It is convenient for operation that the coating solution has fluidity at the coating step and loses fluidity by gelation before the drying step after coating step. Viscosity of the said coating solution at a coating step is preferably from 1 mPa.s to 1000 mPa.s, more preferably from 1 mPa.s to 200 mPa.s, and even more preferably from 10 mPa.s to 100 mPa.s.

In the present invention, an aqueous solvent is used as a solvent for a coating solution. The aqueous solvent as referred herein, signifies water or the mixture of water and 70% by weight or less of a water-miscible organic solvent. As water-miscible organic solvents, there can be mentioned, for example, alcohols such as methyl alcohol, ethyl alcohol, propyl alcohol, or the like; cellosolves such as methyl cellosolve, ethyl cellosolve, butyl cellosolve, or the like; ethyl acetate, dimethylformamide, and the like.

Though it is difficult to measure the viscosity of formed layer at the time before the drying step and after coating step (at this point, gelation occurs), it is guessed that the viscosity is almost from 200 mPa.s to 5,000 mPa.s, and preferably from 500 mPa.s to 5,000 mPa.s.

The temperature for gelation is not specifically limited, however to consider the easy work operation of coating, the temperature for gelation is preferably nearly about a room temperature. Because at this temperature, it is easy to make the fluidity increase for easy coating of a coating solution and the fluidity can be maintained (that is namely the temperature level, in which the elevated temperature can be maintained easily) and this is the temperature that the cooling can be easily operated to make the fluidity of formed layer lose after coating. Preferable temperature for gelation is from 0° C. to 40° C., and more preferably from 0° C. to 35° C.

The temperature of a coating solution at coating step is not specifically limited as far as the temperature is set higher than a temperature for gelation, and the cooling temperature at the point before drying step and after coating step is not specifically limited as far as the temperature is set lower than a temperature for gelation. However, when the difference between the temperature of coating solution and a cooling temperature is small, the problem that gelation starts during coating step occurs and an uniform coating can not be performed. On the other hand, when the temperature of coating solution is set too high to make this temperature difference large, it causes the problem that the solvent of coating solution is evaporated and viscosity is changed. Therefore, the difference of temperatures is preferably set up in a range of from 5° C. to 50° C., more preferably from 10° C. to 40° C.

As regards the layer containing the binder which can gelate, there is no limitation so long as the layer is disposed on the image forming layer side to the support and is the layer other than the non-photosensitive intermediate layer described above. The mentioned layer is preferably an outermost layer or a layer adjacent to the outermost layer fron the viewpoint of depressing unevenness in the film surface caused by air for drying, at the drying step. The outermost layer used herein means the layer which is disposed on the same side as the image forming layer and is the farthest layer from the support.

1) Water-Soluble Polymer Derived from Animal Protein

In the present invention, the polymer derived from animal protein means natural or chemically modified water-soluble polymer such as glue, casein, gelatin, egg white, or the like.

It preferably is gelatin, in which are acid treated gelatin and alkali treated gelatin (lime extracted gelatin and the like) depending on a synthetic method and any of them can be preferably used. The molecular weight of gelatin used is preferably 10,000 to 1,000,000. Modified gelatin of an amino group or a carboxy group of gelatin (e.g., phthalated gelatin or the like) can be also used.

In an aqueous gelatin solution, solation occurs when gelatin is heated to 30° C. or higher, and gelation occurs and the solution loses fluidity when it is cooled to lower than 30° C. As this sol-gel exchange occurs reversibly, an aqueous gelatin solution as coating solution has the set property. That means, gelatin solution loses fluidity when it is cooled to lower than 30° C.

Further, the polymer derived from animal protein can be used in combination with the following water-soluble polymer which is not derived from animal protein and/or a hydrophobic polymer.

In the coating solution, the content of water-soluble polymer derived from animal protein is from 1% by weight to 20% by weight, preferably from 2% by weight to 12% by weight, with respect to the total coating solution.

2) Water-Soluble Polymer Which is not Derived from Animal Protein

In the present invention, a water-soluble polymer which is not derived from an animal protein means a natural polymer (polysaccharide series, microorganism series, or animal series) except for animal protein such as gelatin or the like, a semi-synthetic polymer (cellulose series, starch series, or alginic acid series), and a synthetic polymer (vinyl series or others) and corresponds to synthetic polymer such as poly(vinyl alcohol) described below and natural or semi-synthetic polymer made by cellulose or the like derived from plant as a raw material. Poly(vinyl alcohols) and acrylic acid-vinyl alcohol copolymers are preferable. When the water-soluble polymer which is not derived from an animal protein is used in the layer adjacent to the outermost layer, the polymer is used in combination with the gelling agent described below because the water-soluble polymer which is not derived from an animal protein has no setting ability.

<1> Poly(vinyl Alcohols)

The water-soluble polymer which is not derived from an animal protein according to the present invention is preferably poly(vinyl alcohols).

As the poly(vinyl alcohols) (PVA) preferably used in the present invention, there are compounds that have various degree of saponification, degree of polymerization, degree of neutralization, modified compound, and copolymer with various monomers as described below.

As fully saponified compound, it can be selected among PVA-105 (poly(vinyl alcohol) (PVA) content: 94.0% by weight or more, degree of saponification: 98.5±0.5 mol %, content of sodium acetate: 1.5% by weight or less, volatile constituent: 5.0% by weight or less, viscosity (4% by weight at 20° C.): 5.6±0.4 CPS], PVA-110 [PVA content: 94.0% by weight, degree of saponification: 98.5±0.5 mol %, content of sodium acetate: 1.5% by weight, volatile constituent: 5.0% by weight, viscosity (4% by weight at 20° C.): 11.0±0.8 CPS], PVA-117 [PVA content: 94.0% by weight, degree of saponification: 98.5±0.5 mol %, content of sodium acetate: 1.0% by weight, volatile constituent: 5.0% by weight, viscosity (4% by weight at 20° C.): 28.0±3.0 CPS], PVA-117H [PVA content: 93.5% by weight, degree of saponification: 99.6±0.3 mol %, content of sodium acetate: 1.85% by weight, volatile constituent: 5.0% by weight, viscosity (4% by weight at 20° C.): 29.0±0.3 CPS], PVA-120 [PVA content: 94.0% by weight, degree of saponification: 98.5±0.5 mol %, content of sodium acetate: 1.0% by weight, volatile constituent: 5.0% by weight, viscosity (4% by weight at 20° C.): 39.5±4.5 CPS], PVA-124 [PVA content: 94.0% by weight, degree of saponification: 98.5±0.5 mol %, content of sodium acetate: 1.0% by weight, volatile constituent: 5.0% by weight, viscosity (4% by weight at 20° C.): 60.0±6.0 CPS], PVA-124H [PVA content: 93.5% by weight, degree of saponification: 99.6±0.3 mol %, content of sodium acetate: 1.85% by weight, volatile constituent: 5.0% by weight, viscosity (4% by weight at 20° C.): 61.0±6.0 CPS], PVA-CS [PVA content: 94.0% by weight, degree of saponification: 97.5±0.5 mol %, content of sodium acetate: 1.0% by weight, volatile constituent: 5.0% by weight, viscosity (4% by weight at 20° C.): 27.5±3.0 CPS], PVA-CST [PVA content: 94.0% by weight, degree of saponification: 96.0±0.5 mol %, content of sodium acetate: 1.0% by weight, volatile constituent: 5.0% by weight, viscosity (4% by weight at 20° C.): 27.0±3.0 CPS], PVA-HC [PVA content: 90.0% by weight, degree of saponification: 99.85 mol % or more, content of sodium acetate: 2.5% by weight, volatile constituent: 8.5% by weight, viscosity (4% by weight at 20° C.): 25.0±3.5 CPS] (above all trade names, produced by Kuraray Co., Ltd.), and the like.

As partial saponified compound, it can be selected among PVA-203 [PVA content: 9.4.0% by weight, degree of saponification: 88.0±1.5 mol %, content of sodium acetate: 1.0% by weight, volatile constituent: 5.0% by weight, viscosity (4% by weight at 20° C.): 3.4±0.2 CPS], PVA-204[PVA content: 94.0% by weight, degree of saponification: 88.0±1.5 mol %, content of sodium acetate: 1.0% by weight, volatile constituent: 5.0% by weight, viscosity (4% by weight at 20° C.): 3.9±0.3 CPS], PVA-205 [PVA content: 94.0% by weight, degree of saponification: 88.0±1.5 mol %, content of sodium acetate: 1.0% by weight, volatile substance: 5.0% by weight, viscosity (4% by weight at 20° C.): 5.0±0.4 CPS], PVA-210 [PVA content: 94.0% by weight, degree of saponification: 88.0±1.0 mol %, content of sodium acetate: 1.0% by weight, volatile constituent: 5.0% by weight, viscosity (4% by weight at 20° C.): 9.0±1.0 CPS], PVA-217 [PVA content: 94.0% by weight, degree of saponification: 88.0±1.0 mol %, content of sodium acetate: 1.0% by weight, volatile constituent: 5.0% by weight, viscosity (4% by weight at 20° C.): 22.5±2.0 CPS], PVA-220 [PVA content: 94.0% by weight, degree of saponification: 88.0±1.0 mol %, content of sodium acetate: 1.0% by weight, volatile constituent: 5.0% by weight, viscosity (4% by weight at 20° C.): 30.0±3.0 CPS], PVA-224 [PVA content: 94.0% by weight, degree of saponification: 88.0±1.5 mol %, content of sodium acetate: 1.0% by weight, volatile constituent: 5.0% by weight, viscosity (4% by weight at 20° C.): 44.0±4.0 CPS], PVA-228 [PVA content: 94.0% by weight, degree of saponification: 88.0±1.5 mol %, content of sodium acetate: 1.0% by weight, volatile constituent: 5.0% by weight, viscosity (4% by weight at 20° C.): 65.0±5.0 CPS], PVA-235 [PVA content: 94.0% by weight, degree of saponification: 88.0±1.5 mol %, content of sodium acetate: 1.0% by weight, volatile constituent: 5.0% by weight, viscosity (4% by weight at 20° C.): 95.0±15.0 CPS], PVA-217EE [PVA content: 94.0% by weight, degree of saponification: 88.0±1.0 mol %, content of sodium acetate: 1.0% by weight, volatile constituent: 5.0% by weight, viscosity (4% by weight at 20° C.): 23.0±3.0 CPS], PVA-217E [PVA content: 94.0% by weight, degree of saponification: 88.0±1.0 mol %, content of sodium acetate: 1.0% by weight, volatile constituent: 5.0% by weight, viscosity (4% by weight at 20° C.): 23.0±3.0 CPS], PVA-220E [PVA content: 94.0% by weight, degree of saponification: 88.0±1.0 mol %, content of sodium acetate: 1.0% by weight, volatile constituent: 5.0% by weight, viscosity (4% by weight at 20° C.): 31.0±4.0 CPS], PVA-224E [PVA content: 94.0% by weight, degree of saponification: 88.0±1.0 mol %, content of sodium acetate: 1.0% by weight, volatile constituent: 5.0% by weight, viscosity (4% by weight at 20° C.): 45.0±5.0 CPS], PVA-403 [PVA content: 94.0% by weight, degree of saponification: 80.0±1.5 mol %, content of sodium acetate: 1.0% by weight, volatile constituent: 5.0% by weight, viscosity (4% by weight at 20° C.): 3.1±0.3 CPS], PVA-405 [PVA content: 94.0% by weight, degree of saponification: 81.5±1.5 mol %, content of sodium acetate: 1.0% by weight, volatile constituent: 5.0% by weight, viscosity (4% by weight at 20° C.): 4.8±0.4 CPS], PVA-420 [PVA content: 94.0% by weight, degree of saponification: 79.5±1.5 mol %, content of sodium acetate: 1.0% by weight, volatile constituent: 5.0% by weight], PVA-613 [PVA content: 94.0% by weight, degree of saponification: 93.5±1.0 mol %, content of sodium acetate: 1.0% by weight, volatile constituent: 5.0% by weight, viscosity (4% by weight at 20° C.): 16.5±2.0 CPS], L-8 [PVA content: 96.0% by weight, degree of saponification: 71.0±1.5 mol %, content of sodium acetate: 1.0% by weight (ash), volatile constituent: 3.0% by weight, viscosity (4% by weight at 20° C.): 5.4±0.4 CPS] (above all are trade names, produced by Kuraray Co., Ltd.), and the like.

The above values were measured in the manner described in JISK-6726-1977.

As modified poly(vinyl alcohol), it can be selected among cationic modified compound, anionic modified compound, modified compound by —SH compound, modified compound by alkylthio compound and modified compound by silanol. Further, the modified poly(vinyl alcohol) described in “POVAL” (Koichi Nagano et. al., edited by Kobunshi Kankokai) can be used.

As this modified poly(vinyl alcohol) (modified PVA), there are C-118, C-318, C-318-2A, C-506 (above all are trade names, produced by Kuraray Co., Ltd.) as C-polymer, HL-12E, HL-1203 (above all are trade name, produced by Kuraray Co., Ltd.) as HL-polymer, HM-03, HM-N-03 (above all are trade marks, produced by Kuraray Co., Ltd.) as HM-polymer, M-115 (trade mark, produced by Kuraray Co., Ltd.) as M-polymer, MP-102, MP-202, MP-203 (above all are trade mark, produced by Kuraray Co., Ltd.) as MP-polymer, MPK-1, MPK-2, MPK-3, MPK-4, MPK-5, MPK-6 (above all are trade marks, produced by Kuraray Co., Ltd.) as MPK-polymer, R-1130, R-2105, R-2130 (above all are trade marks, produced by Kuraray Co., Ltd.) as R-polymer, V-2250 (trade mark, produced by Kuraray Co., Ltd.) as V-polymer, and the like.

Viscosity of aqueous solution of poly(vinyl alcohol) can be controlled or stabilized by addition of small amount of solvent or inorganic salts, which are described in detail in above literature “POVAL” (Koichi Nagano et. al., edited by Kobunshi Kankokai, pages 144 to 154). The typical example preferably is to imcorporate boric acid to improve the surface quality of coating. The addition amount of boric acid is preferably from 0.01% by weight to 40% by weight with respect to poly(vinyl alcohol).

It is also described in above-mentioned “POVAL” that the crystallization degree of poly(vinyl alcohol) is improved and waterproof property is improved by heat treatment. The binder can be heated at coating-drying process or can be additionally subjected to heat treatment after drying, and therefore, poly(vinyl alcohol), which can be improved in waterproof property during those processes, is particularly preferable among water-soluble polymers.

Furthermore, it is preferred that a waterproof improving agent such as those described in above “POVAL” (pages 256 to 261) is added. As examples, there can be mentioned aldehydes, methylol compounds (e.g., N-methylolurea, N-methylolmelamine, or the like), active vinyl compounds (divinylsulfones, derivatives thereof , or the like), bis(β-hydroxyethylsulfones), epoxy compounds (epichlorohydrin, derivatives thereof, or the like), polyvalent carboxylic acids (dicarboxylic acids, poly(acrylic acid) as poly(carboxylic acid), methyl vinyl ether/maleic acid copolymers, isobutylene/maleic anhydride copolymers, or the like), diisocyanates, and inorganic crosslinking agents (Cu, B, Al, Ti, Zr, Sn, V, Cr, or the like).

In the present invention, inorganic crosslinking agents are preferable as a waterproof improving agent. Among these inorganic crosslinking agents, boric acid and derivatives thereof are preferred and boric acid is particularly preferable. Specific examples of the boric acid derivative are shown below.

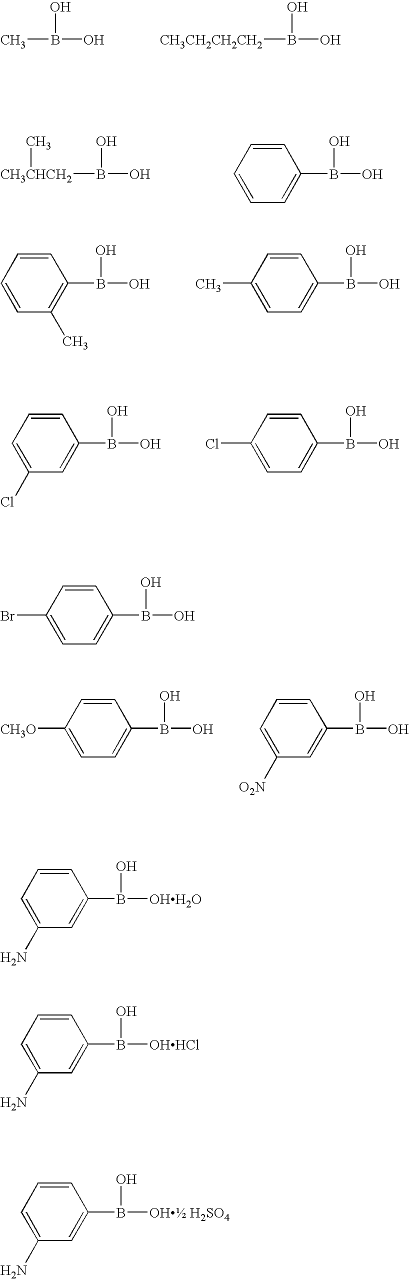

The addition amount of the waterproof improving agent is preferably in a range of from 0.01% by weight to 40% by weight with respect to poly(vinyl alcohol).

<2> Other Water-Soluble Polymers not Derived from Animal Protein

Water-soluble polymers which are not derived from animal protein in the present invention besides above-mentioed poly(vinyl alcohols) are described below.

As typical examples, plant polysaccharides such as gum arabic, κ-carrageenan, ι- carrageenan, λ-carrageenan, guar gum (Supercol produced by SQUALON Co. or the like), locust bean gum, pectin, tragacanth gum, corn starch (Purity-21 produced by National Starch & Chemical Co. or the like), starch phosphate (National 78-1898 produced by National Starch & Chemical Co. or the like), and the like are included.

Also as polysaccharides derived from microorganism, xanthan gum (Keltrol T produced by KELCO Co. and the like), dextrin (Nadex 360 produced by National Starch & Chemical Co. or the like) and as animal polysaccharides, sodium chondroitin sulfate (Cromoist CS produced by CRODA Co. or the like), and the like are included.

And as cellulose polymer, ethyl cellulose (Cellofas WLD produced by I.C.I. Co. or the like), carboxymethyl cellulose (CMC produced by Daicel Chemical Industries, Ltd. or the like), hydroxyethyl cellulose (HEC produced by Daicel Chemical Industries, Ltd. or the like), hydroxypropyl cellulose (Klucel produced by AQUQLON Co. or the like), methyl cellulose (Viscontran produced by HENKEL Co. or the like), nitrocellulose (Isopropyl Wet produced by HELCLES Co. or the like), cationized cellulose (Crodacel QM produced by CRODA Co. or the like), and the like are included. As alginic acid series, sodium alginate (Keltone produced by KELCO Co. or the like), propylene glycol alginate, and the like and as other classification, cationized guar gum (Hi-care 1000 produced by ALCOLAC Co. or the like) and sodium hyaluronate (Hyalure produced by Lifecare Biomedial Co. or the like) are included.

As others, agar, furcelleran, guar gum, karaya gum, larch gum, guar seed gum, psylium seed gum, kino's seed gum, tamarind gum, tara gum and the like are included. Among them, highly water-soluble compound is preferable and the compound in which can solution sol-gel conversion can occur within 24 hours at a temperature change in a range of from 5° C. to 95° C. is preferably used.

Concerning synthetic polymers, sodium polyacrylate, poly(acrylic acid) copolymers, polyacrylamide, polyacrylamide copolymers and the like as acryl series, poly(vinyl pyrrolidone), poly(vinyl pyrrolidone) copolymers and the like as vinyl series and poly(ethylene glycol), poly(propylene glycol), poly(vinyl ether), poly(ethylene imine), poly(styrene sulfonic acid) and copolymers thereof, poly(acrylic acid) and copolymers thereof, poly(vinyl sulfanic acid) and copolymers thereof, maleic acid copolymers, maleic acid monoester copolymers, acryloylmethylpropane sulfonic acid and copolymers thereof, and the like are included.

High-water-absorbable polymers described in U.S. Pat. No. 4,960,681, JP-A No. 62-245260 and the like, namely such as homopolymers of vinyl monomer having —COOM or —SO₃M (M represents a hydrogen atom or an alkali metal) or copolymers of their vinyl monomers or other vinyl monomers (e.g., sodium methacrylate, ammonium methacrylate, or Sumikagel L-5H produced by SUMITOMO KAGAKU Co.) can be also used.

Among these, Sumikagel L-5H produced by SUMITOMO KAGAKU Co.) is preferably used as the water-soluble polymer.

Coating amount of the water-soluble polymer is preferably from 0.3 g/m² to 4.0 g/m² per one m² of the support, and more preferably from 0.5 g/m² to 2.0 g/m².

And it is preferred that the concentration of the water-soluble polymer in a coating solution is arranged to have suitable viscosity for simultaneous multilayer coating after the addition, but it is not specifically limited. Generally, the concentration of the water-soluble polymer in solution is from 0.01% by weight to 30% by weight, and is preferably from 0.05% by weight to 20% by weight, and particularly preferably 0.1% by weight to 10% by weight. The viscosity gain obtained by these addition is preferably from 1 mPa.s to 200 mPa.s with respect to the previous viscosity, and more preferably from 5 mPa.s to 100 mPa.s. The viscosities above mentioned were measured with B-type rotating viscosity meter at 25° C. The glass transition temperature of the water-soluble polymer preferably used in the present invention is not especially limited, but is preferably from 60° C. to 220° C. in term of brittleness such as a belt mark by thermal development, dust adhering at manufacturing, or the like. It is more preferably from 70° C. to 200° C., even more preferably from 80° C. to 180° C., and most preferably from 90° C. to 170° C.

A polymer which is despersible to an aqueous solvent may be used in combination with the water-soluble polymer which is not derived from an animal protein.

Suitable as the polymer which is despersible to an aqueous solvent are those that are synthetic resin or polymer and their copolymer; or media forming a film; for example, included are cellulose acetates, cellulose acetate butyrates, poly(methylmethacrylic acids), poly(vinyl chlorides), poly(methacrylic acids), styrene-maleic anhydride copolymers, styrene-acrylonitrile copolymers, styrene-butadiene copolymers, poly(vinyl acetals) (for example, poly(vinyl formal) or poly(vinyl butyral)), polyesters, polyurethanes, phenoxy resin, poly(vinylidene chlorides), polyepoxides, polycarbonates, poly(vinyl acetates), polyolefins, cellulose esters, and polyamides.

Preferable latexes are described above in the explanation of latex polymer. The latex is mixed in an amount of from 1% by weight to 70% by weight, and preferably from 5% by weight to 50% by weight, with respect to the water-soluble polymer which is not derived from an animal protein.

3) Gelling Agent

A gelling agent in the present invention is a compound which can gelate when it is added into an aqueous solution of the water-soluble polymer which is not derived from an animal protein or an aqueous latex solution of the hydrophobic polymer and cooled, or a compound which can gelate when it is further used with the galation accelerator. The fluidity is remarkably decreased by the occurrence of gelation.

The following water-soluble polysaccharides can be described as the specific examples of the gelling agent. Namely these are at least one kind selected from the group consisting of agar, κ-carrageenan, ι-carrageenan, alginic acid, alginate, agarose, furcellaran, jellan gum, glucono-δ-lactone, azotobactor vinelandii gum, xanthan gum, pectin, guar gum, locust bean gum, tara gum, cassia gum, glucomannan, tragacanth gum, karaya gum, pullulan, gum arabic, arabinogalactan, dextran, sodium carboxymethyl celulose, methyl celulose, cyalume seed gum, starch, chitin, chitosan, and curdlan.

As the compounds which can gelate by cooling after melted by heating, agar, carrageenan, jellan gum, and the like are included.

Among these gelling agents, κ-carrageenan (e.g., K-9F produced by DAITO Co.: K-15, 21, 22, 23, 24 and 1-3 produced by NITTA GELATIN Co.), ι-carrageenan, and agar are preferable, and κ-carrageenan is particularly preferable.

The gelling agent is preferably used in a range from 0.01% by weight to 10.0% by weight, preferably from 0.02% by weight to 5.0% by weight, and more preferably from 0.05% by weight to 2.0% by weight, with respect to the binder polymer.

The gelling agent is preferably used with a gelation accelerator. A gelation accelerator in the present invention is a compound which accelerates gelation by contact with a gelling agent, whereby the gelling function can be developed by specific combination with the gelling agent. In the present invention, the combinations of the gelling agent and the gelation accelerator such as shown below can be used.

<1> The combination of alkali metal ions such as potassium ion or the like or alkali earth metal ions such as calcium ion, magnesium ion, or the like as the gelation accelerator and carrageenan, alginate, azotobactor vinelandii gum, pectin, sodium carboxymethyl cellulose, or the like as the gelling agent;

<2> the combination of boric acid or other boron compounds as the gelation accelerator and guar gum, locust bean gum, tara gum, cassia gum, or the like as the gelling agent;

<3> the combination of acids or alkali compounds as the gelation accelerator and alginate, glucomannan, pectin, chitin, chitosan, curdlan, or the like as the gelling agent;

<4> a water-soluble polysaccharides which can form gel by reaction with the gelling agent is used as the galation accelerator. As typical examples, the combination of xanthan gum as the gelling agent and cassia gum as the gelation accelerator, and the combination of carrageenan as the gelling agent and locust bean gum as the gelation accelerator;

and the like are illustrated.

As the typical examples of the combination of these gelling agents and gelation accelerators, the following combinations a) to g) can be described.
a) Combination of κ-carrageenan and potassium;
b) combination of ι-carrageenan and calcium;
c) combination of low methoxyl pectin and potassium;
d) combination of sodium alginate and potassium;
e) combination of locust bean gum and xanthan gum;
f) combination of jellan gum and acid;
g) combination of locust bean gum and xanthan gum.

These combinations may be used simultaneously as plural combinations.

Although the gelation accelerator can be added to the same layer in which the gelling agent is added, it is preferably added in a different layer as to react. It is more preferable to add the galation accelerator to the layer not directly adjacent to the layer containing the gelling agent. Namely, it is more preferable to set a layer not containing any of the gelling agent and the gelation accelerator between the layer containing the gelling agent and the layer containing the gelation accelerator.

The gelation accelerator is used in a range from 0.1% by weight to 200% by weight, and preferably from 1.0% by weight to 100% by weight, with respect to the gelling agent.

(Organic Silver Salt)

1) Composition

The organic silver salt which can be used in the present invention is relatively stable to light but serves as to supply silver ions and forms silver images when heated to 80° C. or higher in the presence of an exposed photosensitive silver halide and a reducing agent. The organic silver salt may be any material containing a source capable of supplying silver ions that are reducible by a reducing agent. Such a non-photosensitive organic silver salt is disclosed, for example, in JP-A No. 10-62899 (paragraph Nos. 0048 to 0049), European Patent (EP) No. 0803764A1 (page 18, line 24 to page 19, line 37), EP No. 0962812A1, JP-A Nos. 11-349591, 2000-7683, and 2000-72711, and the like. A silver salt of an organic acid, particularly, a silver salt of long chained aliphatic carboxylic acid (having 10 to 30 carbon atoms, and preferably having 15 to 28 carbon atoms) is preferable. Preferred examples of the silver salt of fatty acid can include, for example, silver lignocerate, silver behenate, silver arachidinate, silver stearate, silver oleate, silver laurate, silver capronate, silver myristate, silver palmitate, silver erucate, and mixtures thereof. In the invention, among these silver salts of fatty acid, it is preferred to use a silver salt of fatty acid with a silver behenate content of 50 mol % or higher, more preferably, 85 mol % or higher, and even more preferably, 95 mol % or higher. Further, it is preferred to use a silver salt of fatty acid with a silver erucate content of 2 mol % or lower, more preferably, 1 mol % or lower, and even more preferably, 0.1 mol % or lower.

It is preferred that the content of silver stearate is 1 mol % or lower. When the content of silver stearate is 1 mol % or lower, a silver salt of organic acid having low fog, high sensitivity and excellent image storability can be obtained. The above-mentioned content of silver stearate is preferably 0.5 mol % or lower, and particularly preferably, silver stearate is not substantially contained.

Further, in the case where the silver salt of organic acid includes silver arachidinate, it is preferred that the content of silver arachidinate is 6 mol % or lower in order to obtain a silver salt of organic acid having low fog and excellent image storability. The content of silver arachidinate is more preferably 3 mol % or lower.

2) Shape

The organic silver salt according to the present invention is preferably nano-particles. A mean particle size of the nano-particles is preferably from 10 nm to 1000 nm, and more preferably from 30 nm to 400 nm.

When the particle size is smaller than the above range, fog increases, fog increases during storage of unused photothermographic material, or deterioration in fog occurs during storage of the processed image.

Further, when the particle size is larger than the above range, it exert bad influences such as increase in haze, retardation of development, and deterioration in precipitation of solid component while keeping the organic silver salt dispersion for a long time.

There is no particular restriction on the shape of the organic silver salt usable in the invention and it may be needle-like, bar-like, tabular, or flake shaped.

In the invention, a flake shaped organic silver salt is preferred. Short needle-like, rectangular, cuboidal, or potato-like indefinite shaped particles with the major axis to minor axis ratio being less than 5 are also used preferably. Such organic silver particles suffer less from fogging during thermal development compared with long needle-like particles with the major axis to minor axis length ratio of 5 or more. Particularly, a particle with the major axis to minor axis ratio of 3 or less is preferred since it can improve the mechanical stability of the coating film. In the present specification, the flake shaped organic silver salt is defined as described below. When an organic silver salt is observed under an electron microscope, calculation is made while approximating the shape of an organic silver salt particle to a rectangular body and assuming each side of the rectangular body as a, b, c from the shorter side (c may be identical with b) and determining x based on numerical values a, b for the shorter side as below.
x=b/a

As described above, x is determined for the particles by the number of about 200 and those capable of satisfying the relation: x (average)≧1.5 as an average value x is defined as a flake shape. The relation is preferably: 30≧x (average)≧1.5 and, more preferably, 15≧x (average)≧1.5. By the way, needle-like is expressed as 1≦x (average)<1.5.

In the flake shaped particle, a can be regarded as a thickness of a tabular particle having a major plane with b and c being as the sides. a in average is preferably from 1 nm to 300 nm and, more preferably, from 5 nm to 100 nm. c/b in average is preferably from 1 to 9, more preferably from 1 to 6, even more preferably from 1 to 4 and, most preferably from 1 to 3.

In the invention, an equivalent spherical diameter can be measured by a method of photographing a sample directly by using an electron microscope and then image processing the negative images.

In the flake shaped particle, the equivalent spherical diameter of the particle/a is defined as an aspect ratio. The aspect ratio of the flake particle is preferably from 1.1 to 30 and, more preferably, from 1.1 to 15, from a viewpoint of causing less agglomeration in the photothermographic material and improving the image storability.

As the particle size distribution of the organic silver salt, monodispersion is preferred. In the monodispersion, the percentage for the value obtained by dividing the standard deviation for the length of minor axis and major axis by the minor axis and the major axis respectively is, preferably, 100% or less, more preferably, 80% or less and, even more preferably, 50% or less. The shape of the organic silver salt can be measured by analyzing a dispersion of an organic silver salt as transmission type electron microscopic images. Another method of measuring the monodispersion is a method of determining of the standard deviation of the volume weighted mean diameter of the organic silver salt, in which the percentage for the value defined by the volume weight mean diameter (variation coefficient) is preferably 100% or less, more preferably, 80% or less and, even more preferably, 50% or less. The monodispersion can be determined from particle size (volume weighted mean diameter) obtained, for example, by a measuring method of irradiating a laser beam to organic silver salts dispersed in a liquid, and determining a self correlation function of the fluctuation of scattered light to the change of time.

3) Preparation

The organic silver salt used in the present invention is preferably dispersed by at least one dispersing agent selected from among polyacrylamide and derivatives thereof.

The dispersing agent may be added at the preparing process of organic silver salt, or at the dispersing process. The organic silver salt particles are preferably formed in the presence of the dispersing agent, and more preferably, a desalting process after particle formation is carried out in the presence of the said dispersing agent.

As at least one dispersing agent selected from among polyacrylamide and derivatives thereof, it is prefereed to use the compound represented by the following formulae (W1) or (W2).

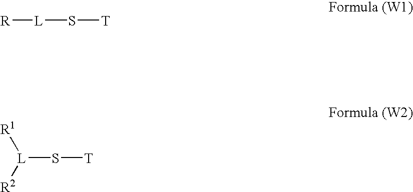

In the formulae, R represents a hydrophobic group, and at least one of R¹ and R² is a hydrophobic group. L represents a divalent linking group. T represents an oligomer part.

The number of the hydrophobic group is determined by the linking group L. The hydrophobic group is a group selected from a saturated or unsaturated alkyl group, an arylalkyl group, or an alkylaryl group, where each alkyl group may be linear or branched. Preferably, the hydrophobic R, R₁, and R₂ each independently has 8 to 21 carbon atoms. L (linking group) combines with the hydrophobic group by a simple chemical bond and T (oligomer part) with thio-bond (—S—). Representative examples of the compound represented by formula (W1) are shown in the following formulae.

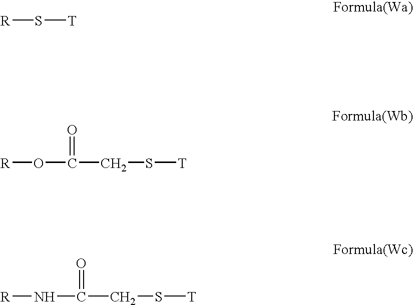

Representative examples of the compound represented by formula (W2) are shown in the following formulae.

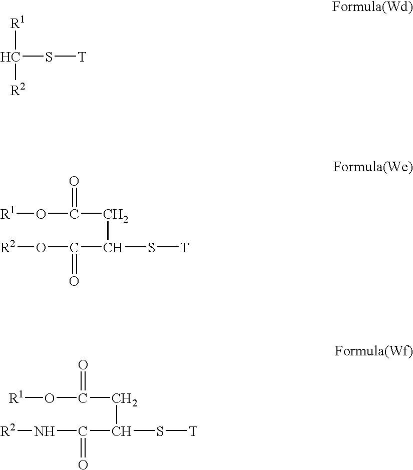

The oligomer part T is based on an oligomerization derived from a vinyl monomer having an amide group wherein the vinyl part provides the path to the oligomerization, and the amide group provides an non-ionic polar group which composes a hydrophilic group after the oligomerization. The oligomer part T can be formed from the mixture of monomers if one kind of monomer source or the oligomer part obtained has enough hydrophilicity to dissolve or disperse the obtained surface active substance in water. The specific examples of the monomer used for forming the oligomer part T include acrylamide, methacrylamide, an acrylamide derivative, a methacrylamide derivative, and 2-vinyl pyrrolidone, however the latter is not preferred because poly(vinyl pyrrolidone) exhibits occasionally harmful photographic performance.

These monomers can be expressed by the following formulae.

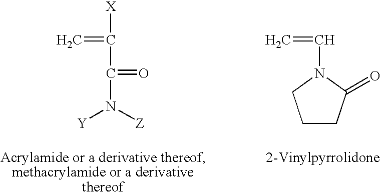

In the formulae, X specifically represents a hydrogen atom or a methyl group, which can form acrylamide monomer or methacryamide monomer, respectively. Specifically, Y and Z each independently represents a hydrogen atom, a methyl group, an ethyl group or —C(CH₂OH)₃ group, where X and Y may be the same or different.

Examples of the compound represented by formula (W1) or (W2) used in the present invention are set forth below, however, the present invention is not limited to these.

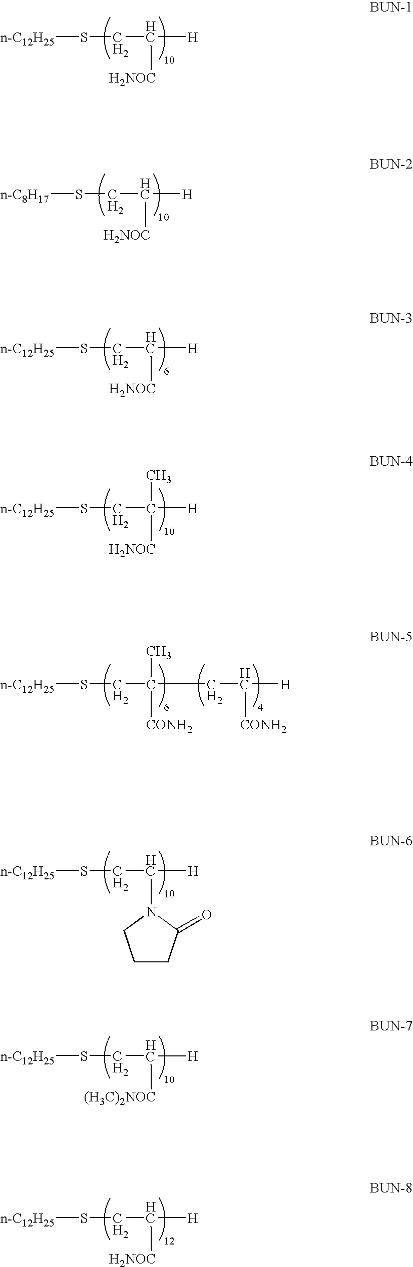

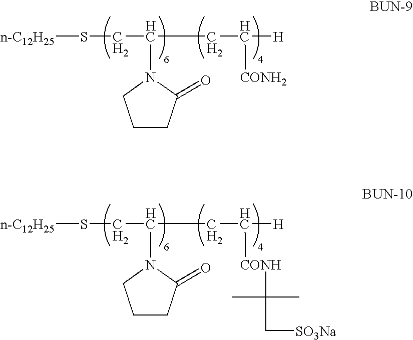

The compound represented by formula (W1) or (W2) which is obtained from a vinyl polymer having the said amide group is an oligomer surfactant. The oligomer surfactant can be produced by a well-known method or by simply modifying a well-known method in the technical art. One example of the synthesis method is described hereinafter. An aqueous nano-particle dispersion of silver carboxylate can be prepared by a media grinding method comprising the following steps;

(A) preparing a silver carboxylate dispersion containing silver carboxylate, water as a carrier of carboxylate, and the above-described oligomer surfactant as a surface modifing agent,

(B) mixing the obtained silver carboxylate dispersion and hard media for grinding having a mean particle diameter of 500 μm or less,

(C) adding the mixture of step (B) into a high speed mill,

(D) grinding the mixture of step (C) until reaching the particle size distribution of silver carboxylate in which 90% by weight of the silver carboxylate particles has a particle diameter of less than 1 μm, and

(E) separating the media for grinding from the mixture obtained by grinding in step (D).

When a photosensitive silver salt is present together during dispersion of the organic silver salt, fog increases and sensitivity becomes remarkably lower, so that it is more preferred that the photosensitive silver salt is not substantially contained during dispersion. In the invention, the amount of the photosensitive silver salt to be dispersed in the aqueous dispersion is preferably 1 mol % or less, more preferably 0.1 mol % or less, per 1 mol of the organic silver salt in the solution and, even more preferably, positive addition of the photosensitive silver salt is not conducted.

In the invention, the photothermographic material can be prepared by mixing an aqueous dispersion of an organic silver salt and an aqueous dispersion of a photosensitive silver salt and the mixing ratio between the organic silver salt and the photosensitive silver salt can be selected depending on the purpose. The ratio of photosensitive silver salt relative to organic silver salt is preferably in a range of from 1 mol % to 30 mol %, more preferably, from 2 mol % to 20 mol % and, particularly preferably, 3 mol % to 15 mol %. A method of mixing two or more kinds of aqueous dispersions of organic silver salts and two or more kinds of aqueous dispersions of photosensitive silver salts upon mixing is used preferably for controlling the photographic properties.

Methods other than described above can be applied to the method for producing the organic silver salt used in the invention and to the dispersing method thereof. For example, reference can be made to JP-A No. 10-62899, EP Nos. 0803763A1 and 0962812A1, JP-A Nos. 11-349591, 2000-7683, 2000-72711, 2001-163889, 2001-163890, 2001-163827, 2001-33907, 2001-188313, 2001-83652, 2002-6442, 2002-49117, 2002-31870, and 2002-107868, and the like.

4) Addition Amount

While an organic silver salt in the invention can be used in a desired amount, a total amount of coated silver including silver halide is preferably in a range of from 0.1 g/m² to 5.0 g/m², more preferably from 0.3 g/m² to 3.0 g/m², and even more preferably from 0.5 g/m² to 2.0 g/m². Particularly, in order to improve image storability, the total amount of coated silver is preferably 1.8 mg/m² or less, more preferably 1.6 mg/m² or less. In the case where a preferable reducing agent in the invention is used, it is possible to obtain a sufficient image density by even such a low amount of silver.

(Reducing Agent)

The photothermographic material of the present invention contains a reducing agent for organic silver salts as a thermal developing agent. The reducing agent according to the invention is preferably a so-called hindered phenolic reducing agent or a bisphenol agent having a substituent at the ortho-position to the phenolic hydroxy group. It is more preferably a reducing agent represented by the following formula (R).

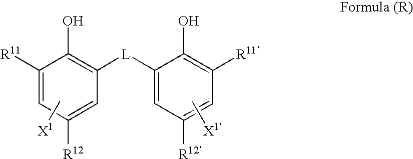

In formula (R), R¹¹ and R^{11′} each independently represent an alkyl group having 1 to 20 carbon atoms. R¹² and R^{12′} each independently represent a hydrogen atom or a group capable of substituting for a hydrogen atom on a benzene ring. L represents an —S— group or a —CHR¹³— group. R¹³ represents a hydrogen atom or an alkyl group having 1 to 20 carbon atoms. X¹ and X^{1′} each independently represent a hydrogen atom or a group capable of substituting for a hydrogen atom on a benzene ring.

Formula (R) is to be described in detail.

In the following description, when referred to as an alkyl group, it means that the alkyl group contains a cycloalkyl group, as far as it is not mentioned specifically.

1) R¹¹ and R^{11′}

R¹¹ and R^{11′} each independently represent a substituted or unsubstituted alkyl group having 1 to 20 carbon atoms. The substituent for the alkyl group has no particular restriction and can include, preferably, an aryl group, a hydroxy group, an alkoxy group, an aryloxy group, an alkylthio group, an arylthio group, an acylamino group, a sulfonamide group, a sulfonyl group, a phosphoryl group, an acyl group, a carbamoyl group, an ester group, a ureido group, a urethane group, a halogen atom, and the like.

2) R¹² and R^{12′}, X¹ and X^{1′}

R¹² and R^{12′} each independently represent a hydrogen atom or a group capable of substituting for a hydrogen atom on a benzene ring. X¹ and X^{1′} each independently represent a hydrogen atom or a group capable of substituting for a hydrogen atom on a benzene ring. As each of the groups capable of substituting for a hydrogen atom on the benzene ring, an alkyl group, an aryl group, a halogen atom, an alkoxy group, and an acylamino group are described preferably.

3) L

L represents an —S— group or a —CHR¹³— group. R¹³ represents a hydrogen atom or an alkyl group having 1 to 20 carbon atoms in which the alkyl group may have a substituent. Specific examples of the unsubstituted alkyl group for R¹³ can include, for example, a methyl group, an ethyl group, a propyl group, a butyl group, a heptyl group, an undecyl group, an isopropyl group, a 1-ethylpentyl group, a 2,4,4-trimethylpentyl group, cyclohexyl group, 2,4-dimethyl-3-cyclohexenyl group, 3,5-dimethyl-3-cyclohexenyl group, and the like. Examples of the substituent for the alkyl group can include, similar to the substituent of R¹¹, a halogen atom, an alkoxy group, an alkylthio group, an aryloxy group, an arylthio group, an acylamino group, a sulfonamide group, a sulfonyl group, a phosphoryl group, an oxycarbonyl group, a carbamoyl group, a sulfamoyl group, and the like.

4) Preferred Substituents

R¹¹ and R^{11′} are preferably a secondary or tertiary alkyl group having 3 to 15 carbon atoms. Specifically, an isopropyl group, a t-butyl group, a t-amyl group, a t-octyl group, a cyclohexyl group, a cyclopentyl group, a 1-methylcyclohexyl group, a 1-methylcyclopropyl group, and the like can be described. R¹¹ and R^{11′} each represent, more preferably, a t-butyl group, a t-amyl group, or a 1-methylcyclohexyl group and a t-butyl group being most preferred.

R¹² and R^{12′} are preferably an alkyl group having 1 to 20 carbon atoms and can include, specifically, a methyl group, an ethyl group, a propyl group, a butyl group, an isopropyl group, a t-butyl group, a t-amyl group, a cyclohexyl group, a 1-methylcyclohexyl group, a benzyl group, a methoxymethyl group, a methoxyethyl group, and the like. More preferred are a methyl group, an ethyl group, a propyl group, an isopropyl group, and a t-butyl group, and particularly preferred are a methyl group and an ethyl group.

X¹ and X^{1′} are preferably a hydrogen atom, a halogen atom, or an alkyl group, and more preferably a hydrogen atom.

L is preferably a —CHR¹³— group.

R¹³ is preferably a hydrogen atom or an alkyl group having 1 to 15 carbon atoms. The alkyl group is preferably a chain or a cyclic alkyl group. And, a group which has a C═C bond in these alkyl group is also preferably used. Preferable examples of the alkyl group can include a methyl group, an ethyl group, a propyl group, an isopropyl group, a 2,4,4-trimethylpentyl group, a cyclohexyl group, a 2,4-dimethyl-3-cyclohexenyl group, a 3,5-dimetyl-3-cyclohexenyl group and the like. Particularly preferable R¹³ is a hydrogen atom, a methyl group, an ethyl group, a propyl group, an isopropyl group, or a 2,4-dimethyl-3-cyclohexenyl group.

In the case where R¹¹ and R^{11′} are a tertiary alkyl group and R¹² and R^{12′} are a methyl group, R¹³ is preferably a primary or secondary alkyl group having 1 to 8 carbon atoms (a methyl group, an ethyl group, a propyl group, an isopropyl group, a 2,4-dimethyl-3-cyclohexenyl group, or the like).

In the case where R¹¹ and R^{11′} are a tertiary alkyl group and R¹² and R^{12′} are an alkyl group other than a methyl group, R¹³ is preferably a hydrogen atom.

In the case where R¹¹ and R^{11′} are not a tertiary alkyl group, R¹³ is preferably a hydrogen atom or a secondary alkyl group, and particularly preferably a secondary alkyl group. As the secondary alkyl group for R¹³, an isopropyl group and a 2,4-dimethyl-3-cyclohexenyl group are preferred.

The reducing agent described above shows different thermal development performances, color tones of developed silver images, or the like depending on the combination of R¹¹, R^{11′}, R¹², R^{12′}, and R¹³. Since these performances can be controlled by using two or more kinds of reducing agents at various mixing ratios, it is preferred to use two or more kinds of reducing agents in combination depending on the purpose.

Specific examples of the reducing agents of the invention including the compounds represented by formula (R) according to the invention are shown below, but the invention is not restricted to these.

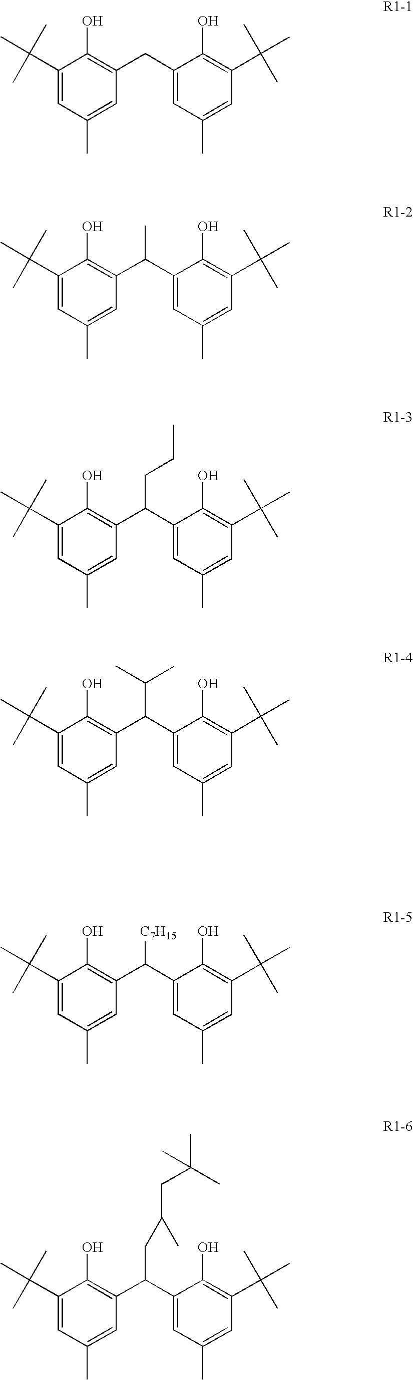

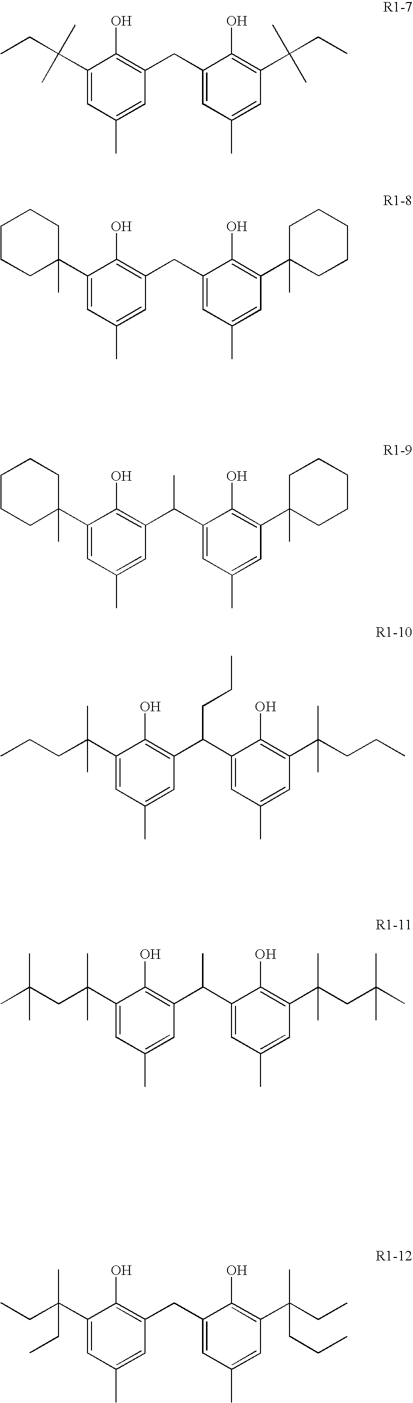

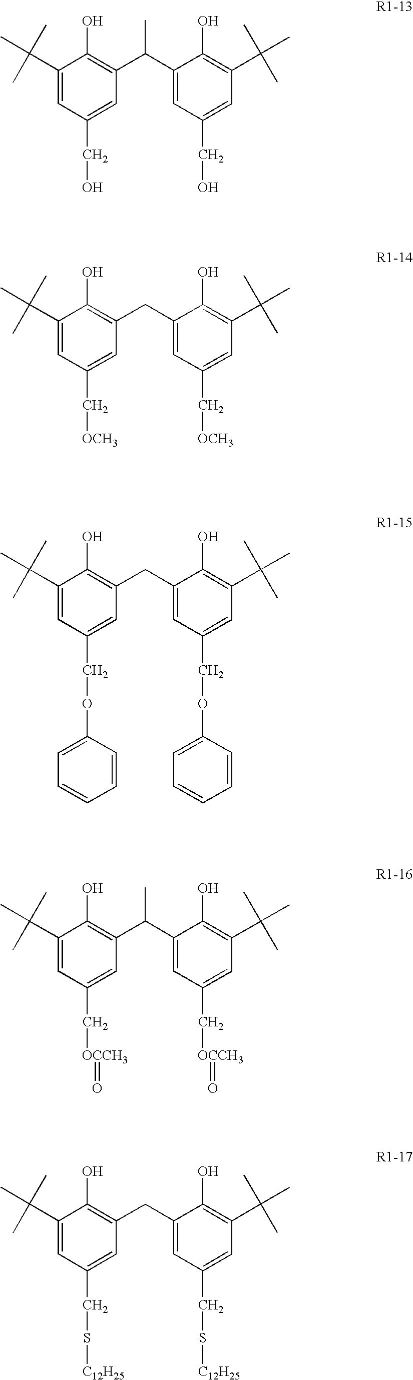

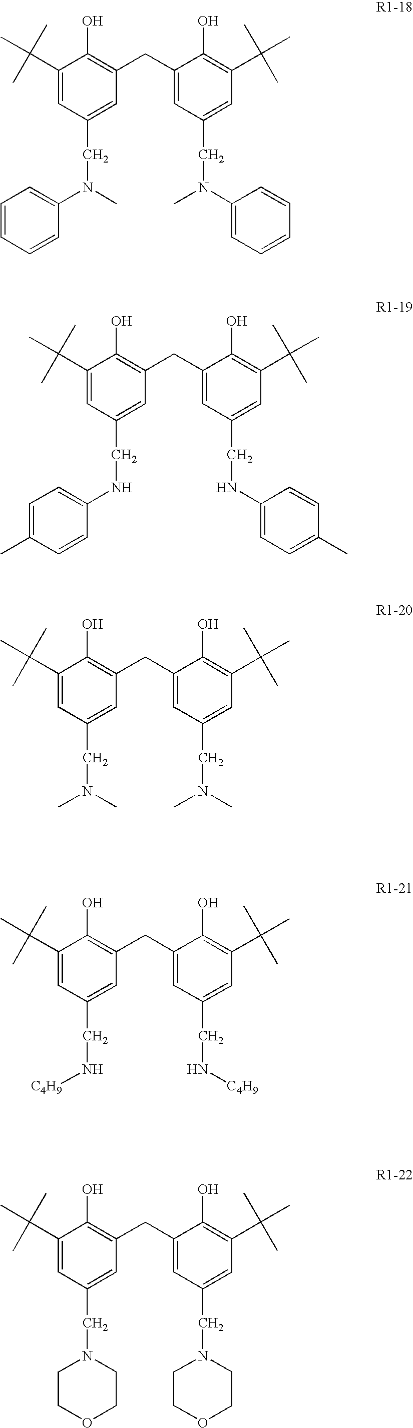

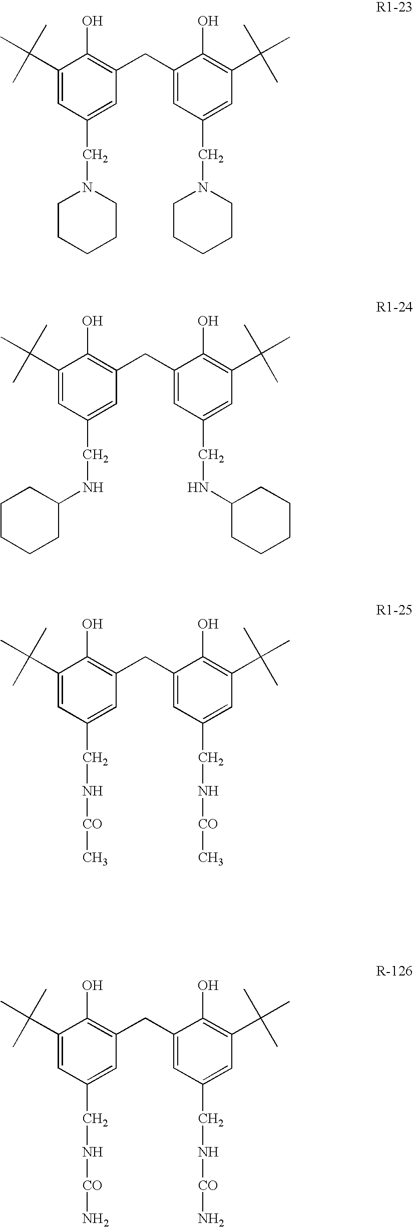

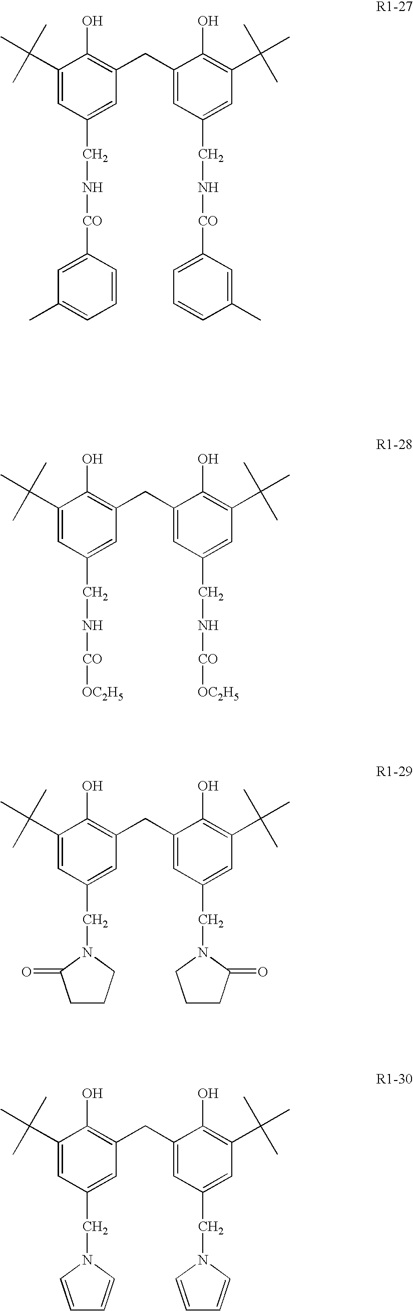

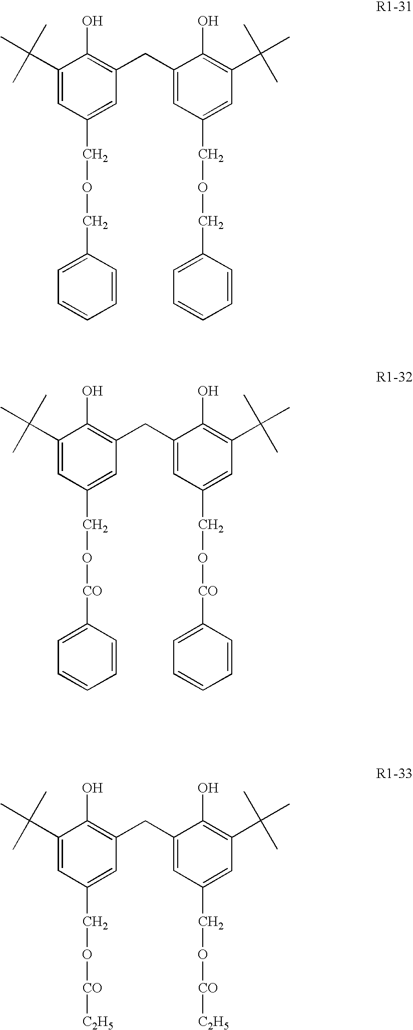

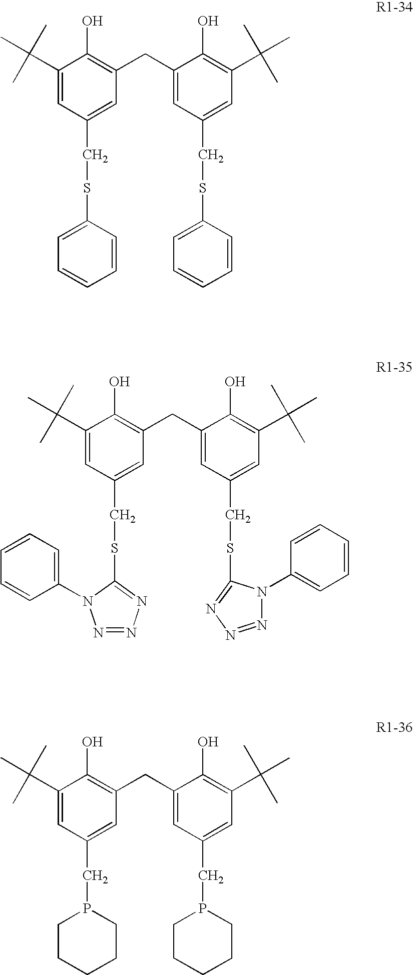

As preferred reducing agents of the invention other than those above, there can be mentioned compounds disclosed in JP-A Nos. 2001 -188314, 2001-209145, 2001-350235, and 2002-156727, and EP No. 1278101A2.

The addition amount of the reducing agent is preferably from 0.1 g/m² to 3.0 g/m², more preferably from 0.2 g/m² to 2.0 g/m² and, even more preferably from 0.3 g/m² to 1.0 g/m². It is preferably contained in a range of from 5 mol % to 50 mol %, more preferably from 8 mol % to 30 mol % and, even more preferably from 10 mol % to 20 mol %, per 1 mol of silver in the image forming layer.

The reducing agent can be added to any layer on the side having thereon the image forming layer. The reducing agent is preferably contained in the image forming layer.

In the invention, the reducing agent may be incorporated into photothermographic material by being added into the coating solution, such as in the form of solution, emulsion dispersion, solid fine particle dispersion, or the like.

As well known emulsion dispersing method, there can be mentioned a method comprising dissolving the reducing agent in an oil such as dibutylphthalate, tricresylphosphate, dioctylsebacate, tri(2-ethylhexyl)phosphate, or the like, and an auxiliary solvent such as ethyl acetate, cyclohexanone, or the like, and then adding a surfactant such as sodium dodecylbenzenesulfonate, sodium oleoil-N-methyltaurinate, sodium di(2-ethylhexyl)sulfosuccinate or the like; from which an emulsion dispersion is mechanically produced. During the process, for the purpose of controlling viscosity of oil droplet and refractive index, the addition of polymer such as α-methylstyrene oligomer, poly(t-butylacrylamide), or the like is preferable.

As solid fine particle dispersing method, there can be mentioned a method comprising dispersing the powder of the reducing agent in a proper solvent such as water or the like, by means of ball mill, colloid mill, vibrating ball mill, sand mill, jet mill, roller mill, or ultrasonics, thereby obtaining solid dispersion. In this case, there may also be used a protective colloid (such as poly(vinyl alcohol)), or a surfactant (for instance, an anionic surfactant such as sodium triisopropylnaphthalenesulfonate (a mixture of compounds having the isopropyl groups in different substitution sites)). In the mills enumerated above, generally used as the dispersion media are beads made of zirconia or the like, and Zr or the like eluting from the beads may be incorporated in the dispersion. Although depending on the dispersing conditions, the amount of Zr or the like incorporated in the dispersion is generally in a range of from 1 ppm to 1000 ppm. It is practically acceptable so long as Zr is incorporated in an amount of 0.5 mg or less per 1 g of silver.

Preferably, an antiseptic (for instance, benzisothiazolinone sodium salt) is added in the aqueous dispersion.

The reducing agent is particularly preferably used as a solid particle dispersion, and the reducing agent is added in the form of fine particles having mean particle size from 0.01 μm to 10 μm, and more preferably, from 0.05 μm to 5 μm, and even more preferably, from 0.1 μm to 2 μm. In the invention, other solid dispersions are preferably used with this particle size range.

(Development Accelerator)

In the photothermographic material of the invention, sulfonamide phenolic compounds described in the specification of JP-A No. 2000-267222, and represented by formula (A) described in the specification of JP-A No. 2000-330234; hindered phenolic compounds represented by formula (II) described in JP-A No. 2001-92075; hydrazine compounds described in the specification of JP-A No. 10-62895, represented by formula (I) described in the specification of JP-A No. 11-15116, represented by formula (D) described in the specification of JP-A No. 2002-156727, and represented by formula (1) described in the specification of JP-A No. 2002-278017; and phenolic or naphthalic compounds represented by formula (2) described in the specification of JP-A No. 2001-264929 are used preferably as a development accelerator.

Further, phenolic compounds described in JP-A Nos. 2002-311533 and 2002-341484 are also preferable. Naphthalic compounds described in JP-A No. 2003-66558 are particularly preferable.

The development accelerator described above is used in a range of from 0.1 mol % to 20 mol %, preferably, in a range of from 0.5 mol % to 10 mol % and, more preferably in a range of from 1 mol % to 5 mol %, with respect to the reducing agent.

The introducing methods to the photothermographic material can include similar methods as those for the reducing agent and, it is particularly preferred to add as a solid dispersion or an emulsion dispersion. In the case of adding as an emulsion dispersion, it is preferred to add as an emulsion dispersion dispersed by using a high boiling solvent which is solid at a normal temperature and an auxiliary solvent at a low boiling point, or to add as a so-called oilless emulsion dispersion not using the high boiling solvent.

In the present invention, among the development accelerators described above, it is more preferred to use hydrazine compounds described in the specification of JP-A Nos. 2002-156727 and 2002-278017, and naphtholic compounds described in the specification of JP-A No. 2003-66558.

Particularly preferred development accelerators of the invention are compounds represented by the following formulae (A-1) or (A-2).
Q₁-NHNH-Q₂ Formula (A-1)

wherein Q₁ represents an aromatic group or a heterocyclic group which bonds to —NHNH-Q₂ at a carbon atom, and Q₂ represents one selected from a carbamoyl group, an acyl group, an alkoxycarbonyl group, an aryloxycarbonyl group, a sulfonyl group, or a sulfamoyl group.

In formula (A-1), the aromatic group or the heterocyclic group represented by Q₁ is preferably a 5 to 7-membered unsaturated ring. Preferred examples include a benzene ring, a pyridine ring, a pyrazine ring, a pyrimidine ring, a pyridazine ring, a 1,2,4-triazine ring, a 1,3,5-triazine ring, a pyrrole ring, an imidazole ring, a pyrazole ring, a 1,2,3-triazole ring, a 1,2,4-triazole ring, a tetrazole ring, a 1,3,4-thiadiazole ring, a 1,2,4-thiadiazole ring, a 1,2,5-thiadiazole ring, a 1,3,4-oxadiazole ring, a 1,2,4-oxadiazole ring, a 1,2,5-oxadiazole ring, a thiazole ring, an oxazole ring, an isothiazole ring, an isooxazole ring, a thiophene ring, and the like. Condensed rings in which the rings described above are condensed to each other are also preferred.

The rings described above may have substituents and in a case where they have two or more substituents, the substituents may be identical or different from each other. Examples of the substituents can include a halogen atom, an alkyl group, an aryl group, a carbonamide group, an alkylsulfonamide group, an arylsulfonamide group, an alkoxy group, an aryloxy group, an alkylthio group, an arylthio group, a carbamoyl group, a sulfamoyl group, a cyano group, an alkylsulfonyl group, an arylsulfonyl group, an alkoxycarbonyl group, an aryloxycarbonyl group, and an acyl group. In the case where the substituents are groups capable of substitution, they may have further substituents and examples of preferred substituents can include a halogen atom, an alkyl group, an aryl group, a carbonamide group, an alkylsulfonamide group, an arylsulfonamide group, an alkoxy group, an aryloxy group, an alkylthio group, an arylthio group, an acyl group, an alkoxycarbonyl group, an aryloxycarbonyl group, a carbamoyl group, a cyano group, a sulfamoyl group, an alkylsulfonyl group, an arylsulfonyl group, and an acyloxy group.

The carbamoyl group represented by Q₂ is a carbamoyl group preferably having 1 to 50 carbon atoms and, more preferably having 6 to 40 carbon atoms, and examples can include unsubstituted carbamoyl, methyl carbamoyl, N-ethylcarbamoyl, N-propylcarbamoyl, N-sec-butylcarbamoyl, N-octylcarbamoyl, N-cyclohexylcarbamoyl, N-tert-butylcarbamoyl, N-dodecylcarbamoyl, N-(3-dodecyloxypropyl)carbamoyl, N-octadecylcarbamoyl, N-{3-(2,4-tert-pentylphenoxy)propyl}carbamoyl, N-(2-hexyldecyl)carbamoyl, N-phenylcarbamoyl, N-(4-dodecyloxyphenyl)carbamoyl, N-(2-chloro-5-dodecyloxycarbonylphenyl)carbamoyl, N-naphthylcarbamoyl, N-3-pyridylcarbamoyl, and N-benzylcarbamoyl.

The acyl group represented by Q₂ is an acyl group, preferably having 1 to 50 carbon atoms and, more preferably having 6 to 40 carbon atoms, and can include, for example, formyl, acetyl, 2-methylpropanoyl, cyclohexylcarbonyl, octanoyl, 2-hexyldecanoyl, dodecanoyl, chloroacetyl, trifluoroacetyl, benzoyl, 4-dodecyloxybenzoyl, and 2-hydroxymethylbenzoyl.

The alkoxycarbonyl group represented by Q2 is an alkoxycarbonyl group, preferably having 2 to 50 carbon atoms and, more preferably having 6 to 40 carbon atoms, and can include, for example, methoxycarbonyl, ethoxycarbonyl, isobutyloxycarbonyl, cyclohexyloxycarbonyl, dodecyloxycarbonyl, and benzyloxycarbonyl.

The aryloxy carbonyl group represented by Q₂ is an aryloxycarbonyl group, preferably having 7 to 50 carbon atoms and, more preferably having 7 to 40 carbon atoms, and can include, for example, phenoxycarbonyl, 4-octyloxyphenoxycarbonyl, 2-hydroxymethylphenoxycarbonyl, and 4-dodecyloxyphenoxycarbonyl. The sulfonyl group represented by Q₂ is a sulfonyl group, preferably having 1 to 50 carbon atoms and, more preferably, having 6 to 40 carbon atoms and can include, for example, methylsulfonyl, butylsulfonyl, octylsulfonyl, 2-hexadecylsulfonyl, 3-dodecyloxypropylsulfonyl, 2-octyloxy-5-tert-octylphenyl sulfonyl, and 4-dodecyloxyphenyl sulfonyl.

The sulfamoyl group represented by Q₂ is a sulfamoyl group, preferably having 0 to 50 carbon atoms, more preferably having 6 to 40 carbon atoms, and can include, for example, unsubstituted sulfamoyl, N-ethylsulfamoyl group, N-(2-ethylhexyl)sulfamoyl, N-decylsulfamoyl, N-hexadecylsulfamoyl, N-{3-(2-ethylhexyloxy)propyl}sulfamoyl, N-(2-chloro-5-dodecyloxycarbonylphenyl)sulfamoyl, and N-(2-tetradecyloxyphenyl)sulfamoyl.

The group represented by Q₂ may further have a group mentioned as the example of the substituent of 5 to 7-membered unsaturated ring represented by Q₁ at the position capable of substitution. In a case where the group has two or more substituents, such substituents may be identical or different from each other.

Next, preferred range for the compound represented by formula (A-1) is to be described. A 5 or 6-membered unsaturated ring is preferred for Q₁, and a benzene ring, a pyrimidine ring, a 1,2,3-triazole ring, a 1,2,4-triazole ring, a tetrazole ring, a 1,3,4-thiadiazole ring, a 1,2,4-thiadiazole ring, a 1,3,4-oxadiazole ring, a 1,2,4-oxadiazole ring, a thioazole ring, an oxazole ring, an isothiazole ring, an isooxazole ring, and a ring in which the ring described above is condensed with a benzene ring or unsaturated hetero ring are more preferred.

Further, Q₂ is preferably a carbamoyl group and, particularly, a carbamoyl group having a hydrogen atom on the nitrogen atom is particularly preferred.

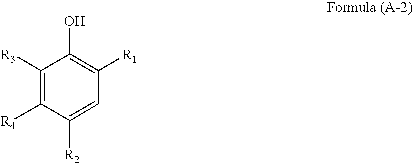

In formula (A-2), R₁ represents one selected from an alkyl group, an acyl group, an acylamino group, a sulfonamide group, an alkoxycarbonyl group, or a carbamoyl group. R₂ represents one selected from a hydrogen atom, a halogen atom, an alkyl group, an alkoxy group, an aryloxy group, an alkylthio group, an arylthio group, an acyloxy group, or a carbonate ester group. R₃ and R₄ each independently represent a group capable of substituting for a hydrogen atom on a benzene ring which is mentioned as the example of the substituent for formula (A-1). R₃ and R₄ may link together to form a condensed ring.

R₁ is preferably an alkyl group having 1 to 20 carbon atoms (for example, a methyl group, an ethyl group, an isopropyl group, a butyl group, a tert-octyl group, a cyclohexyl group, or the like), an acylamino group (for example, an acetylamino group, a benzoylamino group, a methylureido group, a 4-cyanophenylureido group, or the like), or a carbamoyl group (for example, a n-butylcarbamoyl group, an N,N-diethylcarbamoyl group, a phenylcarbamoyl group, a 2-chlorophenylcarbamoyl group, a 2,4-dichlorophenylcarbamoyl group, or the like). An acylamino group (including a ureido group and a urethane group) is more preferred. R₂ is preferably a halogen atom (more preferably, a chlorine atom or a bromine atom), an alkoxy group (for example, a methoxy group, a butoxy group, an n-hexyloxy group, an n-decyloxy group, a cyclohexyloxy group, a benzyloxy group, or the like), or an aryloxy group (for example, a phenoxy group, a naphthoxy group, or the like).

R₃ is preferably a hydrogen atom, a halogen atom, or an alkyl group having 1 to 20 carbon atoms, and most preferably a halogen atom. R₄ is preferably a hydrogen atom, an alkyl group, or an acylamino group, and more preferably an alkyl group or an acylamino group. Examples of the preferred substituent thereof are similar to those for R₁. In the case where R₄ is an acylamino group, R₄ may preferably link with R₃ to form a carbostyryl ring.

In the case where R₃ and R₄ in formula (A-2) link together to form a condensed ring, a naphthalene ring is particularly preferred as the condensed ring. The same substituent as the example of the substituent referred to for formula (A-1) may bond to the naphthalene ring. In the case where formula (A-2) is a naphtholic compound, R₁ is preferably a carbamoyl group. Among them, a benzoyl group is particularly preferred. R₂ is preferably an alkoxy group or an aryloxy group and, particularly preferably an alkoxy group.

Preferred specific examples for the development accelerator of the invention are to be described below. The invention is not restricted to them.

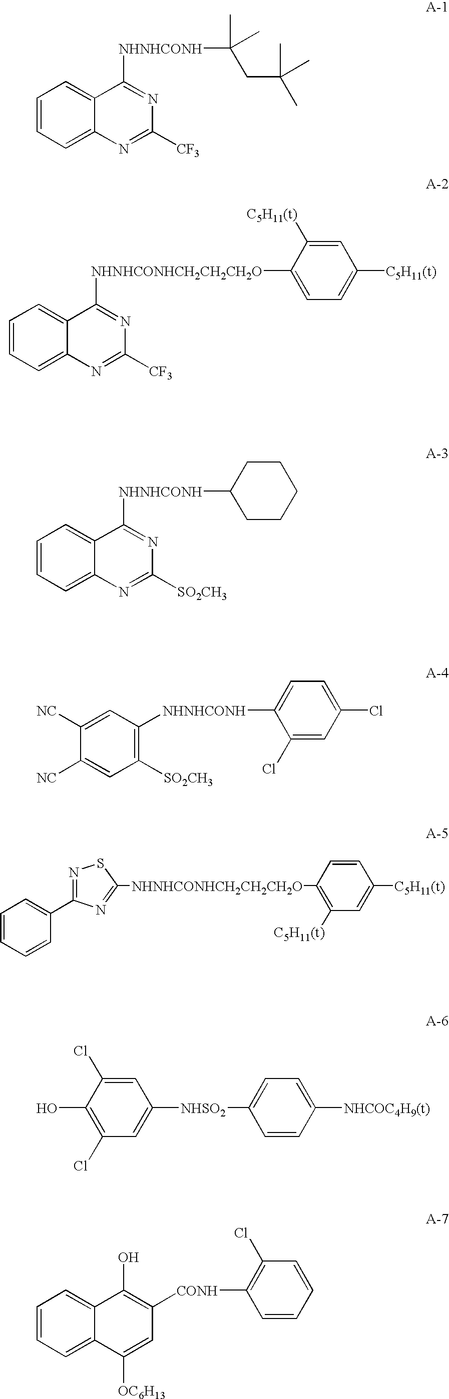

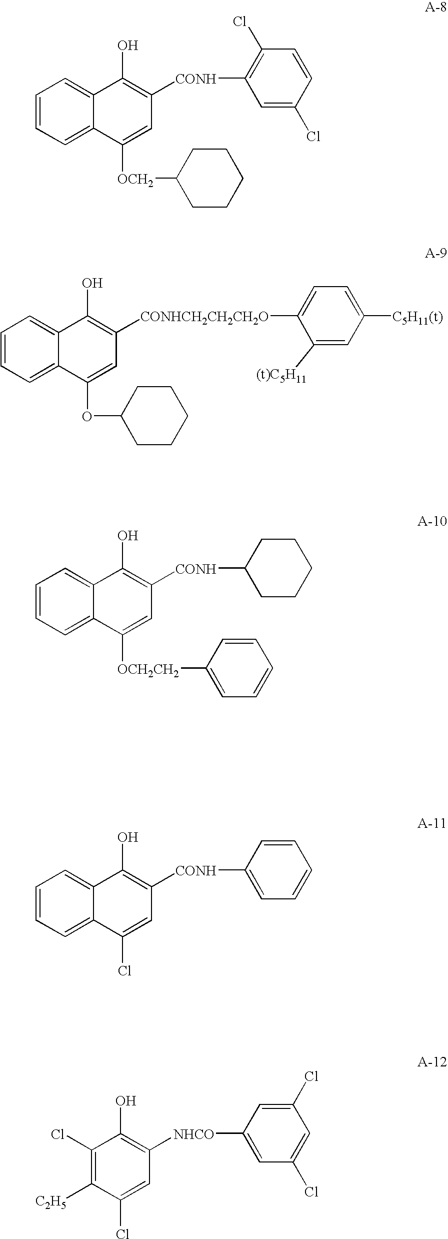

(Hydrogen Bonding Compound)

In the invention, in the case where the reducing agent has an aromatic hydroxy group (—OH) or an amino group (—NHR, R represents a hydrogen atom or an alkyl group), particularly in the case where the reducing agent is a bisphenol described above, it is preferred to use in combination, a non-reducing compound having a group capable of reacting with these groups of the reducing agent, and that is also capable of forming a hydrogen bond therewith.

As a group forming a hydrogen bond with a hydroxy group or an amino group, there can be mentioned a phosphoryl group, a sulfoxide group, a sulfonyl group, a carbonyl group, an amide group, an ester group, a urethane group, a ureido group, a tertiary amino group, a nitrogen-containing aromatic group, and the like. Particularly preferred among them is a phosphoryl group, a sulfoxide group, an amide group (not having >N—H moiety but being blocked in the form of >N—Ra (where, Ra represents a substituent other than H)), a urethane group (not having >N—H moiety but being blocked in the form of >N—Ra (where, Ra represents a substituent other than H)), and a ureido group (not having >N—H moiety but being blocked in the form of >N—Ra (where, Ra represents a substituent other than H)).

In the invention, particularly preferable as the hydrogen bonding compound is the compound expressed by formula (D) shown below.

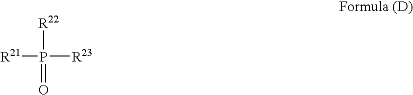

In formula (D), R²¹ to R²³ each independently represent one selected from an alkyl group, an aryl group, an alkoxy group, an aryloxy group, an amino group, or a heterocyclic group, which may be substituted or unsubstituted.

In the case where R²¹ to R²³ contain a substituent, examples of the substituent include a halogen atom, an alkyl group, an aryl group, an alkoxy group, an amino group, an acyl group, an acylamino group, an alkylthio group, an arylthio group, a sulfonamide group, an acyloxy group, an oxycarbonyl group, a carbamoyl group, a sulfamoyl group, a sulfonyl group, a phosphoryl group, and the like, in which preferred as the substituents are an alkyl group or an aryl group, e.g., a methyl group, an ethyl group, an isopropyl group, a t-butyl group, a t-octyl group, a phenyl group, a 4-alkoxyphenyl group, a 4-acyloxyphenyl group, and the like.

Specific examples of an alkyl group expressed by R²¹ to R²³ include a methyl group, an ethyl group, a butyl group, an octyl group, a dodecyl group, an isopropyl group, a t-butyl group, a t-amyl group, a t-octyl group, a cyclohexyl group, a 1-methylcyclohexyl group, a benzyl group, a phenetyl group, a 2-phenoxypropyl group, and the like.

As an aryl group, there can be mentioned a phenyl group, a cresyl group, a xylyl group, a naphthyl group, a 4-t-butylphenyl group, a 4-t-octylphenyl group, a 4-anisidyl group, a 3,5-dichlorophenyl group, and the like.

As an alkoxyl group, there can be mentioned a methoxy group, an ethoxy group, a butoxy group, an octyloxy group, a 2-ethylhexyloxy group, a 3,5,5-trimethylhexyloxy group, a dodecyloxy group, a cyclohexyloxy group, a 4-methylcyclohexyloxy group, a benzyloxy group, and the like.

As an aryloxy group, there can be mentioned a phenoxy group, a cresyloxy group, an isopropylphenoxy group, a 4-t-butylphenoxy group, a naphthoxy group, a biphenyloxy group, and the like.

As an amino group, there can be mentioned are a dimethylamino group, a diethylamino group, a dibutylamino group, a dioctylamino group, an N-methyl-N-hexylamino group, a dicyclohexylamino group, a diphenylamino group, an N-methyl-N-phenylamino group, and the like.

Preferred as R²¹ to R²³ is an alkyl group, an aryl group, an alkoxy group, or an aryloxy group. Concerning the effect of the invention, it is preferred that at least one of R²¹ to R²³ is an alkyl group or an aryl group, and more preferably, two or more of them are an alkyl group or an aryl group. From the viewpoint of low cost availability, it is preferred that R²¹ to R²³ are of the same group.

Specific examples of hydrogen bonding compounds represented by formula (D) of the invention and others are shown below, but it should be understood that the invention is not limited thereto.

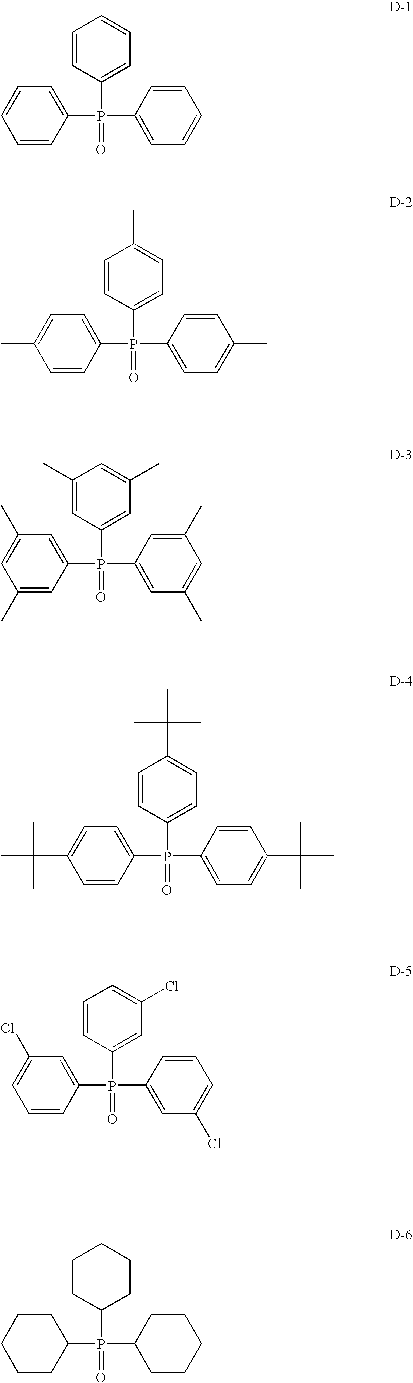

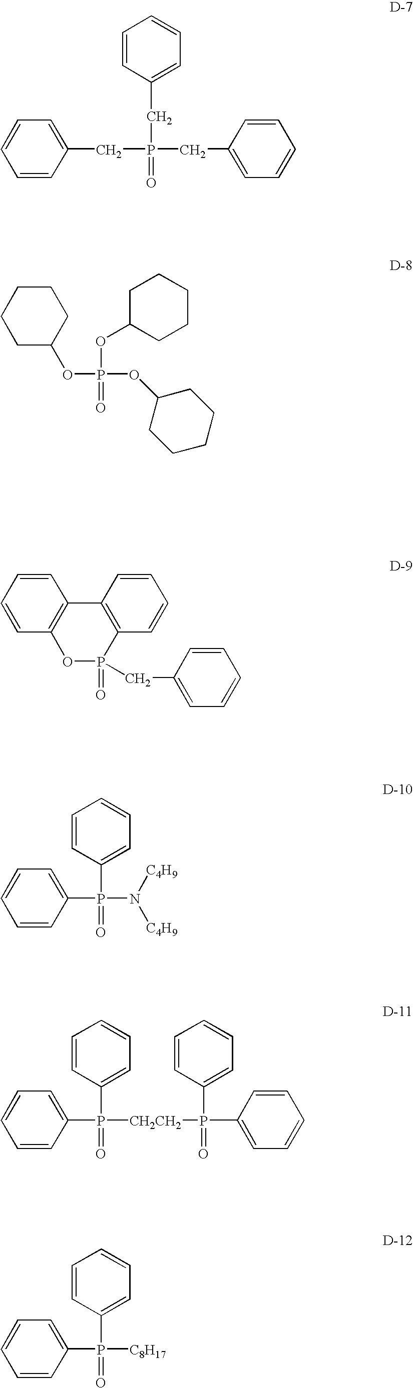

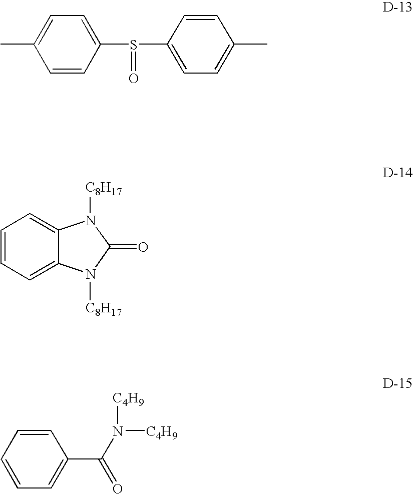

Specific examples of hydrogen bonding compounds other than those enumerated above can be found in those described in EP No. 1,096,310 and in JP-A Nos. 2002-156727 and 2002-318431.

The compound expressed by formula (D) used in the invention can be used in the photothermographic material by being incorporated into the coating solution in the form of solution, emulsion dispersion, or solid fine particle dispersion, similar to the case of reducing agent. However, it is preferably used in the form of solid dispersion. In the solution, the compound expressed by formula (D) forms a hydrogen-bonded complex with a compound having a phenolic hydroxy group or an amino group, and can be isolated as a complex in crystalline state depending on the combination of the reducing agent and the compound expressed by formula (D).

It is particularly preferred to use the crystal powder thus isolated in the form of solid fine particle dispersion, because it provides stable performance. Further, it is also preferred to use a method of leading to form complex during dispersion by mixing the reducing agent and the compound expressed by formula (D) in the form of powders and dispersing them with a proper dispersion agent using sand grinder mill or the like.

The compound expressed by formula (D) is preferably used in a range from 1 mol % to 200 mol %, more preferably from 10 mol % to 150 mol %, and even more preferably, from 20 mol % to 100 mol %, with respect to the reducing agent.

(Photosensitive Silver Halide)

1) Halogen Composition

For the photosensitive silver halide used in the invention, there is no particular restriction on the halogen composition and silver chloride, silver bromochloride, silver bromide, silver iodobromide, silver iodochlorobromide, and silver iodide can be used. Among them, silver bromide, silver iodobromide, and silver iodide are preferred. The distribution of the halogen composition in a grain may be uniform or the halogen composition may be changed stepwise, or it may be changed continuously. Further, a silver halide grain having a core/shell structure can be used preferably. Preferred structure is a twofold to fivefold structure and, more preferably, core/shell grain having a twofold to fourfold structure can be used. Further, a technique of localizing silver bromide or silver iodide to the surface of a silver chloride, silver bromide or silver chlorobromide grains can also be used preferably.

2) Method of Grain Formation

The method of forming photosensitive silver halide is well-known in the relevant art and, for example, methods described in Research Disclosure No. 10729, June 1978 and U.S. Pat. No. 3,700,458 can be used. Specifically, a method of preparing a photosensitive silver halide by adding a silver-supplying compound and a halogen-supplying compound in a gelatin or other polymer solution and then mixing them with an organic silver salt is used. Further, a method described in JP-A No. 11-119374 (paragraph Nos. 0217 to 0224) and methods described in JP-A Nos. 11-352627 and 2000-347335 are also preferred.

3) Grain Size

The grain size of the photosensitive silver halide is preferably small with an aim of suppressing clouding after image formation and, specifically, it is 0.20 μm or less, more preferably, from 0.01 μm to 0.15 μm and, even more preferably, from 0.02 μm to 0.12 μm. The grain size as used herein means an average diameter of a circle converted such that it has a same area as a projected area of the silver halide grain (projected area of a major plane in a case of a tabular grain).

4) Grain Shape

The shape of the silver halide grain can include, for example, cubic, octahedral, tabular, spherical, rod-like, or potato-like shape. The cubic grain is particularly preferred in the invention. A silver halide grain rounded at corners can also be used preferably. The surface indices (Miller indices) of the outer surface of a photosensitive silver halide grain is not particularly restricted, and it is preferable that the ratio occupied by the 1001 face is large, because of showing high spectral sensitization efficiency when a spectral sensitizing dye is adsorbed. The ratio is preferably 50% or more, more preferably, 65% or more and, even more preferably, 80% or more. The ratio of the {100} face, Miller indices, can be determined by a method described in T. Tani; J. Imaging Sci., vol. 29, page 165, (1985) utilizing adsorption dependency of the {111} face and {100} face in adsorption of a sensitizing dye.

5) Heavy Metal

The photosensitive silver halide grain of the invention can contain metals or complexes of metals belonging to groups 6 to 13 of the periodic table (showing groups 1 to 18). Preferred are metals or complexes of metals belonging to groups 6 to 10. The metal or the center metal of the metal complex from groups 6 to 13 of the periodic table is preferably rhodium, ruthenium, iridium, or ferrum. The metal complex may be used alone, or two or more kinds of complexes comprising identical or different species of metals may be used together. A preferred content is in a range from 1×10⁻⁹ mol to 1×10⁻³ mol per 1 mol of silver. The heavy metals, metal complexes and the adding method thereof are described in JP-A No. 7-225449, in paragraph Nos. 0018 to 0024 of JP-A No.11-65021 and in paragraph Nos. 0227 to 0240 of JP-A No. 11-119374.

In the present invention, a silver halide grain having a hexacyano metal complex present on the outermost surface of the grain is preferred. The hexacyano metal complex includes, for example, [Fe(CN)₆]⁴⁻, [Fe(CN)₆]³⁻, [Ru(CN)₆]⁴⁻, [Os(CN)₆]⁴⁻, [Co(CN)₆]³⁻, [Rh(CN)₆]³⁻, [Ir(CN)₆]³⁻, [Cr(CN)₆]³⁻, and [Re(CN)₆]³⁻. In the invention, hexacyano Fe complex is preferred.

Since the hexacyano complex exists in ionic form in an aqueous solution, paired cation is not important and alkali metal ion such as sodium ion, potassium ion, rubidium ion, cesium ion and lithium ion, ammonium ion, alkyl ammonium ion (for example, tetramethyl ammonium ion, tetraethyl ammonium ion, tetrapropyl ammonium ion, and tetra(n-butyl) ammonium ion), which are easily miscible with water and suitable to precipitation operation of a silver halide emulsion are preferably used.

The hexacyano metal complex can be added while being mixed with water, as well as a mixed solvent of water and an appropriate organic solvent miscible with water (for example, alcohols, ethers, glycols, ketones, esters, amides, or the like) or gelatin.

The addition amount of the hexacyano metal complex is preferably from 1×10⁻⁵ mol to 1×10⁻² mol and, more preferably, from 1×10⁻⁴ mol to 1×10⁻³ mol, per 1 mol of silver in each case.

In order to allow the hexacyano metal complex to be present on the outermost surface of a silver halide grain, the hexacyano metal complex is directly added in any stage of: after completion of addition of an aqueous solution of silver nitrate used for grain formation, before completion of an emulsion formation step prior to a chemical sensitization step, of conducting chalcogen sensitization such as sulfur sensitization, selenium sensitization and tellurium sensitization or noble metal sensitization such as gold sensitization, during a washing step, during a dispersion step and before a chemical sensitization step. In order not to grow fine silver halide grains, the hexacyano metal complex is rapidly added preferably after the grain is formed, and it is preferably added before completion of the emulsion formation step.

Addition of the hexacyano complex may be started after addition of 96% by weight of an entire amount of silver nitrate to be added for grain formation, more preferably started after addition of 98% by weight and, particularly preferably, started after addition of 99% by weight.

When any of the hexacyano metal complex is added after addition of an aqueous silver nitrate just before completion of grain formation, it can be adsorbed to the outermost surface of the silver halide grain and most of them form an insoluble salt with silver ions on the surface of the grain. Since the hexacyano iron (II) silver salt is a less soluble salt than AgI, re-dissolution with fine grains can be prevented and fine silver halide grains with smaller grain size can be prepared.

Metal atoms that can be contained in the silver halide grain used in the invention (for example, [Fe(CN)₆]⁴⁻), desalting method of a silver halide emulsion and chemical sensitizing method are described in paragraph Nos. 0046 to 0050 of JP-A No.11-84574, in paragraph Nos. 0025 to 0031 of JP-A No.11-65021, and paragraph Nos. 0242 to 0250 of JP-A No.11-119374.

6) Gelatin

As the gelatin contained the photosensitive silver halide emulsion used in the invention, various kinds of gelatins can be used. It is necessary to maintain an excellent dispersion state of a photosensitive silver halide emulsion in an organic silver salt containing coating solution, and gelatin having a molecular weight of 10,000 to 1,000,000 is preferably used. Phthalated gelatin is also preferably used. These gelatins may be used at grain formation step or at the time of dispersion after desalting treatment and it is preferably used at grain formation step.

7) Sensitizing Dye

As the sensitizing dye applicable in the invention, those capable of spectrally sensitizing silver halide grains in a desired wavelength region upon adsorption to silver halide grains having spectral sensitivity suitable to the spectral characteristic of an exposure light source can be advantageously selected. The sensitizing dyes and the adding method are disclosed, for example, JP-A No. 11-65021 (paragraph Nos. 0103 to 0109), as a compound represented by the formula (II) in JP-A No. 10-186572, dyes represented by the formula (I) in JP-A No. 11-119374 (paragraph No. 0106), dyes described in U.S. Pat. Nos. 5,510,236 and 3,871,887 (Example 5), dyes disclosed in JP-A Nos. 2-96131 and 59-48753, as well as in page 19, line 38 to page 20, line 35 of EP No. 0803764A1, and in JP-A Nos. 2001-272747, 2001-290238 and 2002-23306. The sensitizing dyes described above may be used alone or two or more of them may be used in combination. In the invention, sensitizing dye can be added preferably after a desalting step and before coating, and more preferably after a desalting step and before the completion of chemical ripening.

In the invention, the sensitizing dye may be added at any amount according to the property of sensitivity and fogging, but it is preferably added from 10⁻⁶ mol to 1 mol, and more preferably from 10⁻⁴ mol to 10⁻¹ mol, per 1 mol of silver halide in the image forming layer.

The photothermographic material of the invention may also contain super sensitizers in order to improve the spectral sensitizing effect. The super sensitizers usable in the invention can include those compounds described in EP-A No. 587338, U.S. Pat. Nos. 3,877,943 and 4,873,184, JP-A Nos. 5-341432, 11-109547, and 10-111543, and the like.

8) Chemical Sensitization

The photosensitive silver halide grain in the invention is preferably chemically sensitized by sulfur sensitizing method, selenium sensitizing method or tellurium sensitizing method. As the compound used preferably for sulfur sensitizing method, selenium sensitizing method and tellurium sensitizing method, known compounds, for example, compounds described in JP-A No. 7-128768 can be used. Particularly, tellurium sensitization is preferred in the invention and compounds described in the literature cited in paragraph No. 0030 in JP-A No. 11-65021 and compounds shown by formulae (II), (III), and (IV) in JP-A No. 5-313284 are preferred.

The photosensitive silver halide grain in the invention is preferably chemically sensitized by gold sensitizing method alone or in combination with the chalcogen sensitization described above. As the gold sensitizer, those having an oxidation number of gold of either +1 or +3 are preferred and those gold compounds used usually as the gold sensitizer are preferred. As typical examples, chloroauric acid, bromoauric acid, potassium chloroaurate, potassium bromoaurate, auric trichloride, potassium auric thiocyanate, potassium iodoaurate, tetracyanoauric acid, ammonium aurothiocyanate and pyridyl trichloro gold are preferred. Further, gold sensitizers described in U.S. Pat. No. 5,858,637 and JP-A No. 2002-278016 are also used preferably.

In the invention, chemical sensitization can be applied at any time so long as it is after grain formation and before coating and it can be applied, after desalting, (1) before spectral sensitization, (2) simultaneously with spectral sensitization, (3) after spectral sensitization, (4) just before coating, or the like.

The amount of sulfur, selenium, or tellurium sensitizer used in the invention may vary depending on the silver halide grain used, the chemical ripening condition and the like and it is used by about 10⁻⁸ mol to 10⁻² mol, preferably, 10⁻⁷ mol to 10⁻³ mol, per 1 mol of silver halide.

The addition amount of the gold sensitizer may vary depending on various conditions and it is generally from 10⁻⁷ mol to 10⁻³ mol and, preferably from 10⁻⁶ mol to 5×10⁻⁴ mol, per I mol of silver halide.

There is no particular restriction on the condition for the chemical sensitization in the invention and, appropriately, the pH is from 5 to 8, the pAg is from 6 to 11, and the temperature is from 40° C. to 95° C.

In the silver halide emulsion used in the invention, a thiosulfonic acid compound may be added by the method shown in EP-A No. 293,917.

A reductive compound is used preferably for the photosensitive silver halide grain in the invention. As the specific compound for the reduction sensitization, ascorbic acid or thiourea dioxide is preferred, as well as use of stannous chloride, aminoimino methane sulfonic acid, hydrazine derivatives, borane compounds, silane compounds and polyamine compounds are preferred. The reduction sensitizer may be added at any stage in the photosensitive emulsion producing process from crystal growth to the preparation step just before coating. Further, it is preferred to apply reduction sensitization by ripening while keeping the pH to 7 or higher or the pAg to 8.3 or lower for the emulsion, and it is also preferred to apply reduction sensitization by introducing a single addition portion of silver ions during grain formation.

9) Combined Use of a Plurality of Silver Halides

The photosensitive silver halide emulsion in the photothermographic material used in the invention may be used alone, or two or more kinds of them (for example, those of different average particle sizes, different halogen compositions, of different crystal habits and of different conditions for chemical sensitization) may be used together. Gradation can be controlled by using plural kinds of photosensitive silver halides of different sensitivity. The relevant techniques can include those described, for example, in JP-A Nos. 57-119341, 53-106125, 47-3929, 48-55730, 46-5187, 50-73627, and 57-150841. It is preferred to provide a sensitivity difference of 0.2 or more in terms of log E between each of the emulsions.

10) Coating Amount

The addition amount of the photosensitive silver halide, when expressed by the amount of coated silver per 1 m² of the photothermographic material, is preferably from 0.03 g/m² to 0.6 g/m², more preferably, from 0.05 g/m² to 0.4 g/m² and, even more preferably, from 0.07 g/m² to 0.3 g/m². The photosensitive silver halide is used in a range of from 0.01 mol to 0.5 mol, preferably, from 0.02 mol to 0.3 mol, and even more preferably from 0.03 mol to 0.2 mol, per I mol of the organic silver salt.

11) Mixing Photosensitive Silver Halide and Organic Silver Salt

The method of mixing the photosensitive silver halide and the organic silver salt can include a method of mixing separately prepared silver halide grains and organic silver salt by a high speed stirrer, ball mill, sand mill, colloid mill, vibration mill, or homogenizer, or a method of mixing a photosensitive silver halide completed for preparation at any timing in the preparation of an organic silver salt and preparing the organic silver salt. The effect of the invention can be obtained preferably by any of the methods described above. Further, a method of mixing two or more kinds of aqueous dispersions of organic silver salts and two or more kinds of aqueous dispersions of photosensitive silver salts upon mixing is used preferably for controlling the photographic properties.

12) Mixing Silver Halide into Coating Solution

In the invention, the time of adding silver halide to the coating solution for the image forming layer is preferably in a range of from 180 minutes before to just prior to the coating, more preferably, 60 minutes before to 10 seconds before coating. But there is no restriction for mixing method and mixing condition as long as the effect of the invention is sufficient. As an embodiment of a mixing method, there is a method of mixing in a tank and controlling an average residence time. The average residence time herein is calculated from addition flux and the amount of solution transferred to the coater. And another embodiment of mixing method is a method using a static mixer, which is described in 8th edition of “Ekitai Kongo Gijutu” by N. Harnby and M. F. Edwards, translated by Koji Takahashi (Nikkan Kogyo Shinbunsha, 1989).

(Binder)

Any kind of polymer may be used as the binder for the image forming layer of the present invention so long as it is a hydrophilic binder. Suitable as the binder are those that are transparent or translucent, and that are generally colorless, such as natural resin or polymer and their copolymers;

synthetic resin, or polymer and their copolymer; or media forming a film; for example included are gelatins, rubbers, poly(vinyl alcohols), hydroxylethyl celluloses, cellulose acetates, poly(vinyl pyrrolidones), casein, starch, poly(acrylic acids), and poly(methyl methacrylates).

In the present invention, 50% by weight or more of the binder used in the image forming layer is preferably formed by a hydrophilic binder, and particularly preferably, 70% by weight or more of the binder of the image forming layer is formed by a hydrophilic binder.

The specific examples of the hydrophilic binder include, but not limited to these examples, gelatin or gelatin derivatives (for example, alkali-processed gelatin, acid-processed gelatin, acetylated gelatin, oxidized gelatin, phthalated gelatin, or deionized gelatin), polysilicic acid, acrylamide/methacrylamide polymer, acrylate/methacrylate polymer, poly(vinyl pyrrolidones), poly(vinyl acetates), poly(vinyl alcohols), poly(vinyl lactams), polymer of sulfoalkyl acrylate, polymer of sulfoalkyl methacrylate, hydrolyzed poly(vinyl acetate), polysaccarides (for example, dextrans, starch ethers, and the like), and the other substantially hydrophilic synthetic or natural vehicles (for example, referred to Research Disclosure, item 38957). Among them, more preferred binder are gelatin, a gelatin derivative, and a poly(vinyl alcohols), and most preferred are gelatin and a gelatin derivative.

In the invention, the image forming layer is preferably formed by first applying a coating solution containing 30% by weight or more of water in the solvent and by then drying, and particularly preferably applying a coating solution containing 50% by weight or more of water.

The aqueous solvent in which the polymer is soluble or dispersible, as referred herein, signifies water or water containing mixed therein 70% by weight or less of water-miscible organic solvent. As water-miscible organic solvents, there can be used, for example, alcohols such as methyl alcohol, ethyl alcohol, propyl alcohol, or the like; cellosolves such as methyl cellosolve, ethyl cellosolve, butyl cellosolve, or the like; ethyl acetate, dimethylformamide, or the like.

As a binder other than the hydrophilic binder, polymers dispersible in an aqueous solvent are preferred. Preferred embodiment of these polymers includes hydrophobic polymers such as acrylic polymers, polyesters, rubbers (e.g., SBR resin), polyurethanes, poly(vinyl chlorides), poly(vinyl acetates), poly(vinylidene chlorides), polyolefins, or the like. As the polymers above, usable are straight chain polymers, branched polymers, or crosslinked polymers; also usable are the so-called homopolymers in which one kind of monomer is polymerized, or copolymers in which two or more kinds of monomers are polymerized. In the case of a copolymer, it may be a random copolymer or a block copolymer. The molecular weight of these polymers is, in number average molecular weight, in a range of from 5,000 to 1,000,000, and preferably from 10,000 to 200,000. Those having too small a molecular weight exhibit insufficient mechanical strength on forming the image forming layer, and those having too large a molecular weight are also not preferred because the resulting film-forming properties are poor. Further, crosslinking polymer latexes are particularly preferred for use.

Concerning the amount of the binder for the image forming layer according to the invention, the mass ratio of organic silver salt to total binder (organic silver salt/total binder) is preferably in a range of from 1/10 to 10/1, more preferably from 0.6 to 3.0, and even more preferably from 1.0 to 2.5.

The total amount of binder in the image forming layer of the invention is preferably in a range of from 0.2 g/m² to 30 g/m², more preferably from 1 g/m² to 15 g/m², and even more preferably from 2 g/m² to 10 g/m². To the image forming layer of the invention, there may be added a crosslinking agent for crosslinking, a surfactant to improve coating ability, or the like.

(Preferable Solvent for Coating Solution)

In the invention, a solvent of a coating solution for the image forming layer in the photothermographic material of the invention (wherein a solvent and water are collectively described as a solvent for simplicity) is preferably an aqueous solvent containing water at 30% by weight or more. Examples of solvents other than water may include any of water-miscible organic solvents such as methyl alcohol, ethyl alcohol, isopropyl alcohol, methyl cellosolve, ethyl cellosolve, dimethylformamide and ethyl acetate. A water content in a solvent is more preferably 50% by weight or more, and even more preferably 70% by weight or more. Concrete examples of a preferable solvent composition, in addition to water=100, are compositions in which methyl alcohol is contained at ratios of water/methyl alcohol=90/10 and 70/30, in which dimethylformamide is further contained at a ratio of water/methyl alcohol/dimethylformamide=80/15/5, in which ethyl cellosolve is further contained at a ratio of water/methyl alcohol/ethyl cellosolve=85/10/5, and in which isopropyl alcohol is further contained at a ratio of water/methyl alcohol/isopropyl alcohol=85/10/5 (wherein the numerals presented above are values in % by weight).

(Antifoggant)

As an antifoggant, stabilizer and stabilizer precursor usable in the invention, there can be mentioned those disclosed as patents in paragraph number 0070 of JP-A No. 10-62899 and in line 57 of page 20 to line 7 of page 21 of EP-A No. 0803764A1, the compounds described in JP-A Nos. 9-281637 and 9-329864, U.S. Pat. No. 6,083,681, and EP No. 1,048,975.

1) Organic Polyhalogen Compound

Preferable organic polyhalogen compound that can be used in the invention is explained specifically below. In the invention, preferred organic polyhalogen compounds are the compounds expressed by the following formula (H).
Q-(Y)n-C(X₁)(X₂)Z Formula (H)

In formula (H), Q represents one selected from an alkyl group, an aryl group, or a heterocyclic group; Y represents a divalent linking group; n represents 0 or 1; Z represents a halogen atom; and X₁ and X₂ each represent a hydrogen atom or an electron-attracting group.

In formula (H), Q is preferably an alkyl group having 1 to 6 carbon atoms, an aryl group having 6 to 12 carbon atoms, or a heterocyclic group comprising at least one nitrogen atom (pyridine, quinoline, or the like).

In the case where Q is an aryl group in formula (H), Q preferably is a phenyl group substituted by an electron-attracting group whose Hammett substituent constant up yields a positive value. For the details of Hammett substituent constant, reference can be made to Journal of Medicinal Chemistry, vol. 16, No. 11 (1973), pp. 1207 to 1216, and the like. As such electron-attracting groups, examples include halogen atoms, an alkyl group substituted by an electron-attracting group, an aryl group substituted by an electron-attracting group, a heterocyclic group, an alkylsulfonyl group, an arylsulfonyl group, an acyl group, an alkoxycarbonyl group, a carbamoyl group, sulfamoyl group, and the like. Preferable as the electron-attracting group are a halogen atom, a carbamoyl group, and an arylsulfonyl group, and particularly preferred is a carbamoyl group.

At least one of X₁ and X₂ is preferably an electron-attracting group. As the electron-attracting group, preferable are a halogen atom, an aliphatic arylsulfonyl group, a heterocyclic sulfonyl group, an aliphatic arylacyl group, a heterocyclic acyl group, an aliphatic aryloxycarbonyl group, a heterocyclic oxycarbonyl group, a carbamoyl group, and a sulfamoyl group; more preferable are a halogen atom and a carbamoyl group; and particularly preferable is a bromine atom.

Z is preferably a bromine atom or an iodine atom, and more preferably, a bromine atom.

Y preferably represents —C(═O)—, —SO—, —SO₂—, —C(═O)N(R)—, or —SO₂N(R)—; more preferably, —C(═O)—, —SO₂—, or —C(═O)N(R)—; and particularly preferably, —SO₂— or —C(═O)N(R)—. Herein, R represents a hydrogen atom, an aryl group, or an alkyl group, preferably a hydrogen atom or an alkyl group, and particularly preferably a hydrogen atom.

n represents 0 or 1, and preferably represents 1.

In formula (H), in the case where Q is an alkyl group, Y is preferably —C(═O)N(R)—. And, in the case where Q is an aryl group or a heterocyclic group, Y is preferably —SO₂—.

In formula (H), the form where the residues, which are obtained by removing a hydrogen atom from the compound, bind to each other (generally called bis type, tris type, or tetrakis type) is also preferably used.

In formula (H), the form having a substituent of a dissociative group (for example, a COOH group or a salt thereof, an SO₃H group or a salt thereof, a PO₃H group or a salt thereof, or the like), a group containing a quaternary nitrogen cation (for example, an ammonium group, a pyridinium group, or the like), a polyethyleneoxy group, a hydroxy group, or the like is also preferable.

Specific examples of the compound expressed by formula (H) of the invention are shown below.

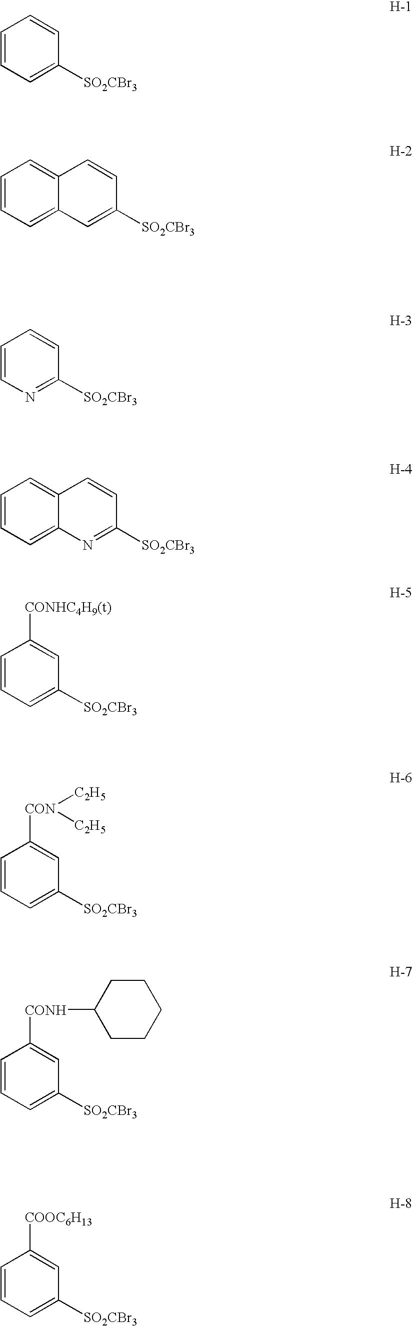

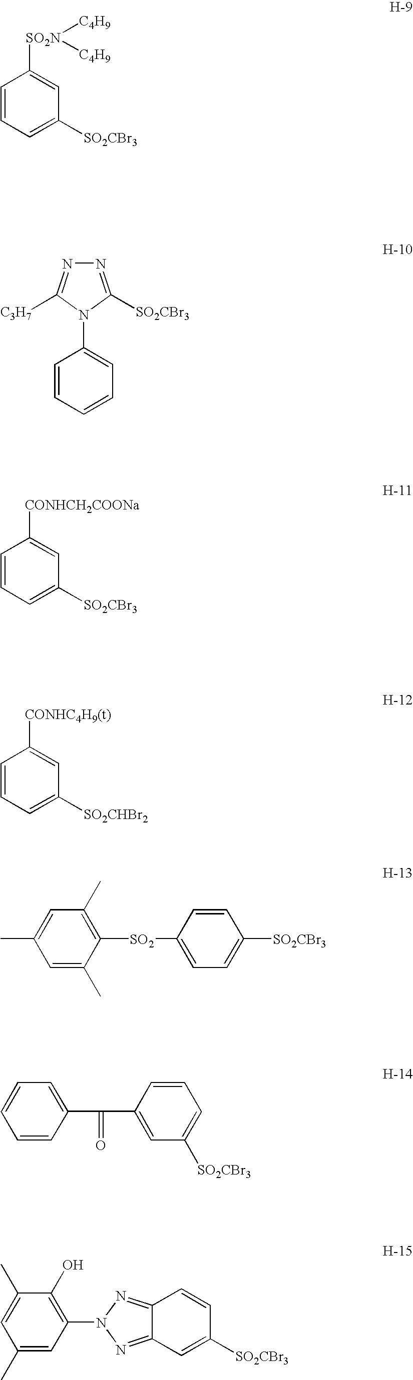

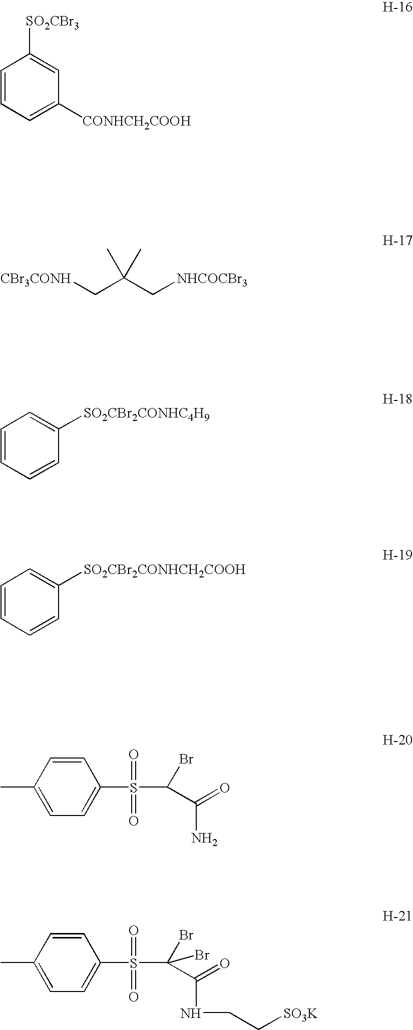

As preferred organic polyhalogen compounds of the invention other than those above, there can be mentioned compounds disclosed in U.S. Pat. Nos. 3,874,946, 4,756,999, 5,340,712, 5,369,000, 5,464,737, and 6,506,548, JP-A Nos. 50-137126, 50-89020, 50-119624, 59-57234, 7-2781, 7-5621, 9-160164, 9-244177, 9-244178, 9-160167, 9-319022, 9-258367, 9-265150, 9-319022, 10-197988, 10-197989, 11-242304, 2000-2963, 2000-112070, 2000-284410, 2000-284412, 2001-33911, 2001-31644, 2001-312027, and 2003-50441. Particularly, compounds disclosed in JP-A Nos. 7-2781, 2001-33911 and 20001-312027 are preferable.

The compounds expressed by formula (H) of the invention are preferably used in an amount from 10⁻⁴ mol to 1 mol, more preferably, from 10⁻³ mol to 0.5 mol, and even more preferably, from 1×10⁻² mol to 0.2 mol, per 1 mol of non-photosensitive silver salt incorporated in the image forming layer.

In the invention, usable methods for incorporating the antifoggant into the photothermographic material are those described above in the method for incorporating the reducing agent, and also for the organic polyhalogen compound, it is preferably added in the form of a solid fine particle dispersion.

2) Other Antifoggants

As other antifoggants, there can be mentioned a mercury (II) salt described in paragraph number 0113 of JP-A No. 11-65021, benzoic acids described in paragraph number 0114 of the same literature, a salicylic acid derivative described in JP-A No. 2000-206642, a formaline scavenger compound expressed by formula (S) in JP-A No. 2000-221634, a triazine compound related to Claim 9 of JP-A No. 11-352624, a compound expressed by formula (III), 4-hydroxy-6-methyl-1,3,3a,7-tetrazaindene and the like, described in JP-A No. 6-11791.

The photothermographic material of the invention may further contain an azolium salt in order to prevent fogging. Azolium salts useful in the present invention include a compound expressed by formula (XI) described in JP-A No. 59-193447, a compound described in Japanese Patent Application Publication (JP-B) No. 55-12581, and a compound expressed by formula (II) in JP-A No. 60-153039. The azolium salt may be added to any part of the photothermographic material, but as an additional layer, it is preferred to select a layer on the side having thereon the image forming layer, and more preferred is to select the image forming layer itself. The azolium salt may be added at any time of the process of preparing the coating solution; in the case where the azolium salt is added into the image forming layer, any time of the process may be selected, from the preparation of the organic silver salt to the preparation of the coating solution, but preferred is to add the salt after preparing the organic silver salt and just before coating. As the method for adding the azolium salt, any method using a powder, a solution, a fine-particle dispersion, and the like, may be used. Furthermore, it may be added as a solution having mixed therein other additives such as sensitizing agents, reducing agents, toners, and the like. In the invention, the azolium salt may be added at any amount, but preferably, it is added in a range from 1×10⁻⁶ mol to 2 mol, and more preferably, from 1×10⁻³ mol to 0.5 mol, per 1 mol of silver.

(Compound of Formula (I) or (II))

The compound of formula (I) or (II) used in the present invention is explained.

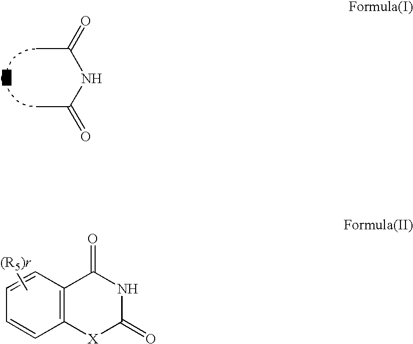

In formula (I), Q represents an atomic group necessary for forming a 5 or 6-membered imide ring. In formula (II), R₅ independently represents one or more hydrogen atoms, an alkyl group, a cycloalkyl group, an alkoxy group, an alkylthio group, an arylthio group, a hydroxy group, a halogen atom, or an N(R₈R₉) group. Two R₅s may link together to form an aromatic, heteroaromatic, alicyclic, or heterocyclic condensed ring. Herein, R₈ and R₉ each independently represent a hydrogen atom, an alkyl group, an aryl group, a cycloalkyl group, an alkenyl group, or a heterocyclic group, or R₈ and R₉ can link together and represent an atomic group necessary for forming a substituted or unsubstituted 5 to 7-membered heterocycle. X represents O, S, Se or N(R₆) and R₆ represents a hydrogen atom, an alkyl group, an aryl group, a cycloalkyl group, or a heterocyclic group. r represents 0, 1, or 2.

1) Formula (I)

The nitrogen atom and the carbon atom which composes Q may bind with a hydrogen atom, an amino group, an alkyl group having 1 to 4 carbon atoms, a halogen atom, a keto-formed oxygen atom, an aryl group, or the like as a branch. As the specific example of the compound having an imide ring represented by formula (I), uracil, 5-bromouracil, 4-methyluracil, 5-methyluracil, 4-carboxyuracil, 4,5-dimethyluracil, 5-aminouracil, dihydrouracil, 1-ethyl-6-methyluracil, 5-carboxymethylaminouracil, barbituric acid, 5-phenylbarbituric acid, cyanuric acid, urazole, hydantoin, 5,5-dimethylhydantoin, gultarimide, glutaconimide, citrazic acid, succinimide, 3,4-dimethylsuccinimide, maleimide, phthalimide, naphthalimide, and the like are described, but the examples are not limited in these. In the present invention, among the compounds having an imide ring represented by formula (I), succinimide, phthalimide, naphthalimide, and 3,4-dimethylsuccinimide are preferred, and succinimide is particularly preferred.

2) Formula (II)

In formula (II), R₅ independently represents one or more hydrogen atoms, an alkyl group, a cycloalkyl group, an alkoxy group, an alkylthio group, an arylthio group, a hydroxy group, a halogen atom, or an N(R₈R₉) group. Further, two R₅s may link together to form an aromatic, heteroaromatic, alicyclic, or heterocyclic condensed ring. In the case where R₅ represents an amino group [(R₈R₉)], R₈ and R₉ each independently represent a hydrogen atom, an alkyl group, an aryl group, a cycloalkyl group, an alkenyl group, or a heterocyclic group. Furthermore, R₈ and R₉ can link together and represent an atomic group necessary for forming a substituted or unsubstituted 5 to 7-membered heterocycle. In formula (II), X represents O, S, Se, or N(R₆) and R₆ represents a hydrogen atom, an alkyl group, an aryl group, a cycloalkyl group, an alkenyl group, or a heterocyclic group. r represents 0, 1, or 2.

Useful alkyl group as R₅, R₆, R₈, or R₉ is linear, branched, or cyclic one and can have 1 to 20 carbon atoms, and has preferaby 1 to 5 carbon atoms. The alkyl group having 1 to 4 carbon atoms (e.g., methyl, ethyl, iso-propyl, n-butyl, t-butyl, or sec-butyl) is particularly preferable.

Useful aryl group as R₅, R₆, R₈, or R₉ can have 6 to 14 carbon atoms in an aromatic ring (one or plural). Preferred aryl group are a phenyl group and a substituted phenyl group.

Useful cycloalkyl group as R₅, R₆, R₈, or R₉ can have 5 to 14 carbon atoms in a center ring system. Preferred cycloalkyl group are cyclopentyl and cyclohexyl.

Useful alkenyl and alkynyl group can be branched or linear and have 2 to 20 carbon atoms. Preferred alkenyl group is allyl.

Useful heterocyclic group as R₅, R₆, R₈, or R₉ can have 5 to 10 carbon atoms, an oxygen atom, a sulfur atom, or a nitrogen atom in a center ring system and may have a condensed ring.

These alkyl, aryl, cycloalkyl, and heterocyclic groups can be further substituted by one or more groups containing a halo group, an alkoxycarbonyl group, a hydroxy group, an alkoxy group, a cyano group, an acyl group, an acyloxy group, a carbonyloxyester group, a sufonate ester group, an alkylthio group, a dialkylamino group, a carboxy group, a sulfo group, a phosphono group, or other group which the art can easily understand, however substituents are not limited in these.

Useful alkoxy group, alkylthio group, or arylthio group as R₅ has the above-mentioned alkyl group or arly group. Preferred halogen atom are chlorine and bromine atom. Representative compounds of formula (II) are the following compound II-1 to II-10. Compound II-1 is most preferable.

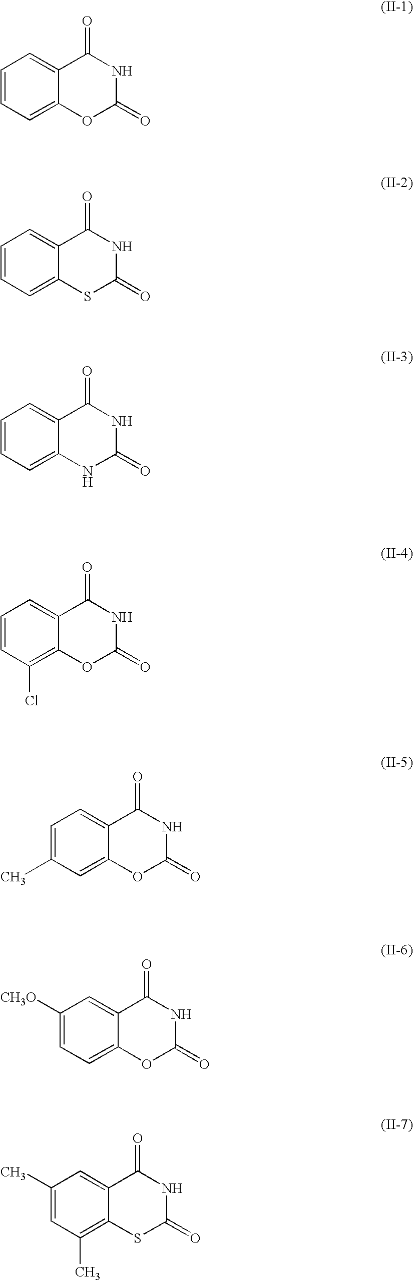

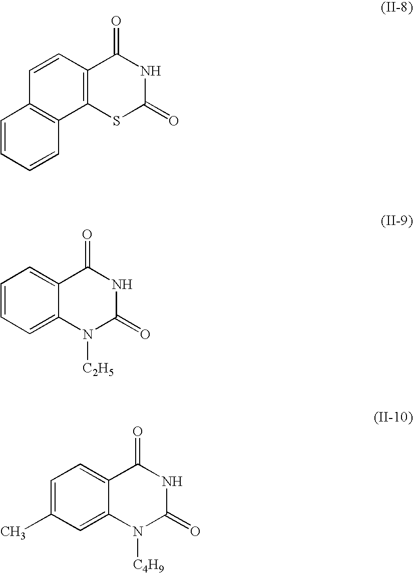

Other useful substituted benzoxazinediones are described in the specification of U.S. Pat. No. 3,951,660. These compounds of formula (I) or (II) are preferred to use as a toner. As a toner used in combination with compound of formula (I) or (II), phthalazinone, a phthalazinone derivative, or a metal salt of the derivative (e.g., 4-(1-naphthyl)phthalazinone , 6-chlorophthalazinone, 5,7-dimethoxyphthalazinone, or 2,3-dihydro-1,4-phthalazinedione); phthalazine or a phthalazine derivative (e.g., 5-isopropylphthalazine) or a phthalic acid derivative (e.g., phthalic acid, 4-methylphthalic acid, 4-nitrophthalic acid, or tetrachlorophthalic acid) may be used as a combination.

The addition amount of the compound of formula (I) or (II) in the present invention is preferably in a range of from 10⁻⁴ mol to 1 mol per 1 mol of non-photosensitive silver salt in the image forming layer, more preferably from 10⁻³ mol to 0.5 mol, and even more preferably from 1×10⁻² mol to 0.3 mol.

Concerning the method for incorporating the compound of formula (I) or (II) of the present invention in the photothermographic material, similar method to the case of reducing agent can be described. Water-soluble compound is preferably added as an aqueous solution and water-insoluble compound is preferably added as a solid fine particle dispersion.

The compound of formula (I) or (II) of the present invention is preferably added in the image forming layer or in the layer adjacent to the image forming layer such as a protective layer or an intermediate layer, and is particularly preferably added in the image forming layer.

(Plasticizer and Lubricant)

In the invention, well-known plasticizer and lubricant can be used to improve physical properties of film. Particularly, to improve handling facility during manufacturing process or scratch resistance during thermal development, it is preferred to use a lubricant such as a liquid paraffin, a long chain fatty acid, an amide of fatty acid, an ester of fatty acid, or the like. Paticularly preferred are a liquid paraffin obtained by removing components having low boiling point and an ester of fatty acid having a branch structure and a molecular weight of 1000 or more.

Concerning the plasticizers and lubricants usable in the image forming layer and in the non-photosensitive layer, compounds described in paragraph No. 0117 of JP-A No. 11-65021 and in JP-A Nos. 2000-5137, 2004-219794, 2004-219802, and 2004-334077 are preferable.

(Dyes and Pigments)

From the viewpoint of improving color tone, of preventing the generation of interference fringes and of preventing irradiation on laser exposure, various types of dyes and pigments (for instance, C.I. Pigment Blue 60, C.I. Pigment Blue 64, and C.I. Pigment Blue 15:6) can be used in combination with the aforementioned phthalocyanine compound in the image forming layer of the invention. Detailed description can be found in WO No. 98/36322, JP-A Nos. 10-268465 and 11-338098, and the like.

(Nucleator)

Concerning the photothermographic material of the invention, it is preferred to add a nucleator into the image forming layer. Details on the nucleators, method for their addition and addition amount can be found in paragraph No. 0118 of JP-A No. 11-65021, paragraph Nos. 0136 to 0193 of JP-A No. 11-223898, as compounds expressed by formulae (H), (1) to (3), (A), and (B) in JP-A No. 2000-284399; as for a nucleation accelerator, description can be found in paragraph No. 0102 of JP-A No. 11-65021, and in paragraph Nos. 0194 to 0195 of JP-A No. 11-223898.

In the case of using formic acid or formates as a strong fogging agent, it is preferably incorporated into the side having thereon the image forming layer containing photosensitive silver halide at an amount of 5 mmol or less, and more preferably 1 mmol or less, per 1 mol of silver.

In the case of using a nucleator in the photothermographic material of the invention, it is preferred to use an acid resulting from hydration of diphosphorus pentaoxide, or a salt thereof in combination. Acids resulting from the hydration of diphosphorus pentaoxide or salts thereof include metaphosphoric acid (salt), pyrophosphoric acid (salt), orthophosphoric acid (salt), triphosphoric acid (salt), tetraphosphoric acid (salt), hexametaphosphoric acid (salt), and the like. Particularly preferred acids obtainable by the hydration of diphosphorus pentaoxide or salts thereof include orthophosphoric acid (salt) and hexametaphosphoric acid (salt).

Specifically mentioned as the salts are sodium orthophosphate, sodium dihydrogen orthophosphate, sodium hexametaphosphate, ammonium hexametaphosphate, and the like.

The addition amount of the acid obtained by hydration of diphoshorus pentaoxide or the salt thereof (i.e., the coating amount per 1 m² of the photothermographic material) may be set as desired depending on sensitivity and fogging, but preferred is an amount of from 0.1 mg/m² to 500 mg/m², and more preferably, from 0.5 mg/m² to 100 mg/m².

(Wrapping Material)

In order to suppress fluctuation from occurring on the photographic property during a preservation of the photothermographic material of the invention before thermal development, or in order to improve curling or winding tendencies when the photothermographic material is manufactured in a roll state, it is preferred that a wrapping material having low oxygen transmittance and/or vapor transmittance is used. Preferably, oxygen transmittance is 50 mL.atm⁻¹m⁻²day⁻¹ or lower at 25° C., more preferably, 10 mL.atm⁻¹m⁻²day⁻¹ or lower, and even more preferably, 1.0 mL.atm⁻¹m⁻²day⁻¹ or lower. Preferably, vapor transmittance is 10 g.atm⁻¹m⁻²day⁻¹ or lower, more preferably, 5 g.atm⁻¹m⁻²day⁻¹ or lower, and even more preferably, 1 g.atm⁻¹m⁻²day⁻¹ or lower.

As specific examples of a wrapping material having low oxygen transmittance and/or vapor transmittance, reference can be made to, for instance, the wrapping material described in JP-A Nos.8-254793 and 2000-206653.

(Other Applicable Techniques)

Techniques which can be used for the photothermographic material of the invention also include those in EP No. 803764A1, EP No. 883022A1, WO No. 98/36322, JP-A Nos. 56-62648, and 58-62644, JP-A Nos. 09-43766, 09-281637, 09-297367, 09-304869, 09-311405, 09-329865, 10-10669, 10-62899, 10-69023, 10-186568, 10-90823, 10-171063, 10-186565, 10-186567, 10-186569 to 10-186572, 10-197974, 10-197982, 10-197983, 10-197985 to 10-197987, 10-207001, 10-207004, 10-221807, 10-282601, 10-288823, 10-288824, 10-307365, 10-312038, 10-339934, 11-7100, 11-15105, 11-24200, 11-24201, 11-30832, 11-84574, 11-65021, 11-109547, 11-125880, 11-129629, 11-133536 to 11-133539, 11-133542, 11-133543, 11-223898, 11-352627, 11-305377, 11-305378, 11-305384, 11-305380, 11-316435, 11-327076, 11-338096, 11-338098, 11-338099, 11-343420, 2001-200414, 2001-234635, 2002-020699, 2001-275471, 2001-275461, 2000-313204, 2001-292844, 2000-324888, 2001-293864, 2001-348546, and 2000-187298.

3. Image Forming Method

1) Exposure

The photothermographic material of the invention may be subjected to imagewise exposure by any methods. One of the preferred means for exposure is X-ray exposure using the afore-mentioned fluorescent intensifying screen.

As other imagewise exposure means, scanning exposure by laser beam can be used. As laser beam, He—Ne laser of red through infrared emission, red laser diode, or Ar⁺, He—Ne, He—Cd laser of blue through green emission, or blue laser diode can be used. Preferred is red to infrared laser diode and the peak wavelength of laser beam is 600 nm to 900 nm, and preferably 620 nm to 850 nm. From the standpoint of utilizing a high power provided by the laser power and making the processed photothermographic material of the present invention transparent, an infrared laser diode (780 nm, 810 nm) is preferably employed.

In recent years, development has been made particularly on a light source module with an SHG (a second harmonic generator) and a laser diode integrated into a single piece whereby a laser output apparatus in a short wavelength region has become popular. A blue laser diode enables high definition image recording and makes it possible to obtain an increase in recording density and a stable output over a long lifetime, which results in expectation of an expanded demand in the future. The peak wavelength of blue laser beam is preferably from 300 nm to 500 nm, and particularly preferably from 400 nm to 500 nm.

Laser beam which oscillates in a longitudinal multiple modulation by a method such as high frequency superposition is also preferably employed.

2) Thermal Development

Although any method may be used for this thermal developing process, development is usually performed by elevating the temperature of the photothermographic material exposed imagewise. The temperature of development is preferably from 80° C. to 250° C., more preferably from 100° C. to 140° C., and even more preferably from 110° C. to 130° C. Time period for development is preferably from 1 second to 60 seconds, more preferably from 3 seconds to 30 seconds, even more preferably from 5 seconds to 25 seconds, and particularly preferably from 7 seconds to 15 seconds.

A conveying speed of the photothermographic material in a thermal developing portion is preferably from 23 mm/second to 200 mm/second, and more preferably from 28 mm/second to 150 mm/second.

Concerning the process of thermal development, either a drum type heater or a plate type heater may be used. However, a plate type heater is preferred.

For downsizing the thermal developing apparatus and for shortening the time period for thermal development, it is preferable that the heater is more stably controlled, and a top part of one sheet of the photothermographic material is exposed and thermal development of the exposed portion is started before exposure of the end part of the sheet has completed.

Preferred imagers capable of rapid processing for use in the invention are described in, for example, JP-A Nos. 2002-289804 and 2002-287668. When such imagers are used, thermal development within 14 seconds is possible with a plate type heater having three heating plates which are controlled, for example, at 107° C., 121° C., and 121° C., respectively. Thus, the output time period for the first sheet can be reduced to about 60 seconds.

3) System

Examples of a medical laser imager equipped with a light exposing portion and a thermal developing portion include Fuji Medical Dry Laser Imager FM-DPL and DRYPIX 7000, and KODAK DRYVIEW 8700 Laser Imager Plus can be applied. In connection with FM-DPL, description is found in Fuji Medical Review No. 8, pages 39 to 55. The described techniques may be applied as the laser imager for the photothermographic material of the invention. In addition, the present photothermographic material can be also applied as a photothermographic material for the laser imager used in “AD network” which was proposed by Fuji Film Medical Co., Ltd. as a network system accommodated to DICOM standard.

(Application of the Invention)

The photothermographic material and the image forming method of the invention are preferably used for photothermographic materials for use in medical diagnosis, photothermographic materials for use in industrial photographs, photothermographic materials for use in graphic arts, as well as for COM, through forming black and white images by silver imaging, and the image forming method using the same. In particular, the photothermographic material and the image forming method of the invention are preferably used for medical diagnosis.

### EXAMPLES

The present invention is specifically explained by way of Examples below, which should not be construed as limiting the invention thereto.

### Example 1

1. Preparation of PET Support

1) Film Manufacturing

PET having IV (intrinsic viscosity) of 0.66 (measured in phenol/tetrachloroethane=6/4 (mass ratio) at 25° C.) was obtained according to a conventional manner using terephthalic acid and ethylene glycol. The product was pelletized, dried at 130° C. for 4 hours, and melted at 300° C. Thereafter, the mixture was extruded from a T-die and rapidly cooled to form a non-tentered film.

The film was stretched along the longitudinal direction by 3.3 times using rollers of different peripheral speeds, and then stretched along the transverse direction by 4.5 times using a tenter machine. The temperatures used for these operations were 110° C. and 130° C., respectively. Then, the film was subjected to thermal fixation at 240° C. for 20 seconds, and relaxed by 4% along the transverse direction at the same temperature. Thereafter, the chucking part was slit off, and both edges of the film were knurled. Then the film was rolled up at the tension of 4 kg/cm² to obtain a roll having the thickness of 175 μm.

2) Surface Corona Discharge Treatment

Both surfaces of the support were treated at room temperature at 20 m/minute using Solid State Corona Discharge Treatment Machine Model 6KVA manufactured by Piller GmbH. It was proven that treatment of 0.375 kV.A.minute/m² was executed, judging from the readings of current and voltage on that occasion. The frequency upon this treatment was 9.6 kHz, and the gap clearance between the electrode and dielectric roll was 1.6 mm.

3) Undercoating

| | |
|---|---|
| (1) Preperation of Coating Solution for Undercoat Layer | |
| Formula (1) (for undercoat layer on the image forming layer | |
| side) | |
| Pesresin A-520 manufactured by Takamatsu Oil & Fat Co., | 46.8 g |
| Ltd. (30% by weight solution) | |
| BAIRONAARU MD-1200 manufactured by Toyo Boseki Co., | 10.4 g |
| Ltd. | |
| Polyethyleneglycol monononylphenylether (average ethylene | 11.0 g |
| oxide number = 8.5) 1% by weight solution | |
| MP-1000 manufactured by Soken Chemical & Engineering | 0.91 g |
| Co., Ltd. (PMMA polymer fine particle, mean particle | |
| diamerte of 0.4 μm) | |
| Distilled water | 931 mL |
| Formula (2) (for first layer on the backside) | |
| Styrene-butadiene copolymer latex (solid content of 40% by | 130.8 g |
| weight styrene/butadiene mass ratio = 68/32) | |
| Sodium salt of 2,4-dichloro-6-hydroxy-S-triazine | 5.2 g |
| (8% by weight aqueous solution) | |
| 1% by weight aqueous solution of sodium | 10 mL |
| laurylbenzenesulfonate | |
| Polystyrene particle dispersion (mean particle diameter of | 0.5 g |
| 2 μm, 20% by weight) | |
| Distilled water | 854 mL |
| Formula (3) (for second layer on the backside) | |
| SnO₂/SbO (9/1 mass ratio, mean particle diameter of 0.5 μm, | 84 g |
| 17% by weight dispersion) | |
| Gelatin | 7.9 g |
| METOLOSE TC-5 manufactured by Shin-Etsu Chemical Co., | 10 g |
| Ltd. (2% by weight aqueous solution) | |
| 1% by weight aqueous solution of sodium | 10 mL |
| dodecylbenzenesulfonate | |
| NaOH (1% by weight) | 7 g |
| Proxel (manufactured by Imperial Chemical Industries PLC) | 0.5 g |
| Distilled water | 881 mL |

Both surfaces of the biaxially tentered polyethylene terephthalate support having the thickness of 175 μm were subjected to the corona discharge treatment as described above, respectively. Thereafter, the aforementioned formula (1) of the coating solution for the undercoat was coated on one surface (image forming layer side) with a wire bar so that the amount of wet coating became 6.6 mL/m² (per one side), and dried at 1 80° C. for 5 minutes. Then, the aforementioned formula (2) of the coating solution for the undercoat was coated on the reverse side (backside) with a wire bar so that the amount of wet coating became 5.7 mL/m², and dried at 180° C. for 5 minutes. Furthermore, the aforementioned formula (3) of the coating solution for the undercoat was coated on the reverse side (backside) with a wire bar so that the amount of wet coating became 8.4 mL/m², and dried at 180° C. for 6 minutes. Thus, an undercoated support was produced.

(Back Layer)

1) Preparation of Coating Solution for Back Layer

<<Preparation of Dispersion of Dye A>>

15 g of Dye A, 6.4 g of Demol N (trade name, available from Kao Co. Ltd.) and 250 g of water were thoroughly mixed to give a slurry. The slurry was added into a vessel with separately prepared 800 g of zirconia beads having a mean particle diameter of 0.5 mm, and dispersed for 25 hours by using a dispersing apparatus (¼ G sand grinder mill: produced by AIMEX Co. Ltd.) and then water were added thereto, thereby adjusting the concentration of the dye to be 5% by weight. Accordingly, a dye dispersion was prepared.

<<Preparation of Coating Solution for Antihalation Layer>>

A vessel was kept at 40° C., and thereto were added 37 g of gelatin having an isoelectric point of 4.8 (PZ gelatin, trade name, manufactured by Miyagi Chemical Industry Co., Ltd.), 0.1 g of benzoisothiazolinone, and water to allow gelatin to be dissolved. Additionally, 43 mL of a 3% by weight aqueous solution of sodium polystyrenesulfonate, 82 g of a 10% by weight solution of SBR latex (styrene/butadiene/acrylic acid copolymer, mass ratio of the copolymerization of 68.3/28.7/3.0), and 40 g of the dispersion of dye A prepared above were added to the mixture to prepare a coating solution for antihalation layer.

2) Preparation of Coating Solution for Back Surface Protective Layer

A vessel was kept at 40° C., and thereto were added 43 g of gelatin having an isoelectric point of 4.8 (PZ gelatin, manufactured by Miyagi Chemical Industry Co., Ltd.), 0.21 g of benzoisothiazolinone, and water to allow gelatin to be dissolved. Additionally, 8.1 mL of a 1 mol/L sodium acetate aqueous solution, 0.93 g of monodispersed fine particles of poly(ethylene glycol dimethacrylate-co-methylmethacrylate) (mean particle diameter of 7.7 μm, standard deviation of particle diameter of 0.3), 5 g of a 10% by weight emulsion of liquid paraffin, 10 g of a 10% by weight emulsion of dipentaerythritol hexaisostearate, 10 mL of a 5% by weight aqueous solution of sodium di(2-ethylhexyl)sulfosuccinate, 17 mL of a 3% by weight aqueous solution of sodium polystyrenesulfonate, 2.4 mL of a 2% by weight solution of a fluorocarbon surfactant (F-1), 2.4 mL of a 2% by weight solution of another fluorocarbon surfactant (F-2), and 30 mL of a 20% by weight solution of ethyl acrylate/acrylic acid copolymer (mass ratio of the copolymerization of 96.4/3.6) latex were admixed. Just prior to the coating, 50 mL of a 4% by weight aqueous solution of N,N-ethylenebis(vinylsulfone acetamide) was admixed to give a coating solution for the back surface protective layer in an amount of 855 mL.

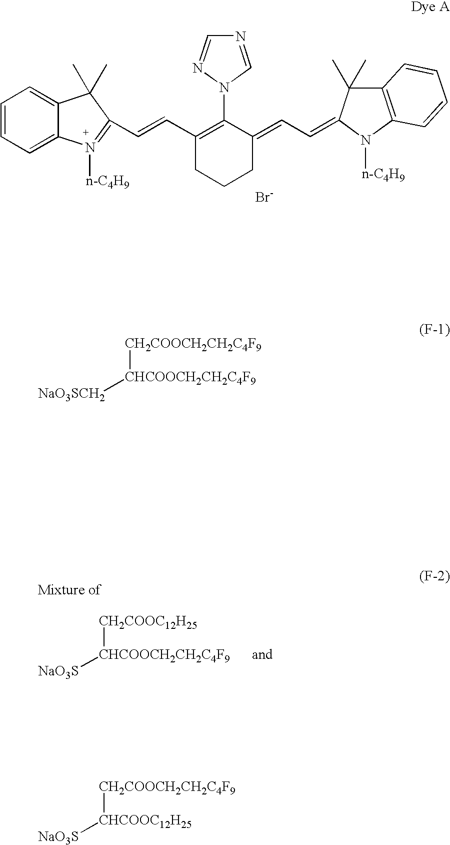

5) Coating of Back Layer

The backside of the undercoated support described above was subjected to simultaneous double coating so that the coating solution for the antihalation layer gave the coating amount of gelatin of 1.0 g/m², and so that the coating solution for the back surface protective layer gave the coating amount of gelatin of 1.0 g/m², followed by drying to produce a back layer.

(Image Forming Layer and Surface Protective Layer)

1. Preparations of Coating Material

1) Preparation of Silver Halide Emulsion

<<Preparation of Silver Halide Emulsion 1>>

A liquid was prepared by adding 3.1 mL of a 1% by weight potassium bromide solution, and then 3.5 mL of 0.5 mol/L sulfuric acid and 31.7 g of phthalated gelatin to 1421 mL of distilled water. The liquid was kept at 30° C. while stirring in a stainless steel reaction vessel, and thereto were added total amount of: solution A prepared through diluting 22.22 g of silver nitrate by adding distilled water to give the volume of 95.4 mL; and solution B prepared through diluting 15.3 g of potassium bromide and 0.8 g of potassium iodide with distilled water to give the volume of 97.4 mL, over 45 seconds at a constant flow rate. Thereafter, 10 mL of a 3.5% by weight aqueous solution of hydrogen peroxide was added thereto, and 10.8 mL of a 10% by weight aqueous solution of benzimidazole was further added. Moreover, a solution C prepared through diluting 51.86 g of silver nitrate by adding distilled water to give the volume of 317.5 mL and a solution D prepared through diluting 44.2 g of potassium bromide and 2.2 g of potassium iodide with distilled water to give the volume of 400 mL were added. A controlled double jet method was executed through adding total amount of the solution C at a constant flow rate over 20 minutes, accompanied by adding the solution D while maintaining the pAg at 8.1. Potassium hexachloroiridate (III) was added in its entirely to give 1×10⁻⁴ mol per 1 mol of silver, at 10 minutes post initiation of the addition of the solution C and the solution D. Moreover, at 5 seconds after completing the addition of the solution C, a potassium hexacyanoferrate (II) in an aqueous solution was added in its entirety to give 3×10⁻⁴ mol per 1 mol of silver. The mixture was adjusted to the pH of 3.8 with 0.5 mol/L sulfuric acid. After stopping stirring, the mixture was subjected to precipitation/desalting/water washing steps. The mixture was adjusted to the pH of 5.9 with 1 mol/L sodium hydroxide to produce a silver halide dispersion having the pAg of 8.0.

The above-described silver halide dispersion was kept at 38° C. with stirring, and thereto was added 5 mL of a 0.34% by weight methanol solution of 1,2-benzisothiazoline-3-one, followed by elevating the temperature to 47° C. at 40 minutes thereafter. At 20 minutes after elevating the temperature, sodium benzene thiosulfonate in a methanol solution was added at 7.6×10⁻⁵ mol per 1 mol of silver. At additional 5 minutes later, a tellurium sensitizer C in a methanol solution was added at 2.9×10⁻⁴ mol per 1 mol of silver and subjected to ripening for 91 minutes. Thereafter, a 0.3% by weight aqueous solution of dye aggrigation inhibitor-1 was added to be 5×10⁻⁴ mol per 1 mol of silver and sensitizing dye-1 was added to be 1×10⁻⁴ mol per 1 mol of silver. At 1 minute later, 1.3 mL of a 0.8% by weight methanol solution of N,N′-dihydroxy-N″,N″-diethylmelamine was added thereto, and at additional 4 minutes thereafter, 5-methyl-2-mercaptobenzimidazole in a methanol solution at 4.8×10⁻³ mol per I mol of silver, 1-phenyl-2-heptyl-5-mercapto-1,3,4-triazole in a methanol solution at 5.4×10⁻³ mol per I mol of silver, and 1-(3-methylureidophenyl)-5-mercaptotetrazole in an aqueous solution at 8.5×10⁻³ mol per 1 mol of silver were added to produce a silver halide emulsion 1.

Grains in thus prepared silver halide emulsion were silver iodobromide grains having a mean equivalent spherical diameter of 0.042 μm, a variation coefficient of an equivalent spherical diameter distribution of 20%, which uniformly include iodine at 3.5 mol %. Grain size and the like were determined from the average of 1000 grains using an electron microscope. The {100} face ratio of these grains was found to be 80% using a Kubelka-Munk method.

<<Preparation of Silver Halide Emulsion 2>>

Preparation of silver halide emulsion 2 was conducted in a similar manner to the process in the preparation of the silver halide emulsion I except that: the temperature of the liquid upon the grain forming process was altered from 30° C. to 47° C.; the solution B was changed to that prepared through diluting 15.9 g of potassium bromide with distilled water to give the volume of 97.4 mL; the solution D was changed to that prepared through diluting 45.8 g of potassium bromide with distilled water to give the volume of 400 mL; time period for adding the solution C was changed to 30 minutes; potassium hexacyanoferrate (II) was deleted; the amount of the tellurium sensitizer C to be added was changed to 1.1×10⁻⁴ mol per 1 mol of silver; the addition amount of 1-phenyl-2-heptyl-5-mercapto-1,3,4-triazole was changed to 3.3×10⁻³ mol per 1 mol of silver; and the addition amount of 1-(3-methylureidophenyl)-5-mercaptotetrazole was changed to 4.7×10⁻³ mol per 1 mol of silver. Grains in the silver halide emulsion 2 were cubic pure silver bromide grains having a mean equivalent spherical diameter of 0.080 μm and a variation coefficient of an equivalent spherical diameter distribution of 20%.

<<Preparation of Silver Halide Emulsion 3>>

Preparation of silver halide emulsion 3 was conducted in a similar manner to the process in the preparation of the silver halide emulsion 1 except that: the temperature of the liquid upon the grain forming process was altered from 30° C. to 27° C.; the amount of the tellurium sensitizer C to be added was changed to 5.2×10⁻⁴ mol per 1 mol of silver; and bromoauric acid in an mount of 5×10⁻⁴ mol per 1 mol of silver and potassium thiocyanate in an amount of 2×10⁻³ mol per I mol of silver were added at 3 minutes following the addition of the tellurium sensitizer. Grains in the silver halide emulsion 3 were silver iodobromide grains having a mean equivalent spherical diameter of 0.034 μm and a variation coefficient of an equivalent spherical diameter distribution of 20%, which uniformly include iodine at 3.5 mol %.

<<Preparation of Mixed Emulsion A for Coating Solution>>

The silver halide emulsion I at 70% by weight, the silver halide emulsion 2 at 15% by weight, and the silver halide emulsion 3 at 15% by weight were dissolved, and thereto was added benzothiazolium iodide in a 1% by weight aqueous solution to give 7×10⁻³ mol per 1 mol of silver.

Further, water was added thereto to give the content of silver of 38.2 g per 1 kg of the mixed emulsion for a coating solution, and 1-(3-methylureidophenyl)-5-mercaptotetrazole was added to give 0.34 g per 1 kg of the mixed emulsion for a coating solution.

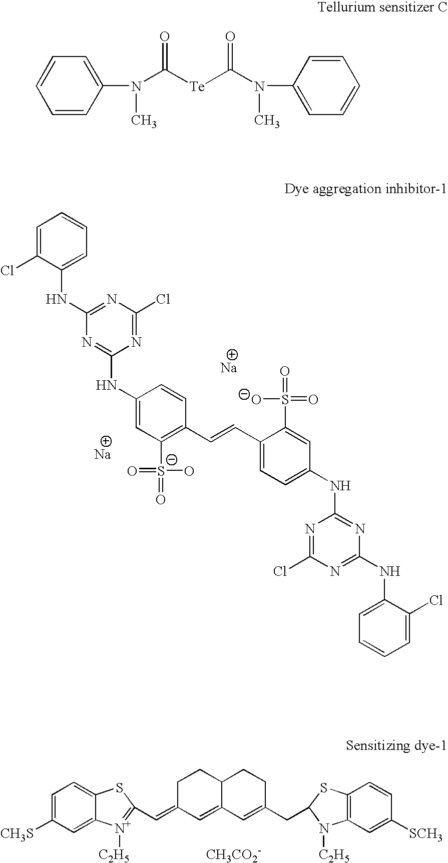

2) Preparation of Dispersion of Silver Salt of Fatty Acid

<<Preparation of Recrystallized Behenic Acid>>

Behenic acid manufactured by Henkel Co. (trade name: Edenor C22-85R) in an amount of 100 kg was admixed with 1200 kg of isopropyl alcohol, and dissolved at 50° C. The mixture was filtrated through a 10 μm filter, and cooled to 30° C. to allow recrystallization. Cooling speed for the recrystallization was controlled to be 3 ° C./hour. The resulting crystal was subjected to centrifugal filtration, and washing was performed with 100 kg of isopropyl alcohol. Thereafter, the crystal was dried. The resulting crystal was esterified, and subjected to GC-FID analysis to give the results of the content of behenic acid being 96 mol %, lignoceric acid 2 mol %, and arachidic acid 2 mol %. In addition, erucic acid was included at 0.001 mol %.

<<Preparation of Nano-particles of Silver Behenate>>

Into a reaction vessel, deionized water, 72 g of a 10% by weight aqueous solution of dodecylthio polyacrylamide surfactant, and 46.6 g of the above recrystallized behenic acid were added. The mixture was stirred at a rotating speed of 150 rpm and heated to 70° C., while adding 70.6 g of a 10% by weight aqueous solution of potassium hydroxide into the reaction vessel. Next, the resulting mixture was heated to 80° C. and allowed to stand for 30 minutes till the solution turned to be turbid. Thereafter, the mixture was cooled to 70° C. and then 21.3 g of 100% by weight solution of silver nitrate was added into the reaction vessel over a period of 30 minutes while adjusting the addition speed. The reaction temperature of the mixture was kept for 30 minutes, and then cooled to room temperature, and the resultant was then decanted. The nano-particle dispersion of silver behenate having a median particle size of 150 nm was obtained (solid content of 3% by weight).

<<Purification and Condensation of Nano-particles of Silver Behenate>>

12 kg of nano-particle dispersion (solid content: 3% by weight) was introduced into a filtration dialysis/ultrafiltration device equipped with a permeable membrane cartridge Osmonics Model 21-HZ20-S8J (the effective surface area: 0.34 m², nominal molecular weight cutoff of 50,000). The device was operated so that the pressure to the permeable membrane was set to be 3.5 kg/cm² (50 lb/in²), and the pressure of the downstream side of the permeable membrane was set to be 20 kg/cm² (285 lb/in²). The permeating liquid was replaced by deionized water until 24 kg of permeating liquid was removed from the dispersion, and then the replacement by deionized water was stopped. Thereafter, the device was operated until the dispersion reached to a concentration of 28% by weight based on the solid content. Thereby, purified and condensed nano-particle dispersion of silver behenate was obtained.

3) Preparation of Reducing Agent Dispersion

<<Preparation of Reducing Agent-1 Dispersion>>

To 10 kg of reducing agent-I (6,6′-di-t-butyl-4,4′-dimethyl-2,2′-butylidene diphenol) and 16 kg of a 10% by weight aqueous solution of modified poly(vinyl alcohol) (manufactured by Kuraray Co., Ltd., Poval MP-203) was added 10 kg of water, and thoroughly mixed to give a slurry. This slurry was fed with a diaphragm pump, and was subjected to dispersion with a horizontal sand mill (UVM-2: manufactured by AIMEX Co., Ltd.) packed with zirconia beads having a mean particle diameter of 0.5 mm for 3 hours. Thereafter, 0.2 g of a benzoisothiazolinone sodium salt and water were added thereto, thereby adjusting the concentration of the reducing agent to be 25% by weight. This dispersion was subjected to heat treatment at 60° C. for 5 hours to obtain reducing agent-I dispersion. Particles of the reducing agent included in the resulting reducing agent dispersion had a median diameter of 0.40 μm, and a maximum particle diameter of 1.4 μm or less. The resultant reducing agent dispersion was subjected to filtration with a polypropylene filter having a pore size of 3.0 μm to remove foreign substances such as dust, and stored.

4) Preparations of Dispersions of Development Accelerator

<<Preparation of Development Accelerator-1 Dispersion>>

To 10 kg of development accelerator (A-1) and 20 kg of a 10% by weight aqueous solution of modified poly(vinyl alcohol) (manufactured by Kuraray Co., Ltd., Poval MP203) was added 10 kg of water, and thoroughly mixed to give a slurry. This slurry was fed with a diaphragm pump, and was subjected to dispersion with a horizontal sand mill (UVM-2: manufactured by AIMEX Co., Ltd.) packed with zirconia beads having a mean particle diameter of 0.5 mm for 3 hours and 30 minutes. Thereafter, 0.2 g of a benzisothiazolinone sodium salt and water were added thereto, thereby adjusting the concentration of the development accelerator to be 20% by weight. Accordingly, development accelerator-1 dispersion was obtained. Particles of the development accelerator included in the resulting development accelerator dispersion had a median diameter of 0.48 μm, and a maximum particle diameter of 1.4 μm or less. The resultant development accelerator dispersion was subjected to filtration with a polypropylene filter having a pore size of 3.0 μm to remove foreign substances such as dust, and stored.

<<Preparation of Development Accelerator-2 Dispersion>>

Also concerning a solid dispersion of development accelerator (A-2), dispersion was executed similar to the development accelerator-1, and thus the dispersion of 20% by weight was obtained.

5) Preparations of Organic Polyhalogen Compound Dispersion

<<Preparation of Organic Polyhalogen Compound-1 Dispersion>>

10 kg of organic polyhalogen compound-1 (tribromomethane sulfonylbenzene), 10 kg of a 20% by weight aqueous solution of modified poly(vinyl alcohol) (manufactured by Kuraray Co., Ltd., Poval MP203), 0.4 kg of a 20% by weight aqueous solution of sodium triisopropylnaphthalenesulfonate and 14 kg of water were thoroughly admixed to give a slurry. This slurry was fed with a diaphragm pump, and was subjected to dispersion with a horizontal sand mill (UVM-2: manufactured by AIMEX Co., Ltd.) packed with zirconia beads having a mean particle diameter of 0.5 mm for 5 hours. Thereafter, 0.2 g of a benzisothiazolinone sodium salt and water were added thereto, thereby adjusting the concentration of the organic polyhalogen compound to be 26% by weight. Accordingly, organic polyhalogen compound-i dispersion was obtained. Particles of the organic polyhalogen compound included in the resulting organic polyhalogen compound dispersion had a median diameter of 0.41 μm, and a maximum particle diameter of 2.0 μm or less. The resultant organic polyhalogen compound dispersion was subjected to filtration with a polypropylene filter having a pore size of 10.0 μm to remove foreign substances such as dust, and stored.

<<Preparation of Organic Polyhalogen Compound-2 Dispersion>>

10 kg of organic polyhalogen compound-2 (N-butyl-3-tribromomethane sulfonylbenzamide), 20 kg of a 10% by weight aqueous solution of modified poly(vinyl alcohol) (manufactured by Kuraray Co., Ltd., Poval MP203) and 0.4 kg of a 20% by weight aqueous solution of sodium triisopropylnaphthalenesulfonate were thoroughly admixed to give a slurry. This slurry was fed with a diaphragm pump, and was subjected to dispersion with a horizontal sand mill (UVM-2: manufactured by AIMEX Co., Ltd.) packed with zirconia beads having a mean particle diameter of 0.5 mm for 5 hours. Thereafter, 0.2 g of a benzisothiazolinone sodium salt and water were added thereto, thereby adjusting the concentration of the organic polyhalogen compound to be 30% by weight. This dispersion was heated at 40° C. for 5 hours to obtain organic polyhalogen compound-2 dispersion. Particles of the organic polyhalogen compound included in the resulting organic polyhalogen compound dispersion had a median diameter of 0.40 μm, and a maximum particle diameter of 1.3 μm or less. The resultant organic polyhalogen compound dispersion was subjected to filtration with a polypropylene filter having a pore size of 3.0 μm to remove foreign substances such as dust, and stored.

6) Preparation of Pigment-1 Dispersion

C.I. Pigment Blue 60 in an amount of 64 g and 6.4 g of DEMOL N manufactured by Kao Corporation were added to 250 g of water and thoroughly mixed to give a slurry. Zirconia beads having a mean particle diameter of 0.5 mm were provided in an amount of 800 g, and charged in a vessel with the slurry. Dispersion was performed with a dispersing machine (¼ G sand grinder mill: manufactured by AIMEX Co., Ltd.) for 25 hours. Thereto was added water to adjust so that the concentration of the pigment became 5% by weight to obtain a pigment-I dispersion. Particles of the pigment included in the resulting pigment dispersion had a mean particle diameter of 0.21 μm.

7) Preparations of Aqueous Solution

The following compounds were added by preparing an aqueous solution thereof.

A 5% by weight aqueous solution of succinimide was prepared.

A 5% by weight aqueous solution of 4-methylphthalic acid was prepared.

Viscosity increasing agent: a 3% by weight aqueous solution of sodium polystyrenesulfonate was prepared.

2. Preparations of Coating Solution

1) Preparation of Coating Solution for Image Forming Layer

A vessel was kept at 40° C., and thereto were added 450 mL of water and gelatin. After dissolving the gelatin, the dispersion of silver salt of fatty acid obtained above, the pigment-i dispersion, the organic polyhalogen compound-I dispersion, the organic polyhalogen compound-2 dispersion, the 5% by weight aqueous solution of succinimide, the 4-methylphthalic acid aqueous solution, sodium iodide, and the viscosity increasing agent solution were serially added. The mixed emulsion A for coating solution was added thereto, followed by thorough mixing just prior to the coating, which is fed directly to a coating die. Further, the addition amount of the viscosity increasing solution was adjusted so that viscosity of the coating solution became 25 [mPa.s].

The amount of zirconium in the coating solution was 0.18 mg per 1 g of silver.

2) Preparations of Coating Solution for Intermediate Layer

<<Preparation of Coating Solution A-2 for Intermediate Layer>>

To 1000 g of poly(vinyl alcohol) PVA-205 (manufactured by Kuraray Co., Ltd.), 65.2 g of the pigment-1 dispersion, 13.2 g of a 18.5% by weight aqueous solution of a blue dye-1 (manufactured by Nippon Kayaku Co., Ltd.: Kayafect turquoise RN liquid 150), 27 mL of a 5% by weight aqueous solution of sodium di(2-ethylhexyl)sulfosuccinate, and 4200 mL of a 19% by weight solution of methyl methacrylate/styrene/butyl acrylate/hydroxyethyl methacrylate/acrylic acid copolymer (mass ratio of the copolymerization of 57/8/28/5/2) latex, 27 mL of a 5% by weight aqueous solution of aerosol OT (manufactured by American Cyanamid Co.), 135 mL of a 20% by weight aqueous solution of diammonium phthalate was added water to give total amount of 10000 g. The mixture was adjusted with sodium hydroxide to give the pH of 7.5. Accordingly, the coating solution for the intermediate layer was prepared, and was fed to a coating die to provide the wet coating amount described in Table 1.

Viscosity of the coating solution was 55 [mPa.s] which was measured with a B type viscometer at 40° C. (No. 1 rotor, 60 rpm).

<<Preparation of Coating Solution A-2 for Intermediate Layer>>

Preparation of coating solution A-2 for intermediate layer was conducted in a similar manner to the process in the preparation of the coating solution A-1 for intermediate layer except that polymer latex P-31 was added in an amount described in the following Table 1 instead of using poly(vinyl alcohol) PVA-205 (trade name, available from Kurary Co. Ltd.) and methyl methacrylate/styrene/butylacrylate/hydroxyethyl methacrylate/acrylic acid copolymer.

<<Preparation of Coating Solution B-1 for Intermediate Layer>>

To the polymer latex P-31 in an amount of 1279 g as a dry solid content, poly(vinyl alcohol) PVA-205 (trade name, available from Kurary Co. Ltd.) in an amount of 142 g as a dry solid content, and 25 mL of a 5% by weight aqueous solution of sodium di-2-(ethylhexyl)sulfosuccinate was added water to make the total amount to be 5116 g. Thereafter, the mixture was adjusted to the pH of 7.5 with sodium hydroxide solution. Accordingly, the coating solution B-1 for the intermediate layer was prepared, and was fed to the coating die to provide the wet coating amount described in Table 1.

Viscosity of the coating solution was 10 [mPa.s] which was measured with a B type viscometer at 40° C. (No. 1 rotor, 60 rpm).

<<Preparations of Coating Solution B-2 to B-6 for Intermediate Layer>>

Preparations of coating solution B-2 to B-6 for intermediate layer were conducted in a similar manner to the process in the preparation of the coating solution B-1 for intermediate layer except that the polymer latex and the hydrophilic polymer were added in the amount described in Table 1 instead of using polymer latex P-31 and poly(vinyl alcohol) PVA-205 (trade name, available from Kurary Co. Ltd.).

3) Preparation of Coating Solution for Surface Protective Layer

A vessel was kept at 40° C., and thereto were added 2400 mL of water and 300 g of gelatin. After dissolving the gelatin, 15 g of poly(methyl methacrylate) fine particles (mean particle diameter of 0.7 μm) and 79 g of poly(methyl methacrylate) fine particles (mean particle diameter of 4.5 μm), 12 mL of a 5% by weight solution of a fluorocarbon surfactant (F-1), 120 mL of a 2% by weight aqueous solution of another fluorocarbon surfactant (F-2), 60 g of a 5% by weight aqueous solution of sodium di(2-ethylhexyl)sulfosuccinate, and 900 g of succinimide aqueous solution. The obtained mixture was stirred well. Further, the addition amount of the viscosity increasing solution was adjusted so that viscosity of the coating solution became 16 [mPa.s].

3. Preparations of Photothermographic Material-1 to -8

Reverse surface of the back surface on which the back layer was coated was subjected to simultaneous overlaying coating by a slide bead coating method in order of the image forming layer, intermediate layer-1, intermediate layer-2, and surface protective layer, and thus sample of photothermographic material was produced. The combination of coating solutions of each layer is shown in Table 2. In this method, the temperature of the coating solution was adjusted to 37° C. for the image forming layer and surface protective layer.

The coating amount of each compound (g/m²) for the image forming layer is as follows. The surface protective layer was coated to give the coating amount of dry gelatin of 2.0 g/m².

| | |
|---|---|
| Silver salt of fatty acid | 5.42 |
| Pigment (C.I.Pigment Blue 60) | 0.036 |
| Organic polyhalogen compound-1 | 0.10 |
| Organic polyhalogen compound-2 | 0.34 |
| 4-Methyl phthalic acid | 0.08 |
| Succinimide | 0.54 |
| Gelatin | 0.90 |
| Sodium iodide | 0.04 |
| Reducing agent-1 | 0.75 |
| Development accelerator-1 | 0.015 |
| Development accelerator-2 | 0.011 |
| Silver halide (on the basis of Ag content) | 0.10 |

TABLE I
<Coating Solution for Intermediate Layer>

| | | | Employment Ratio of |
|---|---|---|---|
| Coating | | | Polymer Latex to |
| Solution | | Water-soluble | Water-soluble |
| No. | Polymer Latex | Polymer | Polymer (mass ratio) |
| A-1 | Polymer-A | Poly(vinyl | 44/56 |
| | | alcohol) | |
| A-2 | P-31 | Poly(vinyl | 90/10 |
| | | alcohol) | |
| B-1 | P-31 | Poly(vinyl | 90/10 |
| | | alcohol) | |
| B-2 | P-33 | Poly(vinyl | 90/10 |
| | | alcohol) | |
| B-3 | P-39 | Poly(vinyl | 90/10 |
| | | alcohol) | |
| B-4 | P-11 | Poly(vinyl | 90/10 |
| | | alcohol) | |
| B-5 | P-4 | Poly(vinyl | 90/10 |
| | | alcohol) | |
| B-6 | P-4 | Poly(vinyl | 85/15 |
| | | alcohol) | |

TABLE 2
<Layer Constitution>

| | | Intermediate | Intermediate | | |
|---|---|---|---|---|---|
| | Image | Layer-1 (Amount | Layer-2 (Amount | Surface | |
| Sample | Forming | of wet coating of | of wet coating of | Protective | |
| No. | Layer | 16.7 mL/m²) | 22.3 mL/m²) | Layer | Note |
| 1 | 1 | — | A-1 | 1 | Comparative |
| 2 | 1 | — | A-2 | 1 | Invention |
| 3 | 1 | B-1 | A-1 | 1 | Invention |
| 4 | 1 | B-2 | A-1 | 1 | Invention |
| 5 | 1 | B-3 | A-1 | 1 | Invention |
| 6 | 1 | B-4 | A-1 | 1 | Invention |
| 7 | 1 | B-5 | A-1 | 1 | Invention |
| 8 | 1 | B-6 | A-1 | 1 | Invention |

note)
Polymer-A: methyl methacrylate/ styrene/ butyl acrylate/ hydroxyethyl methacrylate/ acrylic acid copolymer

Chemical structures of the compounds used in Examples of the invention are shown below. 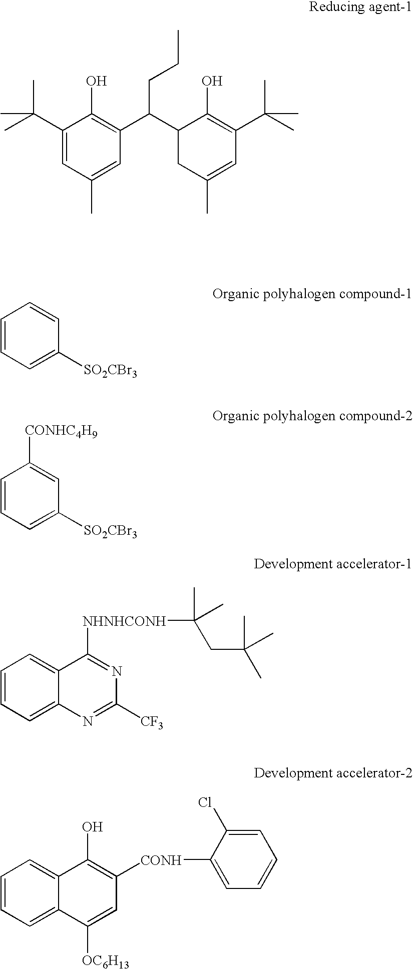
3) Evaluation of Performance
3-1. Evaluating Method for Coated Surface State

The sample each was subjected to uniform exposure to give an optical density of 1.2 and thermal development in a similar condition to that in the respective evaluations of the photographic performance. The numbers of coating streaks per unit coated width are counted. The less the number of the coating streaks, the photothermographic material obtained can attain a better coating ability.

The evaluation criteria are as follows.
\textcircled{o}: No coating streak is seen.
◯: Coating streak with low density is slightly occurred.
Δ: Coating streak with dense density is slightly occurred.
×: Coating streaks are overall occurred.
   3-2. Photographic Properties

1) Preparation

The obtained sample was cut into a half-cut size (43 cm in length×35 cm in width), and was wrapped with the following packaging material under an environment of 25° C. and 50% RH, and stored for 2 weeks at an ambient temperature. Thereafter, the following evaluation was performed.

<<Packaging Material>>

A film laminated with PET 10 μm/PE 12 μm/aluminum foil 9 μm/Ny 15 μm/polyethylene 50 μm containing carbon at 3% by weight:
oxygen permeability at 25° C.: 0.02 mL.atm⁻¹m⁻²day⁻¹;
vapor permeability at 25° C.: 0.10 g.atm⁻¹m⁻²day⁻¹.

2) Exposure and Thermal Development of Photothermographic Material

An exposing apparatus, in which a 800 to 820 nm semiconductor laser emitted in vertical multimode by high frequency superposition was mounted as a light source, was constructed. The sample Nos. 1 to 8 prepared above were subjected to laser scanning exposure using the above exposing apparatus from the image forming layer side. At that time, the image was recorded by the scanning laser beam with an incident angle of 75 degree to the exposed surface of the photothermographic material. Thereafter, using an automatic thermal developing apparatus equipped with heating drum, samples were thermal developed at 124° C. for 15 seconds so as to contact the surface protective layer of the photothermographic material with the drum surface. And then the obtained image was evaluated using a densitometer. Exposure and development were performed in a room conditioned at 23° C. and 50% RH.

The time period for heating described above was set by adjusting the conveying speed of each sample, and the line speed in the thermal developing portion was 28 mm/second.

3) Terms for Evaluation

3-1) Photographic Properties

Fog: Fog is expressed in terms of a density of the unexposed portion.

Sensitivity: Sensitivity is expressed in terms of a reciprocal of the exposure value necessary for giving an optical density of fog+0.5.

These values are expressed by a relative value when fog and sensitivity of sample No. I are taken as 100.

3-2) Evaluation of Image Storability

(1) Test of Image Storability in a Dark Place

This test was an accelerated test to evaluate image storability.

7.5 g of sodium chloride was dissolved in 500 mL of water to prepare a salt solution. The samples which were exposed and thermal developed were prepared. In a dark place, the image portion having a density of 1.3 was superposed on filter paper impregnated with the salt solution, and the assembly was pressed for 2 seconds. After removing the filter paper, a ½ part of the sample was stored in a condition of 45C and 50% RH for 3 days, and then compared with to the remaining ½ part.

The resulting samples were visually evaluated based on the following criteria. This evaluation is made by storing under the accelerated condition so that the rank 2 or better is practically acceptable.

Rank 4: Density unevenness is not seen, and unevenness in surface gloss is not occurred.

Rank 3: Slight density unevenness is seen, and unevenness in surface gloss is slightly occurred.

Rank 2: Slight density unevenness is seen, and unevenness in surface gloss is occurred.

Rank 1: Apparent density unevenness is seen, and unevenness in surface gloss is occurred.

(2) Evaluation of Image Storability Against Stain (Print-Out)

10 g of sodium chloride was dissolved in 497 mL of water to prepare a salt solution. The samples which were exposed and developed were prepared. The minimum density area of the image was once exposed to a fluorescent lamp and superposed on filter paper impregnated with the salt solution, and the assembly was pressed for 2 seconds. After removing the filter paper, a ½ part of the sample was irradiated with a fluorescent lamp at 8500 lux for 4 hours under a condition of 45C and 50% RH. Thereafter, the irradiated part was compared with to the remaining ½ part.

Furthermore, in a similar manner to the above, the maximum density area of the image was once exposed to a fluorescent lamp and was superposed on filter paper impregnated with the salt solution, and the assembly was pressed for 2 seconds. After removing the filter paper, a ½ part of the sample was irradiated with a fluorescent lamp at 8500 lux for 4 hours under a condition of 45C and 50% RH. Thereafter, the irradiated part was compared with to the remaining ½ part.

The resulting samples were visually evaluated based on the following criteria. This evaluation is made by storing under the accelerated condition so that the rank 2 or better is practically acceptable.

Rank 4: No discoloration is seen on both the minimum density area and maximum density area, and no unevenness in surface gloss is occurred.

Rank 3: Slight discoloration is seen, and slight unevenness in surface gloss is occurred.

Rank 2: Slight discoloration is seen, and unevenness in surface gloss is occurred.

Rank 1: Apparent discoloration is seen on both the minimum density area and the maximum density area, and unevenness in surface gloss is occurred.

4) Results of Evaluation

The obtained results are shown in Table 3 below.

Form the results, it is understood that the photothermographic materials of the present invention exhibit low fog and high sensitivity, and also attain excellent image storability.

In particular, the sample Nos. 4, 5, 6, 7, and 8 exhibit an excellent result.

TABLE 3

| | Photographic | | Image Storability | | |
|---|---|---|---|---|---|
| Sample | Properties | | Test in Dark | | |
| No. | Fog | Sensitivity | Place | Print-out | Note |
| 1 | 100 | 100 | 1 | 1 | Comparative |
| 2 | 98 | 110 | 3 | 3 | Invention |
| 3 | 94 | 121 | 3 | 3 | Invention |
| 4 | 95 | 120 | 4 | 4 | Invention |
| 5 | 96 | 119 | 4 | 4 | Invention |
| 6 | 95 | 120 | 4 | 4 | Invention |
| 7 | 94 | 121 | 4 | 4 | Invention |
| 8 | 95 | 120 | 4 | 4 | Invention |

### Example 2

Preparation of coating solution B-6 for the intermediate layer was conducted similar to the process in the preparation of coating solution B-1 for the intermediate layer in Example 1, except that further adding 100 g of crosslinking agent-1 (Epocros K-2020E, trade name, available from Nippon Shokubai Co. Ltd.) described in Table 4. Photothermographic material-11 was prepared in a similar manner to photothermographic material-5 of Example 1 except that the coating solution B-6 for the intermediate layer prepared above was used. Furthermore, evaluation was performed in a similar manner to Example 1. The obtained results are shown in Table 4.

The addition of the crosslinking agent further improves image storability.

TABLE 4

| | | | | | Image Storability | | |
|---|---|---|---|---|---|---|---|
| | Intermediate Layer-1 | | Photographic | | Test in | | |
| Photothermo- | | Crosslinking | Properties | | Dark | | |
| graphic Material | Binder | Agent | Fog | Sensitivity | Place | Print-out | Note |
| 5 | Latex P-31/ | — | 96 | 119 | 4 | 4 | Invention |
| | Poly(vinyl alcohol) | | | | | | |
| | = 90/10 | | | | | | |
| 11 | Latex P-31/ | Crosslinking | 96 | 120 | 5 | 5 | Invention |
| | Poly(vinyl alcohol) | agent-1 | | | | | |
| | = 90/10 | | | | | | |

### Example 3

Preparations of photothermographic material-12 and -13 were conducted in a similar manner to the process in the preparation of photothermographic material-5 except that the compound represented by formula (I) or (II) described in Table 5 was added in a molar equivalent amount instead of succinimide used in the coating solution for the image forming layer of Example 1. Further, evaluation was performed in a similar manner to Example 1. Results are shown in Table 5.

It is apparent from the results, that the photothermographic materials of the present invention exhibit low fog, high sensitivity, and excellent image storability.

TABLE 5

| | Image Forming | | | | | |
|---|---|---|---|---|---|---|
| | Layer | | | | | |
| | Compound | Photographic | | Image Storability | | |
| Photothermo- | represented by | Properties | | Test in Dark | | |
| graphic Material | Formula (I) or (II) | Fog | Sensitivity | Place | Print-out | Note |
| 5 | succinimide | 96 | 119 | 4 | 4 | Invention |
| 12 | phthalimide | 96 | 120 | 4 | 4 | Invention |
| 13 | compound II-1 | 96 | 119 | 4 | 4 | Invention |

What is claimed is:

1. A photothermographic material comprising, on at least one side of a support, an image forming layer comprising at least a photosensitive silver halide, a non-photosensitive organic silver salt, a reducing agent, and a binder and at least two non-photosensitive layers which are disposed on the same side as the image forming layer and farther from the support than the image forming layer, wherein
(1) 50% by weight or more of the binder is a hydrophilic binder; and
(2) one layer among the non-photosensitive layers that is nearer to the image forming layer is a non-photosensitive intermediate layer containing 50% by weight or more of a hydrophobic polymer latex as a binder.

2. The photothermographic material according to claim 1, wherein the non-photosensitive intermediate layer is adjacent to the image forming layer.

3. The photothermographic material according to claim 1, further comprising at least one compound represented by the following formula (I) or (II): 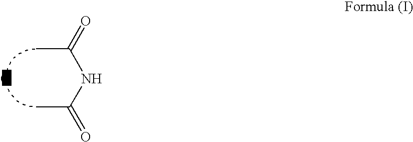
wherein, Q represents an atomic group necessary for forming a 5- or 6-membered imide ring; and 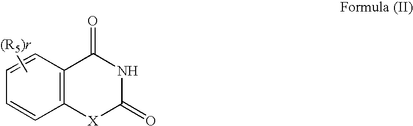
wherein, R₅ independently represents one selected from a hydrogen atom, an alkyl group, a cycloalkyl group, an alkoxy group, an alkylthio group, an arylthio group, a hydroxy group, a halogen atom, or an N(R₈R₉) group, wherein R₈ and R₉ each independently represent one selected from a hydrogen atom, an alkyl group, an aryl group, a cycloalkyl group, an alkenyl group, or a heterocyclic group; r represents 0, 1, or 2; R₈ and R₉ may bond to each other to form a substituted or unsubstituted 5 to 7-membered heterocycle; two R₅'s may link together to form an aromatic, heteroaromatic, alicyclic, or heterocyclic condensed ring; and X represents one selected from O, S, Se, or N(R₆), wherein R₆ represents one selected from a hydrogen atom, an alkyl group, an aryl group, a cycloalkyl group, an alkenyl group, or a heterocyclic group.

4. The photothermographic material according to claim 1, wherein the image forming layer further comprises at least one compound selected from polyacrylamide and derivatives thereof.

5. The photothermographic material according to claim 4, wherein the non-photosensitive organic silver salt is a non-photosensitive organic silver salt prepared as particles in the presence of at least one compound selected from polyacrylamide and derivatives thereof.

6. The photothermographic material according to claim 5, wherein the non-photosensitive organic silver salt comprises nano-particles.

7. The photothermographic material according to claim 6, wherein the nano-particles have a mean particle size of from 50 nm to 1000 nm.

8. The photothermographic material according to claim 1, wherein the hydrophilic binder of the image forming layer comprises gelatin or a gelatin derivative.

9. The photothermographic material according to claim 1, wherein 50% by weight or more of a binder in at least one of the non-photosensitive layers farther from the image forming layer is a hydrophilic polymer.

10. The photothermographic material according to claim 9, wherein the hydrophilic binder in the non-photosensitive layer comprises gelatin or a gelatin derivative.

11. The photothermographic material according to claim 1, wherein 50% by weight or more of the hydrophobic polymer latex in the non-photosensitive intermediate layer comprises 10% by weight to 70% by weight of a monomer component represented by the following formula (M):
CH₂═CR⁰¹—CR⁰²═CH₂ Formula (M)
wherein R⁰¹ and R⁰² each independently represent an atom or a group selected from a hydrogen atom, an alkyl group having 1 to 6 carbon atoms, a halogen atom, or a cyano group.

12. The photothermographic material according to claim 11, wherein both R⁰¹ and R⁰² are a hydrogen atom in formula (M).

13. The photothermographic material according to claim 1, wherein at least one layer among the image forming layer and the non-photosensitive layers comprises a crosslinking agent.

14. The photothermographic material according to claim 13, wherein the crosslinking agent is at least one compound selected from an isocyanate compound, a vinylsulfone compound, an alkoxysilane compound, an epoxy compound, a carbodiimide compound, or an oxazoline compound.

15. The photothermographic material according to claim 14, wherein the crosslinking agent is at least one compound selected from an epoxy compound, a carbodiimide compound, and an oxazoline compound.

16. The photothermographic material according to claim 1, wherein a mass ratio of the non-photosensitive organic silver salt relative to the hydrophilic binder in the image forming layer is from 1.0 to 2.5.

17. An image forming method for forming images by imagewise exposure and thermal development of a photothermographic material comprising, on at least one side of a support, an image forming layer comprising at least a photosensitive silver halide, a non-photosensitive organic silver salt, a reducing agent, and a binder and at least two non-photosensitive layers which are disposed on the same side as the image forming layer and farther from the support than the image forming layer, wherein
1) 50% by weight or more of the binder is a hydrophilic binder, and
2) one layer among the non-photosensitive layers that is nearer to the image forming layer is a non-photosensitive intermediate layer containing 50% by weight or more of a hydrophobic polymer latex as a binder,
and wherein the thermal development is conducted while transporting the photothermographic material at a line speed of from 23 mm/sec to 200 mm/sec.
